(19) United States
(12) Patent Application Publication
(10) Pub. No.: US 2021/0035343 A1
(43) Pub. Date: Feb. 4, 2021

(54) APPARATUS, SYSTEM, AND METHOD FOR DATA MANAGEMENT, AND RECORDING MEDIUM

(71) Applicants: Kazuhiro YOSHIDA, Kanagawa (JP); Takahiro ASAI, Kanagawa (JP); Takuya MIZUHARA, Kanagawa (JP)

(72) Inventors: Kazuhiro YOSHIDA, Kanagawa (JP); Takahiro ASAI, Kanagawa (JP); Takuya MIZUHARA, Kanagawa (JP)

(21) Appl. No.: 16/966,702

(22) PCT Filed: Mar. 13, 2019
(86) PCT No.: PCT/JP2019/010376

§ 371 Date: Jul. 31, 2020

(30) Foreign Application Priority Data
Mar. 15, 2018 (JP) 2018-048369
Dec. 14, 2018 (JP) 2018-234814

(51) Int. Cl. G06T 11/60; H04N 1/00

(52) U.S. Cl. CPC G06T 11/60; H04N 1/00209; H04N 1/00244

(57) ABSTRACT

An information processing system includes one or more processors to: obtain a plurality of pieces of data; generate metadata used to combine first data of the plurality of pieces of data, with second data being one or more of the plurality of pieces of data other than the first data; assign a common identifier to the first data, the second data, and the metadata; and store, in a memory, the first data, the second data, and the metadata in association with the common identifier.

### TECHNICAL FIELD

The present invention relates to an apparatus, system, and method for data management, and a recording medium.

### BACKGROUND ART

When images are captured by using the same image capturing device while the focal length (angle of view) is changed, an image of a wide image capture range and an image of a narrow image capture range are obtained. In a case where the two images have the same number of pixels, the image of a narrow image capture range is a high-resolution image compared to the image of a wide image capture range. In some cases, a high-resolution planar image captured separately from a wide-angle planar image is superimposed on (embedded in) a partial area of the wide-angle planar image to provide a clear image of the partial area together with the overall image.

In such a technique, in order to retain, as metadata, etc., location information of the partial image in the overall image, it is desirable that the overall image, the partial image, and the metadata be associated with each other (see, for example, PTL 1). PTL 1 discloses an image data recording method in which a file storing only metadata and a file in which the metadata is registered for image data are prepared and, in a case where the file storing only the metadata is updated, it is determined, in accordance with data updated in the file, whether the file in which the metadata is registered for the image data is to be updated.

### CITATION LIST

### Patent Literature

PTL 1: JP-2016-96487-A

### SUMMARY of Invention

### Technical Problem

However, an existing system has a drawback in that, to use a plurality of pieces of image data in superimposed display, metadata needs to be referenced without exception. Specifically, a user may want to select a plurality of pieces of data (images, moving images, sounds, etc.) that are in their possession or are stored on a server as desired and to use the selected pieces of data in superimposed display. However, since information about the plurality of pieces of data (images, moving images, sounds, etc.) that are used in superimposed display is included in the metadata, it is not possible to identify the plurality of pieces of data (images, moving images, sounds, etc.) that are used in superimposed display without reference to the metadata.

That is, in order to know, for example, the scene in which the pieces of image data are obtained to superimpose and display the plurality of images, it is also necessary to reference the metadata.

Further, it is not possible to reference, from data (an image, a moving image, a sound, etc.) to be used in superimposed display, the metadata and the other data. Accordingly, it is not possible to identify, from any data (an image, a moving image, a sound, etc.) used in superimposed display, the other data (images, moving images, sounds, etc.). For example, when an image of a wide image capture range is present, it is not easy for a user to identify an image of a narrow image capture range that is superimposed on the image of a wide image capture range.

### Solution to Problem

Example embodiments of the present invention include an information processing system including one or more processors to: obtain a plurality of pieces of data; generate metadata used to combine first data of the plurality of pieces of data, with second data being one or more of the plurality of pieces of data other than the first data; assign a common identifier to the first data, the second data, and the metadata; and store, in a memory, the first data, the second data, and the metadata in association with the common identifier.

Example embodiments of the present invention include a data management system including the information processing system, and a terminal device. The terminal device includes a processor to control a display to display the plurality of pieces of data obtained at the information processing system, and accept selection of the first data and the second data to be combined from among the plurality of pieces of data; and a communication device to transmit information on the first data and the second data that are selected to the information processing system through the network.

Example embodiments of the present invention include a data management method, and a recording medium storing a program code for causing a computer system to perform the data management method.

### Advantageous Effects of Invention

According to at least one embodiment of the present invention, a plurality of pieces of data to be combined for display can be managed.

### BRIEF DESCRIPTION OF DRAWINGS

The accompanying drawings are intended to depict example embodiments of the present invention and should not be interpreted to limit the scope thereof. The accompanying drawings are not to be considered as drawn to scale unless explicitly noted. Also, identical or similar reference numerals designate identical or similar components throughout the several views.

FIG. 1 is a diagram illustrating an example of superimposed display metadata.

FIG. 2A is an example diagram schematically illustrating image data that can be identified from superimposed display metadata. FIG. 2B is an example diagram schematically illustrating a state where, from image data, it is not possible to identify superimposed display metadata or other image data.

FIG. 3A is a diagram illustrating example management of superimposed display use data and superimposed display metadata by using a management table. FIG. 3B is a diagram illustrating example management of superimposed display use data and superimposed display metadata by using a management table.

FIG. 4 is a diagram illustrating an example system configuration of a data management system.

FIG. 5 is a diagram illustrating an example hardware configuration of an application (AP) server.

FIG. 6 is a diagram illustrating an example hardware configuration of a database (DB) server.

FIG. 7 is a diagram illustrating an example hardware configuration of a client terminal.

FIG. 8 is an example functional block diagram illustrating the functions of the AP server, the DB server, and the client terminal included in the data management system.

FIG. 9 is an example flowchart illustrating operation of generating superimposed display metadata using the AP server.

FIG. 10 is a sequence diagram illustrating example operation of authenticates a user in response to a login operation by the user, performed by a superimposed display management system.

FIG. 11 is a sequence diagram illustrating example operation of generating and displaying a screen on the client terminal, performed by the superimposed display management system.

FIG. 12 is a diagram illustrating an example of a menu selection screen.

FIG. 13 is a sequence diagram illustrating example operation of uploading superimposed display use data to the superimposed display management system, performed by the client terminal.

FIG. 14A is a diagram illustrating an example of a data upload screen. FIG. 14B is a diagram illustrating an example of the data upload screen.

FIG. 15 is a sequence diagram illustrating example operation of generating superimposed display metadata, performed by the AP server.

FIG. 16A is a diagram illustrating an example of a superimposed display metadata generation screen displayed by the client terminal. FIG. 16B is a diagram illustrating an example of the superimposed display metadata generation screen displayed by the client terminal.

FIG. 17 is a sequence diagram illustrating example of generating superimposed display metadata, performed by the AP server.

FIGS. 18A to 18D are each an example management table used in a management ID registration step.

FIG. 19 is a sequence diagram illustrating example operation of displaying a data display screen at the client terminal.

FIG. 20 is a diagram illustrating an example management table that is saved on the DB server and used to generate an index display screen.

FIG. 21A is a diagram illustrating an example of the index display screen on which a list of pieces of data uploaded to the superimposed display management system is displayed as an index. FIG. 21B is a diagram illustrating an example of the index display screen on which a list of pieces of data uploaded to the superimposed display management system is displayed as an index.

FIG. 22 is a diagram illustrating an example of a detail display screen displayed by the client terminal.

FIG. 23 is a flowchart illustrating example operation of downloading superimposed display use data, performed by the client terminal.

FIG. 24 is a sequence diagram illustrating example operation of downloading superimposed display use data from the superimposed display management system to the client terminal.

FIG. 25A is a diagram illustrating an example of a download screen. FIG. 25B is a diagram illustrating an example of a download setting screen.

FIG. 26 is a diagram illustrating patterns of the data format of download data set in a download setting field.

FIG. 27 is an example sequence diagram illustrating operation of accessing the superimposed display management system using download data, according to an instruction from other user.

FIG. 28 is a diagram illustrating an example of the download setting screen displayed by the client terminal.

FIGS. 29A and 29B are each a diagram illustrating an example management table.

FIGS. 30A and 30B are each a diagram illustrating an example of the index display screen.

FIG. 31 is a diagram illustrating an example of a management ID selection screen.

FIG. 32 is an example schematic diagram of the data management system according to a second example embodiment.

FIG. 33 is an example diagram illustrating a flow of generating a management ID and registering the management ID in the data management system, according to the second example embodiment.

FIG. 34 is an example functional block diagram illustrating the functions of the AP server, the DB server, and a controller included in the data management system according to the second example embodiment.

FIG. 35 is an example diagram illustrating a way of using an image capturing system.

FIG. 36 is a sequence diagram illustrating an image capture method.

FIG. 37A is an illustration of an example linked image capturing table. FIG. 37B is a diagram illustrating an example of a linked image capturing device setting screen.

FIG. 38 is a diagram illustrating an example of a setting screen displayed on the controller when superimposed display use data and superimposed display metadata are uploaded.

FIG. 39 is a diagram illustrating an example management table retained by the DB server.

FIG. 40 is a diagram illustrating another example of the setting screen displayed on the controller in a case where the controller transmits a selected file to the superimposed display management system.

FIG. 41 is an example functional block diagram illustrating the details of a metadata generating unit.

FIG. 42 is a diagram schematically illustrating images in the process of generating superimposed display parameters.

FIG. 43A is a diagram schematically illustrating determination of a peripheral area image. FIG. 43B is a diagram schematically illustrating determination of the peripheral area image.

FIG. 44A is a diagram schematically illustrating dividing of a second corresponding area into a plurality of grid areas. FIG. 44B is a diagram schematically illustrating dividing of the second corresponding area into a plurality of grid areas.

FIG. 45 is a diagram schematically illustrating a third corresponding area in an equirectangular projection image.

FIGS. 46A, 46B, and 46C are each a diagram schematically illustrating an image in the process of generating a correction parameter.

FIG. 47A is a diagram schematically illustrating grid areas in the second corresponding area. FIG. 47B is a diagram schematically illustrating grid areas in the third corresponding area.

FIG. 48 is an example flowchart illustrating a superimposed display parameter generation process.

FIG. 49 illustrates an equirectangular projection image generated by a special image capturing device using an equirectangular projection method.

FIG. 50 is a diagram illustrating an example of a high-definition planar image.

FIG. 51 is a two-dimensional diagram schematically illustrating a case where a planar image is superimposed on a spherical image.

FIG. 52A is a diagram schematically illustrating an example wide-angle image that is displayed without superimposed display. FIG. 52B is a diagram schematically illustrating an example telephoto image that is displayed without superimposed display. FIG. 52C is a diagram schematically illustrating an example wide-angle image that is displayed with superimposed display. FIG. 52D is a diagram schematically illustrating an example telephoto image that is displayed with superimposed display.

### DESCRIPTION OF EMBODIMENTS

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Hereinafter, as example modes of the present invention, a data management system and a data management method performed by the data management system will be described with reference to the drawings while using example embodiments.

### Structure of Existing Metadata

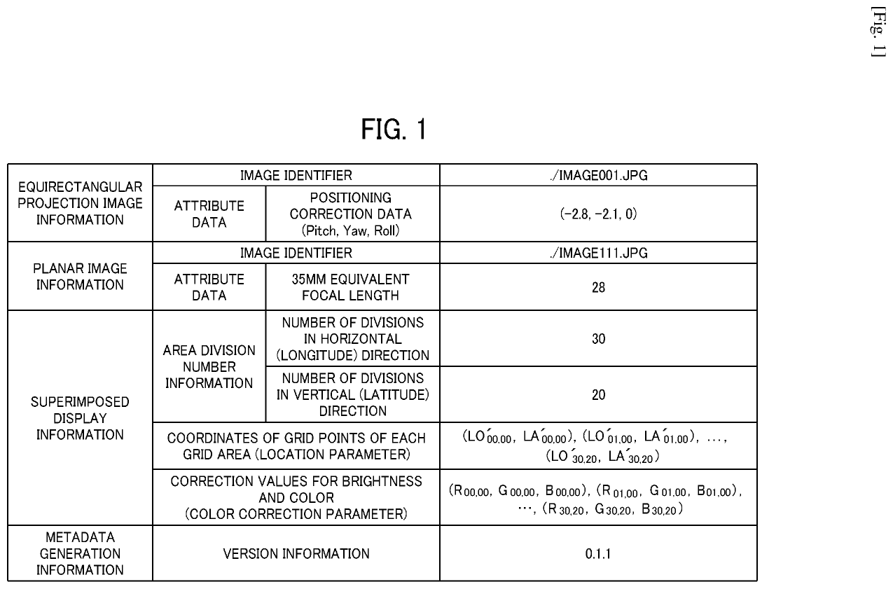

First, superimposed display metadata is described with reference to FIG. 1. As illustrated in FIG. 1, superimposed display metadata includes equirectangular projection image information, planar image information, superimposed display information, and metadata generation information. The equirectangular projection image information is information about wide-angle image data, and the planar image information is information about high-definition image data.

The equirectangular projection image information and the planar image information each include an image identifier. When the superimposed display metadata is provided, an equirectangular projection image and a planar image that are superimposed and displayed are identified. The superimposed display information includes a location parameter that indicates the position of the planar image in the equirectangular projection image.

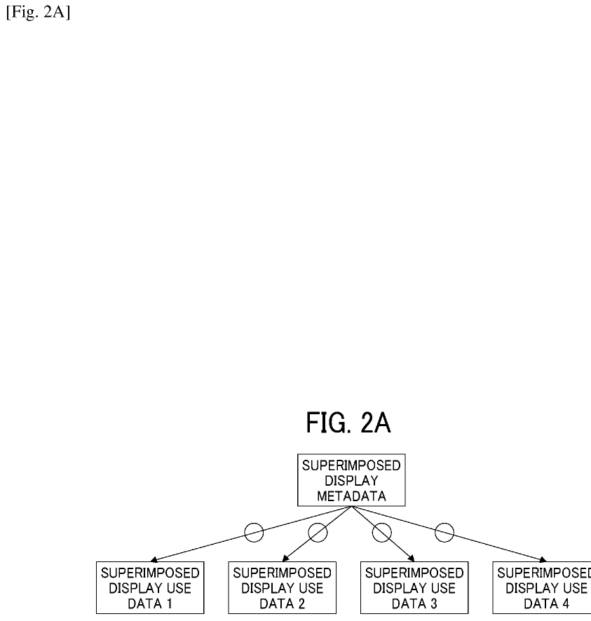

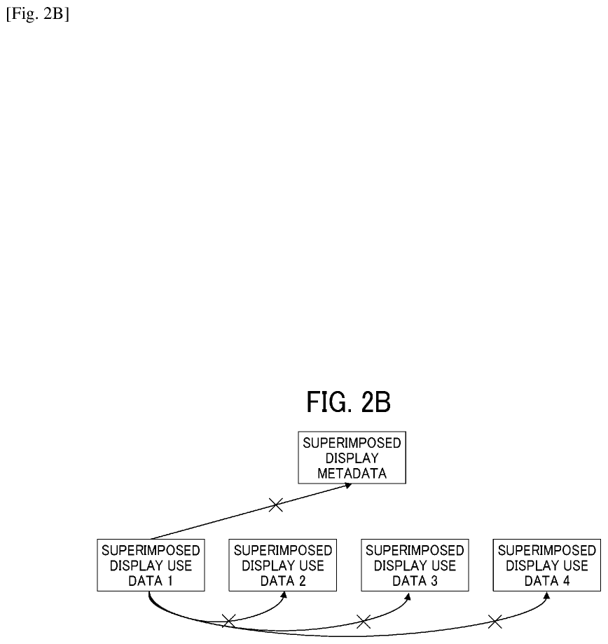

FIG. 2A is an example diagram schematically illustrating pieces of image data that can be identified from superimposed display metadata. FIG. 2B is an example diagram schematically illustrating a state where, from a piece of image data, it is not possible to identify superimposed display metadata or the other pieces of image data. The superimposed display metadata includes the image identifiers, and therefore, a user, etc. can identify pieces of superimposed display use data (an equirectangular projection image and one or more planar images to be used for superimposed display) when the superimposed display metadata is provided, as illustrated in FIG. 2A. More specifically, each piece of superimposed display use data is data of an image, a moving image, a sound, etc. used in superimposed display and is data selected by a user at the time of generating the superimposed display metadata.

However, the pieces of superimposed display use data do not include information about superimposed display, and therefore, it is not possible to reference the superimposed display metadata from any piece of superimposed display use data, as illustrated in FIG. 2B. Similarly, it is not possible to reference, from any piece of superimposed display use data, the other pieces of superimposed display use data. For example, even if a user knows the equirectangular projection image, the user is unable to easily identify a planar image to be superimposed on the equirectangular projection image.

### Overview of Management of Superimposed Display Use Data according to the Present Embodiments

In the present embodiments, a management table is generated, and pieces of superimposed display use data are managed in the management table by using a management ID. In the present embodiments, the table is used; however, the table need not be used in the management.

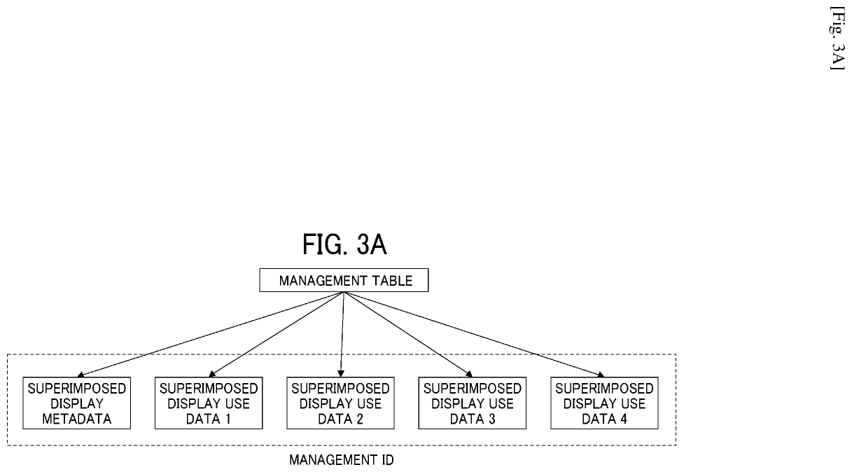

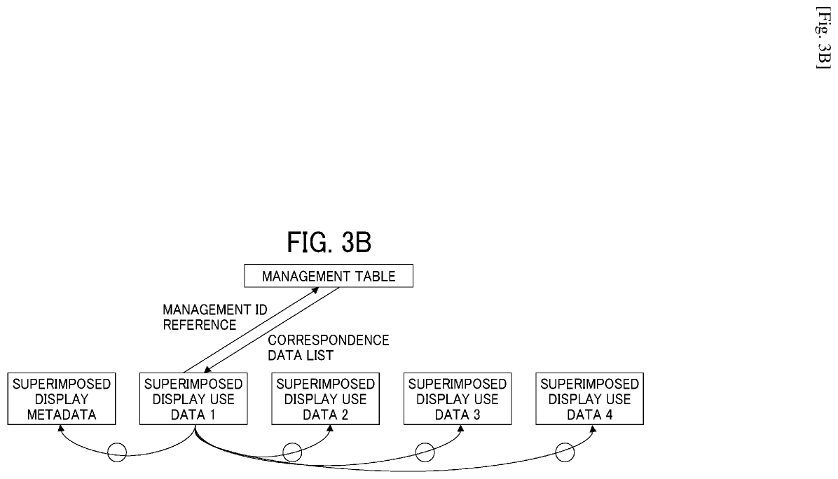

FIGS. 3A and 3B are example diagrams illustrating example management of superimposed display use data and superimposed display metadata by using the management table. In FIG. 3A, two or more pieces of superimposed display use data (an equirectangular projection image and one or more planar images) that are used in superimposed display and superimposed display metadata are assigned a common management ID.

FIG. 3B illustrates pieces of superimposed display use data that can be referenced by using the management ID. The superimposed display metadata and the pieces of superimposed display use data have the management ID in common. Therefore, when the management table is referenced by using the management ID of one piece of superimposed display use data, a correspondence data list indicating the superimposed display metadata and the other pieces of superimposed display use data that correspond to the management ID can be obtained, and the superimposed display metadata can be referenced from the one piece of superimposed display use data. The pieces of superimposed display use data have the management ID in common, and therefore, from the one piece of superimposed display use data, the other pieces of superimposed display use data can be referenced. FIG. 3B illustrates an example where, from superimposed display use data 1, superimposed display metadata and superimposed display use data 2 to superimposed display use data 4 can be referenced.

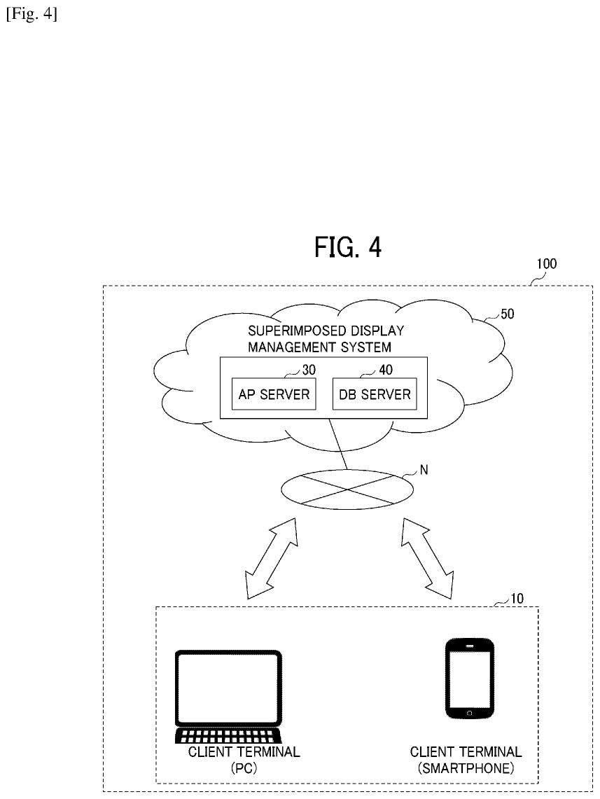

As described above, in a data management system 100 according to the present embodiments illustrated in FIG. 4, the management ID is assigned to pieces of superimposed display use data and superimposed display metadata, so that a user can identify, from a piece of superimposed display use data, superimposed display metadata and the other pieces of superimposed display use data without understanding the superimposed display metadata or without being aware of the presence of the superimposed display metadata.

A plurality of pieces of data that are combined and reproduced are pieces of data having a relation in which one of the pieces of data (first data) and the other piece of data (second data) are reproduced together or one of the pieces of data is reproduced and the other piece of data is subsequently reproduced. For example, in a case where a plurality of pieces of image data are present, these pieces of image data include a piece of data of an image of a wide image capture range and a piece of data of an image of a narrow image capture range to be superimposed on the image of a wide image capture range, the pieces of data being combined and reproduced. Further, the types of images may include a moving image and a still image. The images may be distinguished from each other on the basis of, for example, a difference in the resolution or a difference in the image capture date and time. A plurality of pieces of data include a piece of data of a moving image of a wide image capture range and a piece of data of a still image of a narrow image capture range to be superimposed on the moving image, the pieces of data being combined and reproduced, or include a piece of data of a still image of a wide image capture range and a piece of data of a moving image of a narrow image capture range to be superimposed on the still image, the pieces of data being combined and reproduced.

Metadata is data that includes location information about an image that is superimposed on another wide-angle image. In the present embodiments, metadata is described as superimposed display metadata.

A common identifier is an identifier for associating a plurality of pieces of image data with each other. In the present embodiments, a common identifier is described as a management ID.

### Example System Configuration

FIG. 4 is an example system configuration diagram of the data management system 100 of the present embodiments. The data management system 100 includes a superimposed display management system 50 that manages data used in superimposed display, and a client terminal 10 that is used by a user. The superimposed display management system 50 and the client terminal 10 are connected to each other via a network N, which is, for example, the Internet.

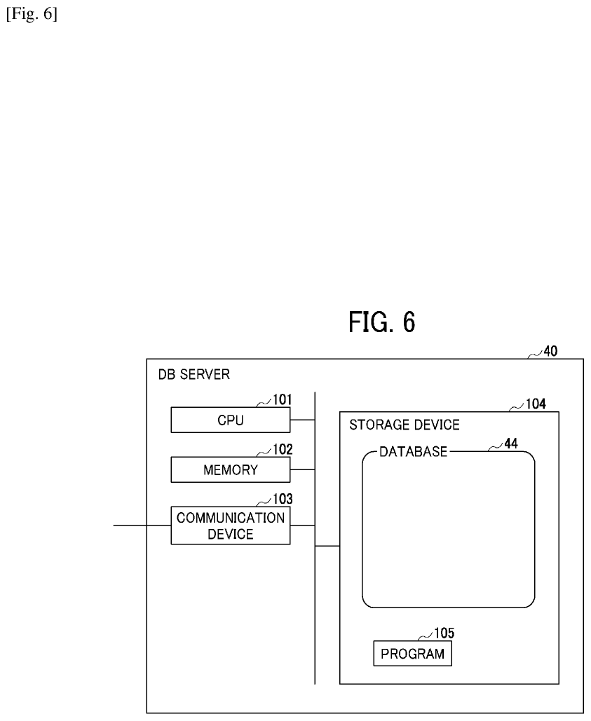

The superimposed display management system 50 is implemented by at least one information processing apparatus such that it may be alternatively referred to as an information processing system. The superimposed display management system 50 assigns a management ID to superimposed display use data. Specifically, in this embodiment, the superimposed display management system 50 includes a database server (hereinafter referred to as a DB server 40) that stores data used in processing and an application server (hereinafter referred to as an AP server 30) that performs processing by using the data retained by the DB server 40. The DB server 40 and the AP server 30 can be implemented as one integrated server; however, when the DB server 40 and the AP server 30 are separated from each other, the processing speed can be increased by distributed processing, the backup frequency of a database 44 (see FIG. 6) in which data is frequently updated can be changed, and a measure can be taken against data corruption by duplicated data, which leads to increased security of the data management system 100.

The superimposed display management system 50 may be applicable to cloud computing. Cloud computing is a use form in which resources on a network are used without awareness of a specific hardware resource.

The client terminal 10 is an information processing apparatus or a terminal device operated by a user and is a client that requests processing from the superimposed display management system 50 to use a service of the superimposed display management system 50. In FIG. 4, the client terminal 10 is any desired information processing apparatus such as a personal computer (PC) or a smartphone, provided with a network connection function. It is desirable that browser software run on the client terminal 10. The client terminal 10 may be a tablet terminal, a personal digital assistant (PDA), a mobile phone, a wearable PC, etc. Alternatively, the client terminal 10 may be an electronic whiteboard, a projector, a videoconference terminal, etc.

The client terminal 10 includes a communication device for making a connection to the network N, an input device for selecting an item in a service, inputting text information, etc., and a display for displaying predetermined screens, images, and moving images provided via the network N, and has at least a function of accepting a user instruction via the input device and transmitting the user instruction to the superimposed display management system 50, as described below.

### Example Hardware Configuration

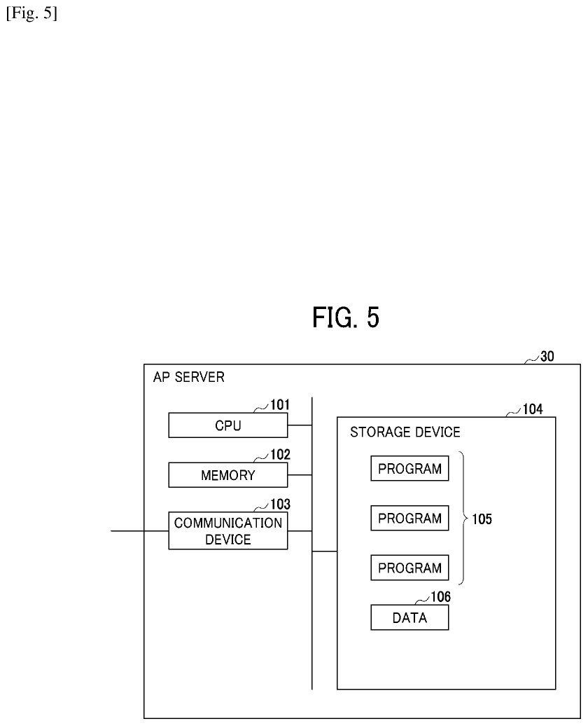

FIG. 5 is an example hardware configuration diagram of the AP server 30. As illustrated in FIG. 5, the AP server 30 is a server apparatus having functions of a general information processing apparatus (computer). The AP server 30 includes a central processing unit (CPU) 101, a memory 102, a communication device 103, and a storage device 104. FIG. 5 illustrates only main functions. The CPU 101 executes a program stored in the storage device 104 to process data, control the AP server 30 as a whole, and perform various types of determination, computation, and processing. The memory 102 includes a volatile memory element, such as a random access memory (RAM), and is a work area to which the program stored in the storage device 104 is loaded. The storage device 104 is constituted by, for example, a hard disk or a solid state drive (SSD) including a nonvolatile memory element. In the storage device 104 of the AP server 30, various programs 105 and data 106 including program settings and parameters are stored.

The communication device 103 is, for example, a network interface card (NIC) and makes a connection to the network N to control communication with the superimposed display management system 50. The AP server 30 further incudes a bus line, and the constituent elements including the CPU 101, the memory 102, the storage device 104, and the communication device 103 are electrically connected to each other via the bus line.

FIG. 6 is an example hardware configuration diagram of the DB server 40. In the description of the DB server 40, a difference from the AP server 30 is mainly described. The DB server 40 includes the database 44 in the storage device 104. In the database 44, a management table, superimposed display use data, superimposed display metadata, etc. are stored.

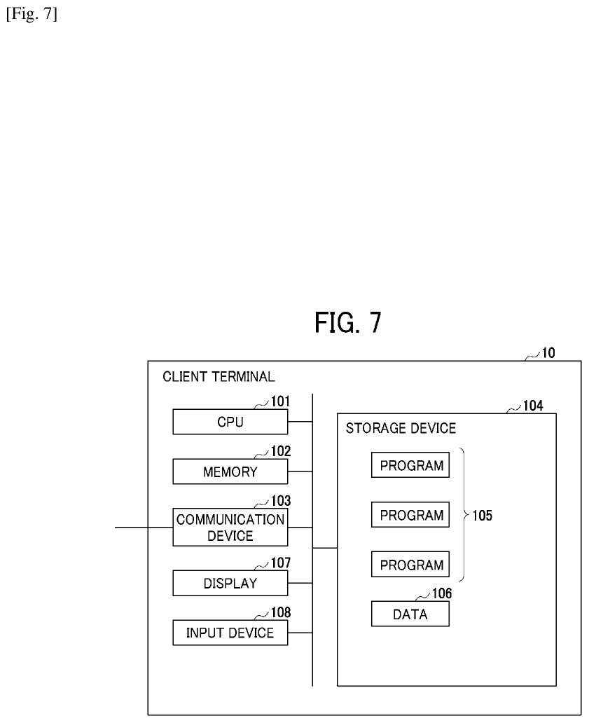

FIG. 7 is an example hardware configuration diagram of the client terminal 10. In the description of the client terminal 10, differences from the AP server 30 are mainly described. The client terminal 10 further includes a display 107 and an input device 108. The display 107 is a flat panel display (display device), such as a liquid crystal display or an organic electroluminescent (EL) display. The input device 108 is, for example, a keyboard, a mouse, or a touch panel.

### FIRST EXAMPLE EMBODIMENT

In a first example embodiment, the data management system 100 is described in which superimposed display metadata is generated for superimposed display use data that has already been obtained and in which a management ID is assigned.

### Functions

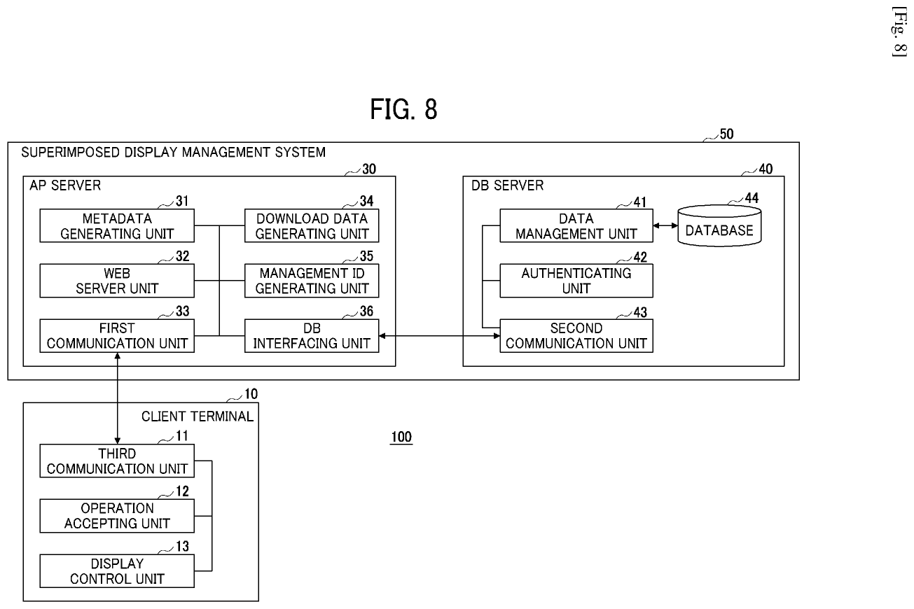

FIG. 8 is an example functional block diagram illustrating the functions of the AP server 30, the DB server 40, and the client terminal 10 included in the data management system 100.

### AP Server

The AP server 30 includes a metadata generating unit 31, a Web server unit 32, a first communication unit 33, a download data generating unit 34, a management ID generating unit 35, and a DB interfacing unit 36. These units included in the AP server 30 are functions or means that are implemented by one or more of the constituent elements illustrated in FIG. 5 operating in accordance with instructions given by the CPU 101 on the basis of the program loaded to the memory 102 from the storage device 104.

The first communication unit 33 transmits/receives various types of data to/from the client terminal 10. In the first example embodiment, the first communication unit 33 receives superimposed display use data and information about a specified file from the client terminal 10 and transmits screen information about various Web pages that are displayed by the client terminal 10.

The Web server unit 32 has a function of a Web server that returns a Hypertext Transport Protocol (HTTP) response including screen information in response to an HTTP request and a function of a Web application. The screen information is described in HyperText Markup Language (HTML), Cascading Style Sheet (CSS), JavaScript (registered trademark), etc. and is provided from the Web server unit 32 as a Web page. The Web application is software that is run by cooperation of a program in a script language (for example, JavaScript (registered trademark)) running on browser software and a program in the Web server and is used on the browser software, or is the mechanism of the software.

The metadata generating unit 31 generates superimposed display metadata illustrated in FIG. 1 by combining two or more pieces of superimposed display use data transmitted from the client terminal 10. The details will be described below.

The management ID generating unit 35 chooses and assigns a common (same) management ID to pieces of superimposed display use data that are used in superimposed display and superimposed display metadata generated on the basis of these pieces of superimposed display use data.

The DB interfacing unit 36 controls communication with the DB server 40 to interface with the DB server 40. For example, the DB interfacing unit 36 calls an authenticating unit 42 of the DB server 40 at the time of user authentication. The DB interfacing unit 36 transmits superimposed display use data to the DB server 40 at the time of uploading the superimposed display use data, and obtains superimposed display use data specified by a user and superimposed display metadata from the DB server 40.

The download data generating unit 34 generates download data that includes at least a management ID. The download data generating unit 34 may generate download data that includes superimposed display use data and superimposed display metadata in addition to the management ID. For the download data, patterns 1 to 5 are available as the data format, which will be described in detail below. With the download data, superimposed display use data and superimposed display metadata can be distributed, and any client terminal can perform superimposed display using superimposed display use data.

### DB Server

The DB server 40 includes a data management unit 41, the authenticating unit 42, and a second communication unit 43. These units included in the DB server 40 are functions or means that are implemented by one or more of the constituent elements illustrated in FIG. 6 operating in accordance with instructions given by the CPU 101 on the basis of the program loaded to the memory 102 from the storage device 104.

The data management unit 41 registers superimposed display use data and superimposed display metadata in the database 44 and obtains superimposed display use data and superimposed display metadata from the database 44.

The authenticating unit 42 performs processing for user authentication and returns the result indicating whether authentication is successful or fails to the AP server 30. The authentication method may be a method using a combination of a user ID and a password, an integrated circuit (IC) card, or biometric authentication information.

The second communication unit 43 communicates with the AP server 30. That is, the second communication unit 43 transmits and receives superimposed display use data and superimposed display metadata. The second communication unit 43 may communicate with the client terminal 10.

### Client Terminal

The client terminal 10 includes a third communication unit 11, an operation accepting unit 12, and a display control unit 13. These units included in the client terminal 10 are functions or means that are implemented by one or more of the constituent elements illustrated in FIG. 7 operating in accordance with instructions given by the CPU 101 on the basis of the program loaded to the memory 102 from the storage device 104.

The third communication unit 11 transmits/receives various types of data to/from the AP server 30. In the first example embodiment, the third communication unit 11 transmits superimposed display use data and information about a specified file to the AP server 30 and receives screen information about a Web page, etc. from the AP server 30.

The operation accepting unit 12 accepts various user operations performed at the client terminal 10. For example, the operation accepting unit 12 accepts selection of superimposed display use data, etc. The display control unit 13 analyzes screen information received by the third communication unit 11 and displays Web pages (various screens) on the display 107 (display device). The client terminal 10 may run a dedicated application instead of browser software to communicate with the superimposed display management system 50.

### Overall Operation

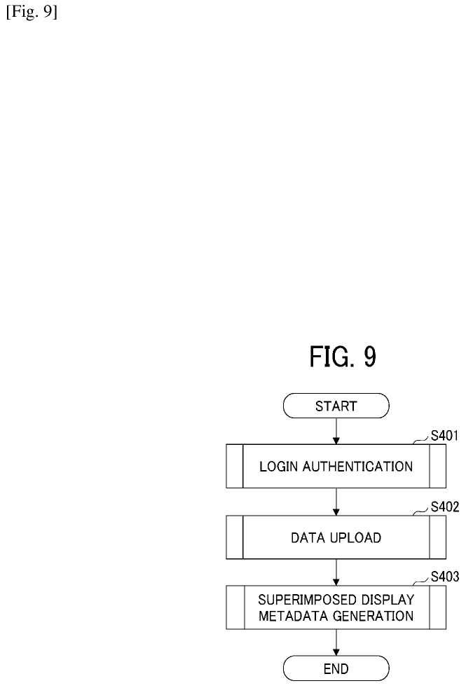

A method for registering a management ID associated with generation of superimposed display metadata is described with reference to FIG. 9. FIG. 9 is an example flowchart illustrating a procedure in which the AP server 30 generates superimposed display metadata. For example, a management ID is generated after superimposed display metadata has been generated.

First, a user operates the client terminal 10 to log in to the superimposed display management system 50. The superimposed display management system 50 performs user authentication (step S401).

When the user authentication is successfully completed (the user successfully logs in to the superimposed display management system 50), the user performs at the client terminal 10 an operation of uploading superimposed display use data to the superimposed display management system 50. Accordingly, the client terminal 10 uploads the superimposed display use data to the superimposed display management system 50 (step S402).

The superimposed display management system 50 generates superimposed display metadata (step S403). After the superimposed display metadata has been generated, a management ID can be generated. The management ID may be generated before the superimposed display metadata is generated.

In a case where superimposed display use data has already been uploaded to the superimposed display management system 50, the data upload step (step 5402) can be skipped. The sequence in each step is described in detail below.

### User Authentication

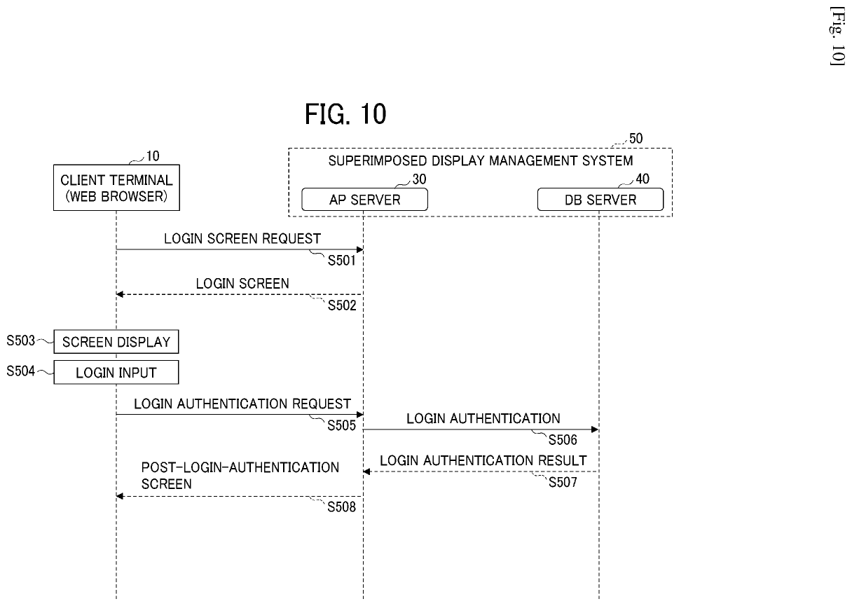

FIG. 10 is an example sequence diagram illustrating a procedure in which the superimposed display management system 50 authenticates a user in response to a login operation by the user. The process for a login to the superimposed display management system 50 is described with reference to FIG. 10.

The superimposed display management system 50 and the client terminal 10 are connected to the network, and a user can access the superimposed display management system 50 via a Web browser by inputting the uniform resource locator (URL) of the superimposed display management system 50 to the Web browser.

SS01: When the client terminal 10 accesses the superimposed display management system 50, the client terminal 10 transmits a login screen request to the AP server 30.

S502: The first communication unit 33 of the AP server 30 receives the login screen request, and the Web server unit 32 transmits screen information about a login screen to the client terminal 10.

S503: The third communication unit 11 of the client terminal 10 (Web browser) receives the screen information about the login screen, and the display control unit 13 displays the login screen on the basis of the received screen information.

S504: The user inputs their user ID and login password on the login screen. The operation accepting unit 12 accepts the input user ID and login password.

S505: When the user presses a “login” button provided on the login screen, the operation accepting unit 12 accepts the operation, and the third communication unit 11 transmits a login authentication request to the AP server 30.

S506: The first communication unit 33 of the AP server 30 receives the login authentication request. The login authentication request includes information about the user ID and login password. When the login authentication request is transmitted, the DB interfacing unit 36 of the AP server 30 requests the DB server 40 to authenticate the login including the user ID and login password.

S507: The second communication unit 43 of the DB server 40 receives the request for login authentication, and the authenticating unit 42 performs login authentication by checking the user ID and login password included in the login authentication request against each record of a user table in the database 44 and transmits the result of login authentication via the second communication unit 43.

S508: The DB interfacing unit 36 of the AP server 30 receives the result of login authentication, and the Web server unit 32 generates and transmits via the first communication unit 33 a post-login-authentication screen. The Web server unit 32 transmits the post-login-authentication screen if the authentication is successful, or transmits a login error screen if the authentication fails.

### Screen Generation/Display

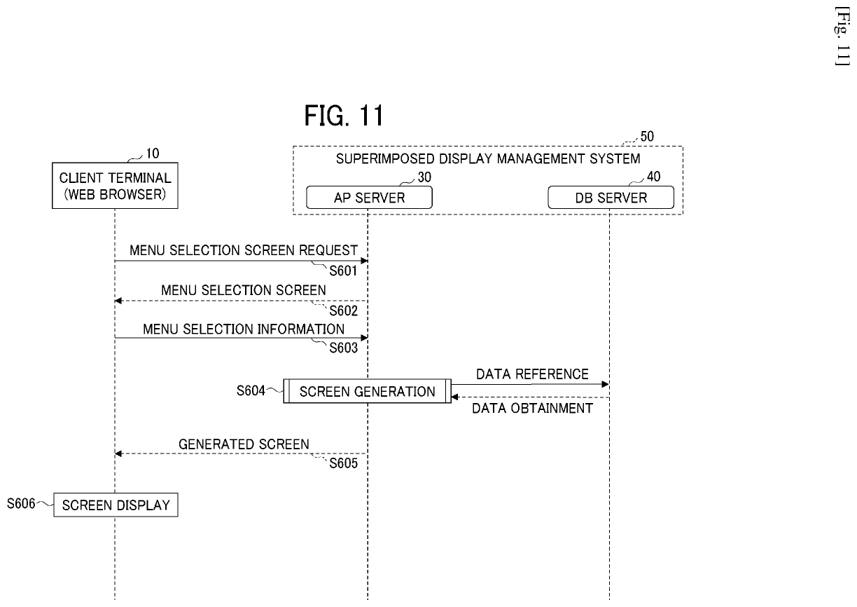

FIG. 11 is an example sequence diagram illustrating a screen generation/display procedure in which the superimposed display management system 50 generates a screen that is displayed on the client terminal 10.

S601: When the user operates the Web browser installed in the client terminal 10, the third communication unit 11 transmits a menu selection screen request to the AP server 30.

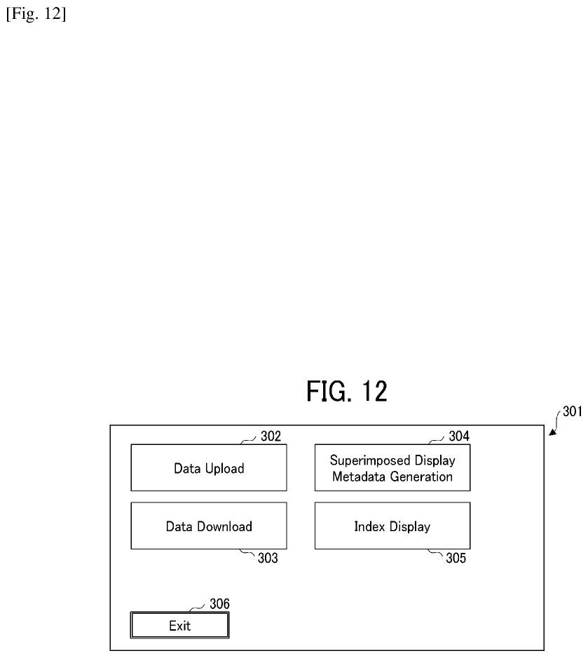

S602: The first communication unit 33 of the AP server 30 receives the menu selection screen request, and the Web server unit 32 transmits screen information about a menu selection screen 301 illustrated in FIG. 12 to the client terminal 10.

S603: The third communication unit 11 of the client terminal 10 receives the screen information about the menu selection screen 301, and the display control unit 13 displays the menu selection screen 301. FIG. 12 illustrates a display example of the menu selection screen 301. When the user uses the input device 108 of the client terminal 10 to select a desired menu on the menu selection screen 301, the operation accepting unit 12 accepts the selection. Accordingly, the third communication unit 11 transmits menu selection information to the AP server 30.

S604: The first communication unit 33 of the AP server 30 causes the DB interfacing unit 36 to obtain data on the basis of the menu selection information. The DB interfacing unit 36 obtains superimposed display use data from the DB server 40 as needed in accordance with the menu selection information, and the Web server unit 32 generates screen information corresponding to the menu selected by the user. Therefore, the specific screen varies. Display examples of a screen displayed for each menu in screen generation (step S604) will be described below.

S605: The first communication unit 33 of the AP server 30 transmits the generated screen information to the client terminal 10.

S606: The third communication unit 11 of the client terminal 10 receives the screen information, and the display control unit 13 analyzes the screen information and displays a screen.

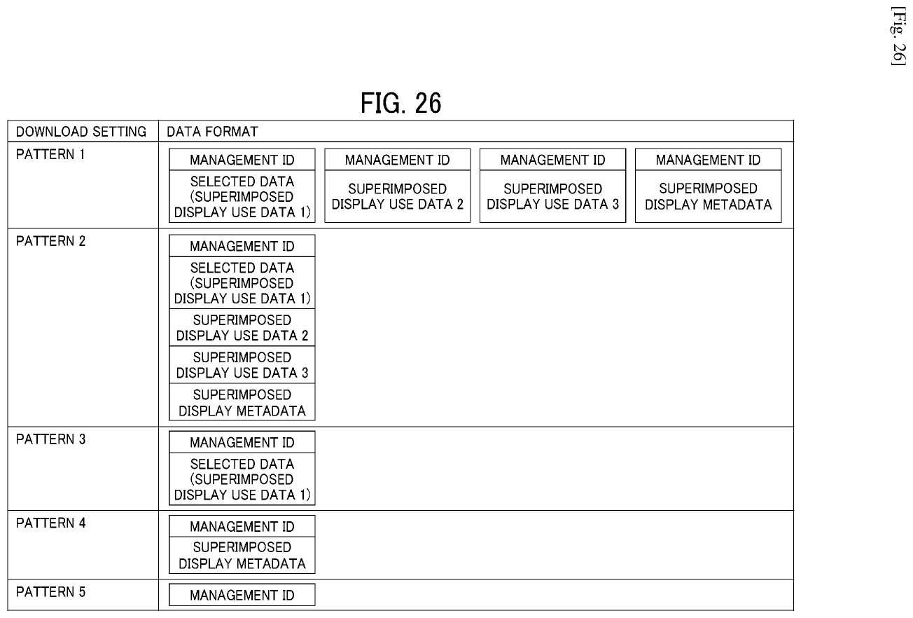

FIG. 12 illustrates an example of the menu selection screen 301. The menu selection screen 301 is a screen for the user to select a service of the superimposed display management system 50, and buttons for calling several services of the superimposed display management system 50 are displayed on the screen. In FIG. 12, a data upload button 302, a data download button 303, a superimposed display metadata generation button 304, an index display button 305, and an exit button 306 are provided. The data upload button 302 is a button for uploading superimposed display use data owned by the user to the DB server 40. The data download button 303 is a button for the client terminal 10 to download download data that includes at least a management ID. The data format of download data has patterns 1 to 5, which will be described with reference to FIG. 26. The superimposed display metadata generation button 304 is a button for causing the AP server 30 to generate superimposed display metadata. The index display button 305 is a button for the client terminal 10 to display various types of superimposed display use data associated with respective management IDs.

The user can make requests for various services to the AP server 30 via the client terminal 10 by using the menu selection screen 301. Information about the menu selection screen 301 is predetermined and is updated less frequently, and therefore, the screen information may be retained in advance in the AP server 30.

### Data Upload

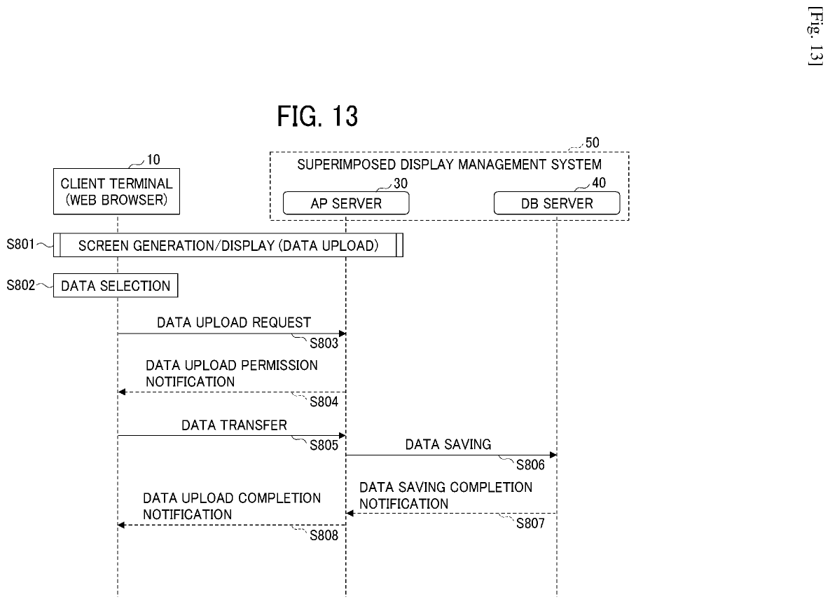

FIG. 13 is an example sequence diagram illustrating a procedure in which the client terminal 10 uploads superimposed display use data to the superimposed display management system 50.

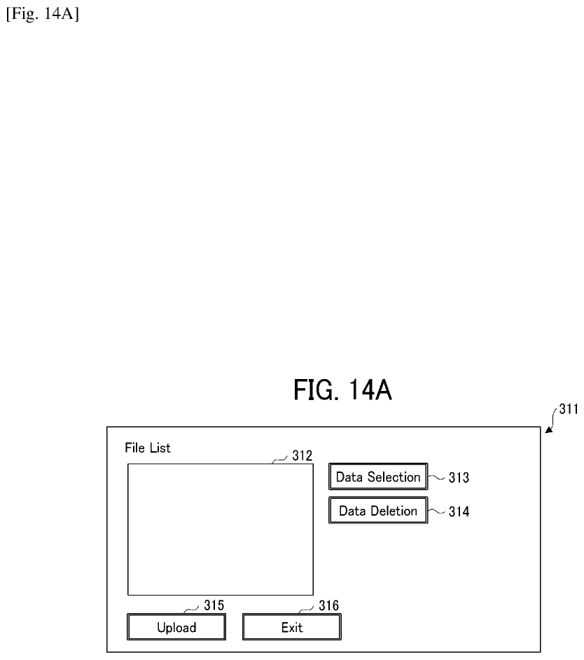

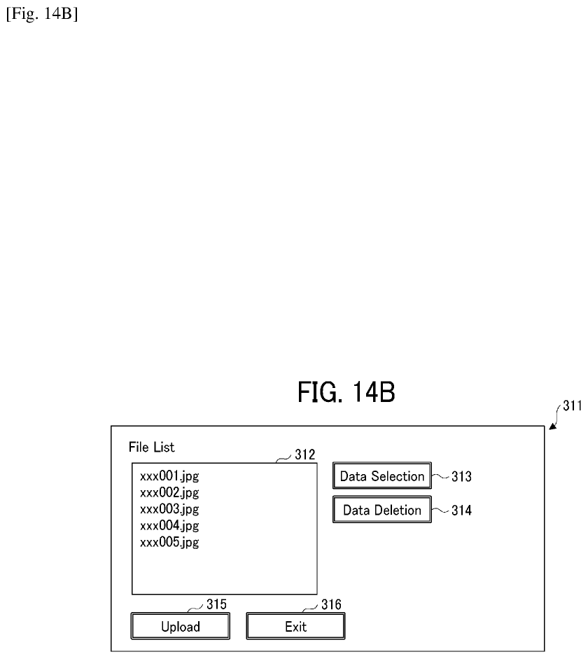

S801: In screen generation/display in step S801, a predetermined screen is generated in accordance with the sequence diagram of screen generation/display described with reference to FIG. 11. Step S801 represents a case where the user selects the data upload button 302 on the menu selection screen 301. Therefore, a data upload screen 311 is generated. Examples of the data upload screen 311 are illustrated in FIGS. 14A and 14B.

S802: The user selects on the data upload screen 311 superimposed display use data that the user wants to upload to the superimposed display management system 50. The operation accepting unit 12 accepts selection of the superimposed display use data.

S803: After the user has registered the superimposed display use data to be uploaded in a file list field, the user presses an upload button 315. The operation accepting unit 12 accepts the operation, and the third communication unit 11 transmits a data upload request to the AP server 30.

S804: The first communication unit 33 of the AP server 30 receives the data upload request and transmits a data upload permission notification to the client terminal 10. In a case where data upload is not permitted, the first communication unit 33 transmits a data upload prohibition notification to the client terminal 10. The first communication unit 33 may transmit to the client terminal 10 a screen with which the user can recognize that data upload is prohibited. The case where data upload is prohibited is, for example, a case where the format of the superimposed display use data is not appropriate, a case where the file size is excessively large, or a case where the DB server 40 is in an abnormal state.

S805: When the third communication unit 11 of the client terminal 10 receives the data upload permission notification, the third communication unit 11 transmits the superimposed display use data registered in a file list field 312 to the AP server 30.

S806: When the first communication unit 33 of the AP server 30 receives the superimposed display use data, the DB interfacing unit 36 transmits the superimposed display use data to the DB server 40. Accordingly, the data management unit 41 saves the superimposed display use data in the database 44. At this point in time, a management ID is not assigned.

S807: After data saving is completed, the data management unit 41 transmits a data saving completion notification to the AP server 30 via the second communication unit 43.

S808: The DB interfacing unit 36 of the AP server 30 receives the data saving completion notification, and the first communication unit 33 transmits a data upload completion notification to the client terminal 10. Consequently, the data upload processing is completed.

FIGS. 14A and 14B illustrate display examples of the data upload screen 311. FIG. 14A illustrates a display example of the data upload screen 311 displayed in step S801 in FIG. 13. The data upload screen 311 includes the file list field 312, a data selection button 313, a data deletion button 314, the upload button 315, and an exit button 316.

When the user presses the data selection button 313 on the data upload screen 311, the operation accepting unit 12 accepts the operation, and the display control unit 13 displays a list of pieces of superimposed display use data stored on the client terminal 10 currently used.

When the user uses the input device 108 of the client terminal 10 to select, from the data list, pieces of data that the user wants to upload, the data names (file names) are registered in the file list field 312, as illustrated in FIG. 14B. In a case where a piece of superimposed display use data that is not to be uploaded is registered in the file list field 312 by mistake, the user selects the file in the file list field 312 and presses the data deletion button 314. The operation accepting unit 12 accepts the operation, and the display control unit 13 deletes the selected piece of superimposed display use data from the file list field 312.

The upload button 315 is a button for uploading the pieces of superimposed display use data in the file list field 312 to the superimposed display management system 50, and the exit button 316 is a button for closing the data upload screen 311.

### Generation of Superimposed Display Metadata without Registration of Management ID

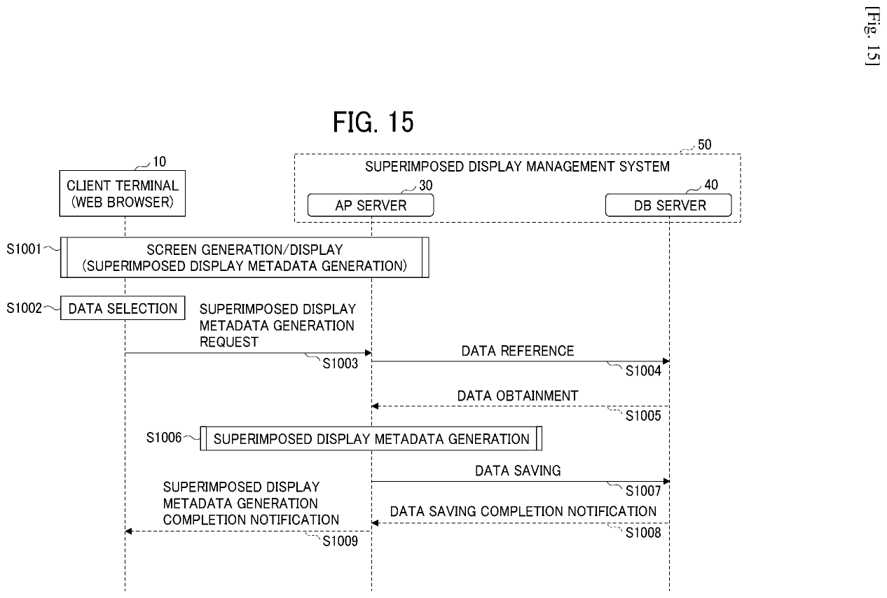

FIG. 15 is an example sequence diagram illustrating the AP server 30 generating superimposed display metadata. A case where a management ID is not registered is described as a comparative example for illustrative purposes.

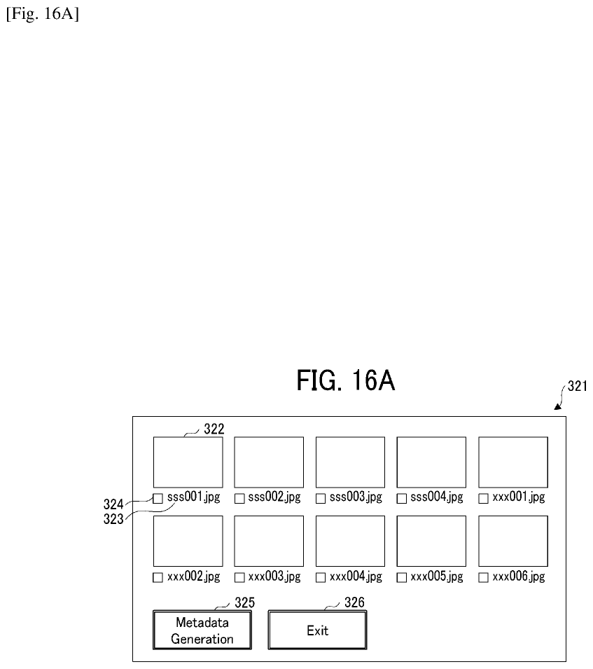

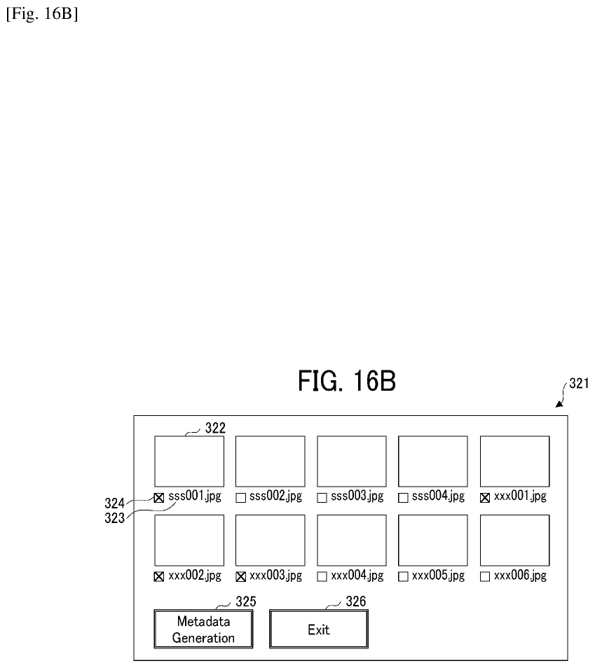

S1001: The client terminal 10 and the AP server 30 generate and display a predetermined screen in accordance with the screen generation/display sequence described with reference to FIG. 11. In step S1001, it is assumed that the user selects the superimposed display metadata generation button 304 on the menu selection screen 301 and the client terminal 10 displays a superimposed display metadata generation screen 321. FIGS. 16A and 16B illustrate display examples of the superimposed display metadata generation screen 321.

S1002: The user uses the input device 108 of the client terminal 10 to check a checkbox 324 for a piece of superimposed display use data for which superimposed display metadata is to be generated. The operation accepting unit 12 accepts the selection, and the display control unit 13 displays a check mark in the checkbox 324.

S1003: When data selection is completed, the user presses a metadata generation button 325 on the superimposed display metadata generation screen 321. The operation accepting unit 12 accepts the operation, and the third communication unit 11 transmits a superimposed display metadata generation request to the AP server 30.

S1004: The first communication unit 33 of the AP server 30 receives the superimposed display metadata generation request. The superimposed display metadata generation request includes information for identifying files, such as the file names of the selected pieces of superimposed display use data. The DB interfacing unit 36 of the AP server 30 requests the selected pieces of superimposed display use data from the DB server 40 in accordance with the superimposed display metadata generation request.

S1005: The second communication unit 43 of the DB server 40 receives the request for the pieces of superimposed display use data, and the data management unit 41 obtains the requested pieces of superimposed display use data from the database 44. The second communication unit 43 transmits the pieces of superimposed display use data to the AP server 30.

S1006: When the DB interfacing unit 36 of the AP server 30 receives the pieces of superimposed display use data, the metadata generating unit 31 of the AP server 30 uses the pieces of superimposed display use data to generate superimposed display metadata. The generation of superimposed display metadata will be described in detail below.

S1007: When the superimposed display metadata is generated, the DB interfacing unit 36 of the AP server 30 transmits the superimposed display metadata to the DB server 40. The second communication unit 43 of the DB server 40 receives the superimposed display metadata, and the data management unit 41 saves the superimposed display metadata in the database 44.

S1008: When data saving is completed, the second communication unit 43 of the DB server 40 transmits a data saving completion notification to the AP server 30.

S1009: The DB interfacing unit 36 of the AP server 30 receives the data saving completion notification, and the first communication unit 33 transmits a superimposed display metadata generation completion notification to the client terminal 10. Consequently, the superimposed display metadata generation processing is completed.

FIGS. 16A and 16B illustrate display examples of the superimposed display metadata generation screen 321 displayed by the client terminal 10. In FIG. 16A, file names 323 and thumbnail images 322 of pieces of superimposed display use data uploaded to the superimposed display management system 50 are displayed. For each thumbnail image (file), the checkbox 324 is provided. The pieces of superimposed display use data displayed on the superimposed display metadata generation screen 321 are managed in association with, for example, the user ID of the logged-in user. Accordingly, the list of the pieces of superimposed display use data associated with the user ID can be displayed by the client terminal 10.

The metadata generation button 325 on the superimposed display metadata generation screen 321 is a button for requesting the AP server 30 to generate metadata of pieces of superimposed display use data for each of which the checkbox 324 is checked, and an exit button 326 is a button for closing the superimposed display metadata generation screen 321.

FIG. 16B illustrates a state where the checkboxes 324 are checked and several pieces of superimposed display use data are selected. The user uses the input device 108 of the client terminal 10 to check the checkbox 324 for a piece of superimposed display use data for which superimposed display metadata is to be generated. The thumbnail images 322 are provided, and therefore, the user can easily select an equirectangular projection image. The user selects a planar image that represents a part of the equirectangular projection image. FIG. 16B illustrates a state where the user selects one equirectangular projection image and three planar images.

### Generation of Superimposed Display Metadata with Registration of Management ID

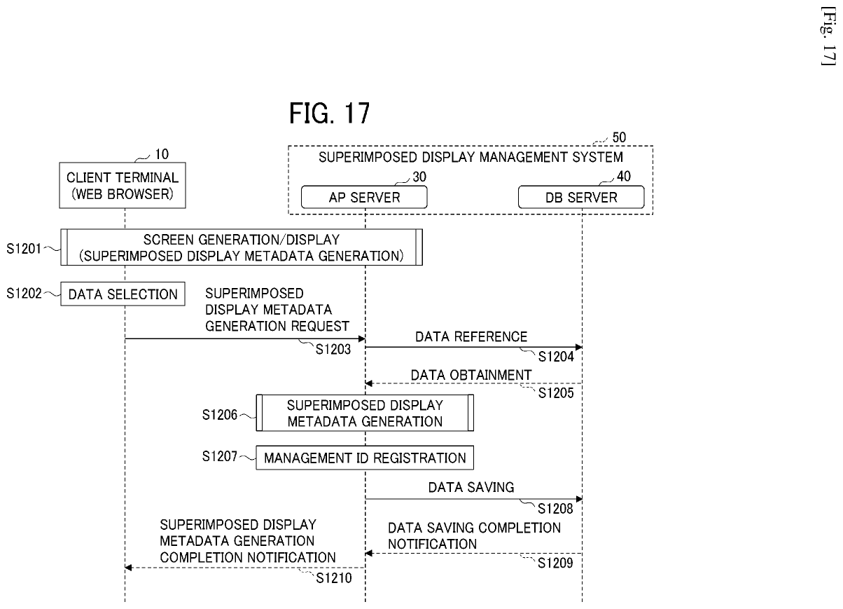

FIG. 17 is an example sequence diagram illustrating operation of generating superimposed display metadata by the AP server 30. A case where a management ID is registered is described with reference to FIG. 17. Regarding FIG. 17, a difference from FIG. 15 is mainly described.

FIG. 17 is different from FIG. 15 in that a management ID registration step (step S1207) is added, and the management ID registration step (step S1207) is described. In the management ID registration step (step S1207), the management ID generating unit 35 generates and registers a management ID for superimposed display metadata generated in superimposed display metadata generation and for pieces of superimposed display use data. The management ID is an identifier of the set of pieces of superimposed display use data used in superimposed display and superimposed display metadata, and is a combination of characters, numbers, symbols, etc. that does not match the other management IDs. The management ID may be determined by using blockchain technology.

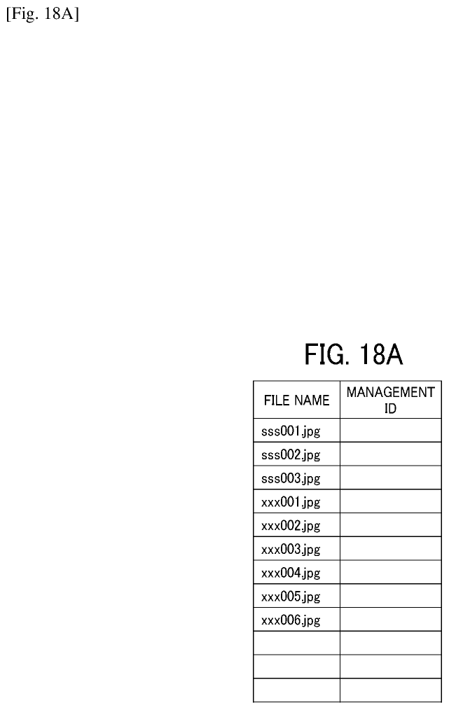

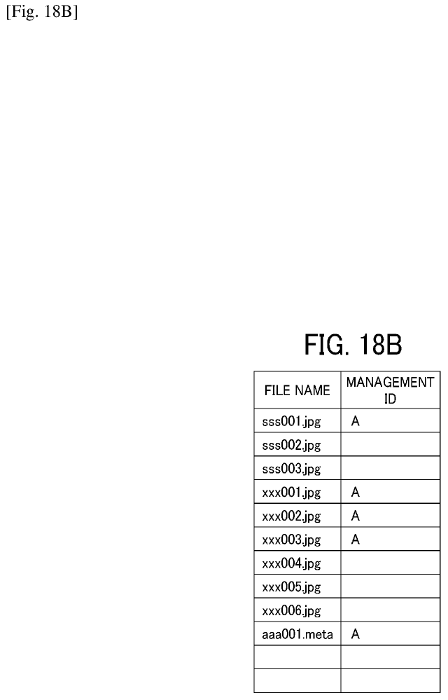

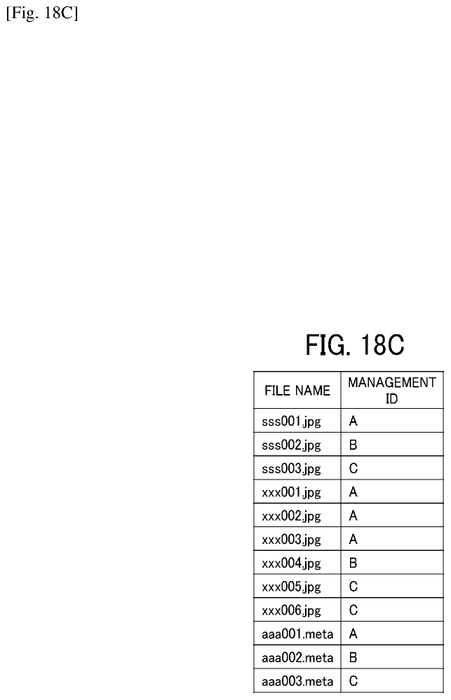

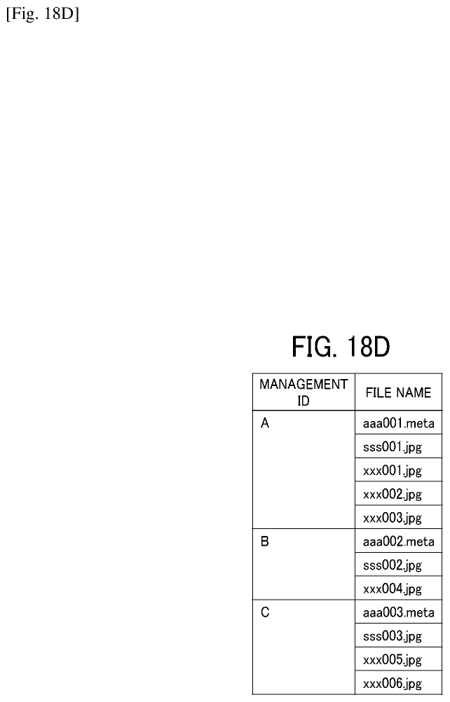

Now, the method for registering the management ID for the superimposed display metadata and the pieces of superimposed display use data is described. FIGS. 18A to 18D are diagrams illustrating a management table used in the management ID registration step (step S1207). FIG. 18A illustrates a management table saved in the database 44 of the DB server 40 and formed of records each including two fields, namely, a “file name” field and a “management ID” field. In the “file name” column of the management table, pieces of superimposed display use data uploaded to the superimposed display management system 50 are registered. In the data saving step (S1208) in which the AP server 30 saves data on the DB server 40, the data management unit 41 registers the file names of uploaded pieces of superimposed display use data in the “file name” column of the management table.

In the management ID registration step (step S1207), the management ID generating unit 35 registers the superimposed display metadata generated in the superimposed display metadata generation step in the “file name” column of the management table and registers a common management ID for pieces of superimposed display use data used in generation of the superimposed display metadata and for the generated superimposed display metadata.

For example, in FIG. 18A, nine image files (having the jpg file extension) are registered in the “file name” column of the management table. In a case where superimposed display metadata (aaa001.meta) is generated in the superimposed display metadata generation step, the management ID generating unit 35 registers the superimposed display metadata (aaa001.meta) in the “file name” column of the management table in the management ID registration step (step S1207). The resulting management table is as illustrated in FIG. 18B. When it is assumed that four pieces of superimposed display use data (sss001.jpg, xxx001.jpg, xxx002.jpg, and xxx003.jpg) are used in generation of the superimposed display metadata as illustrated in FIG. 18B, a common management ID “A” is registered in the “management ID” field of the record of each of the pieces of superimposed display use data and the superimposed display metadata registered in the “file name” column of the management table.

FIG. 18C illustrates the management table in a case where other pieces of superimposed display metadata (aaa002.meta and aaa003.meta) are generated. As illustrated, the same management ID is assigned to each piece of superimposed display use data referenced when superimposed display metadata is generated and to the superimposed display metadata.

FIG. 18D illustrates the management table in which each management ID and corresponding pieces of superimposed display use data and superimposed display metadata are associated with each other and displayed. The management table in FIG. 18D incudes the same information as that in the management table in FIG. 18C. Superimposed display metadata and pieces of superimposed display use data used in superimposed display can be easily identified with the common management ID.

In FIGS. 18B to 18D, each management ID is represented by a simple alphabetic character “A”, “B”, or “C” for simplified description. However, the management ID is not limited to an alphabetic character and may be formed of a plurality of characters or numbers or may be a combination of characters and numbers. The management ID may be systematically generated or may be generated at random. Taking into consideration security, the whole management ID or part of the management ID may be encrypted.

In the first example embodiment, the example case is described where the same management ID is registered for the superimposed display metadata and the pieces of superimposed display use data at a time. However, the present embodiments are not limited to this case, and a case where part of the management ID is the same and a case where completely different management IDs are used but are determined to belong to the same group by referencing another table or by using a specific algorithm are within the scope of the present invention.

For example, a part of the management IDs may be made the same. For example, assuming that one of the management IDs (first management ID) is “A”, the management ID related to the first management ID (second management ID) is assigned with “A-0”. Since the second management ID includes a part of the first management ID, it can be determined that these management IDs belong to the same group. In another example, even when the management IDs are completely different, as long as they are associated via the same identifier, for example, it can be determined that these management IDs belong to the same group. For example, assuming that the first management ID is “A”, and the second management ID is “0AB%08”, are associated via the same identifier “0001”, it is determined that these management IDs belong to the same group. Specifically, these three different identifiers may be managed using a management table, which stores information indicating association of these three different identifiers. Further, as long as superimposed display metadata and pieces of superimposed display use data used in generation of the superimposed display metadata can be referenced with the management ID in the management table, the form of the management ID is not limited. Further, a case where information is retained for the same purpose without using the names “management table” and “management ID” is also within the scope of the present invention.

In the superimposed display metadata generation step, a case where metadata generation fails may occur. The case includes a case where pieces of data of different scenes are selected in data selection and the superimposition positions are unable to be determined and a case where pieces of data of the same scene are selected but the pieces of data are difficult to superimpose. In such cases, a management ID is not registered for the individual pieces of data for which metadata generation fails, so that inappropriate superimposed display use data can be excluded.

### Display Example of Superimposed Display Use Data using Management ID

Now, a procedure for displaying pieces of superimposed display use data having the same management ID by using the management ID in the data management system 100 is described.

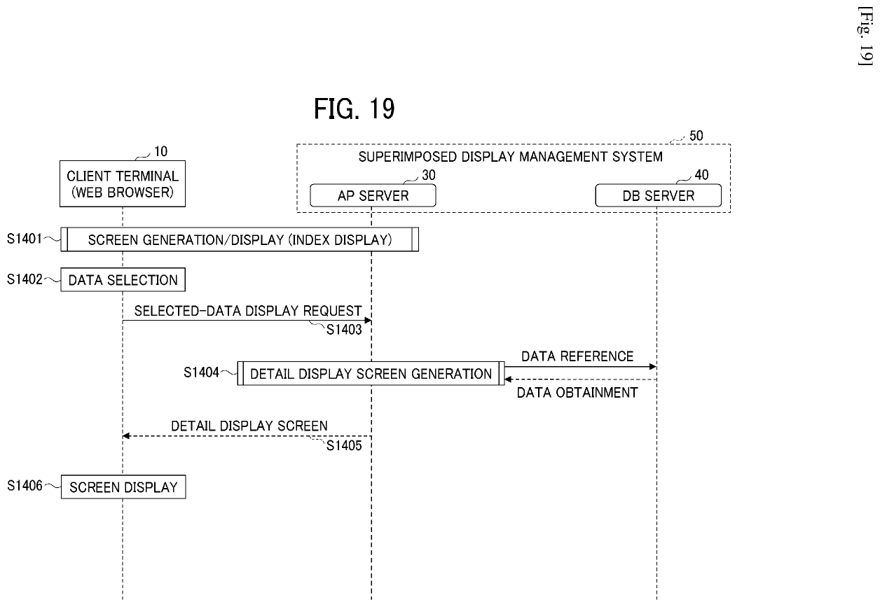

FIG. 19 is an example sequence diagram illustrating a procedure in which the client terminal 10 displays a data display screen. A procedure for generating the data display screen is described with reference to FIG. 19.

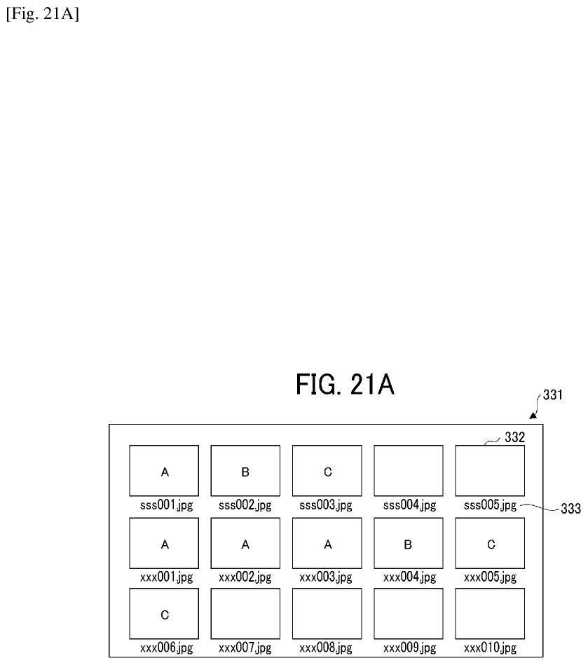

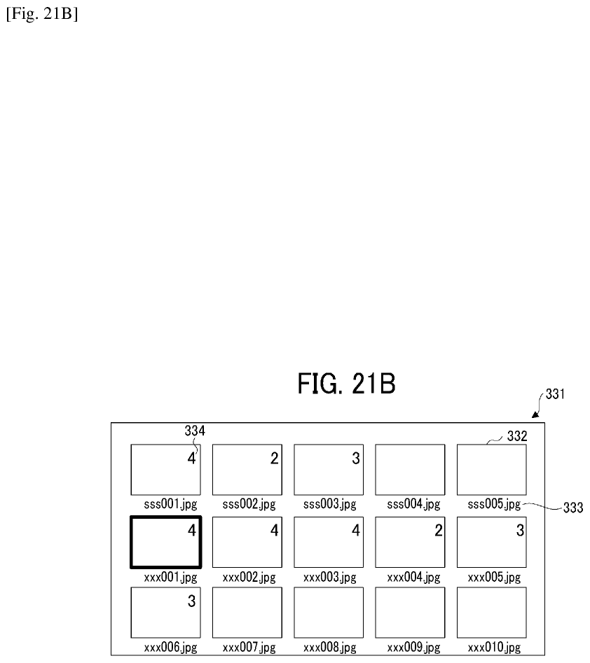

S1401: In a screen generation/display step S1401, a predetermined screen is generated in accordance with the screen generation/display sequence described with reference to FIG. 11. A description is given under the assumption that the user selects the index display button 305 on the menu selection screen 301 in step S1401. On the client terminal 10, an index display screen 331 illustrated in FIG. 21A or 21B is displayed.

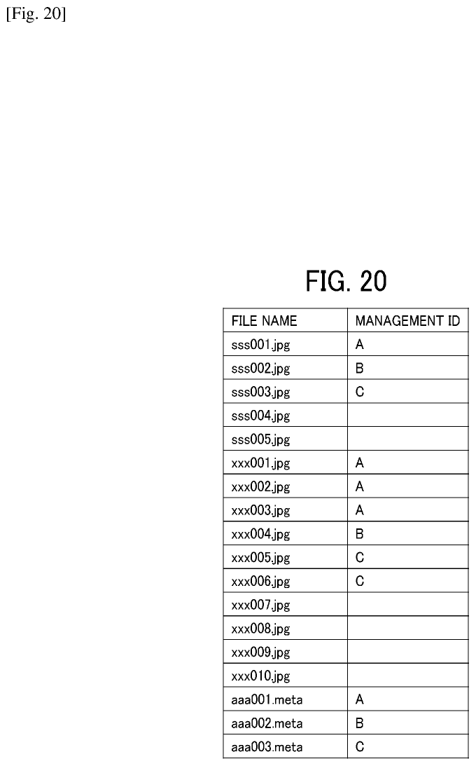

In order to describe the index display screen 331, a management table is illustrated in FIG. 20. FIG. 20 illustrates an example management table that is saved on the DB server 40 and used when the index display screen 331 is generated. The management table in FIG. 20 has the same structure as that of the management table described with reference to FIGS. 18A to 18D. When compared with the management table in FIG. 18C, the management table in FIG. 20 includes records in each of which a management ID is not registered. Each record in which a management ID is not registered corresponds to data that has been uploaded to the superimposed display management system 50 but is not used in generation of superimposed display metadata.

FIGS. 21A and 21B illustrate examples of the index display screen 331 on which a list of pieces of data uploaded to the superimposed display management system 50 is displayed as an index. On the index display screen 331, thumbnail images 332 and file names 333 are displayed for the respective pieces of superimposed display use data, and the thumbnail images 332 are displayed in a matrix.

In FIG. 21A, for each piece of superimposed display use data, a corresponding management ID is displayed on the thumbnail image. For a piece of superimposed display use data for which a management ID is registered in the management table, the management ID is displayed, and for a piece of superimposed display use data for which a management ID is not registered in the management table, nothing is displayed. Accordingly, the user can know the state of use of the pieces of superimposed display use data in superimposed display and the relations of the pieces of data at a glance. The display method is not limited to the method of directly displaying management IDs as illustrated in FIG. 21A, and a display method in which the same symbol is displayed for pieces of data having a common management ID or a display method in which the thumbnail images of pieces of data having a common management ID are outlined in the same color may be employed. Basically, the user needs to be able to recognize pieces of data having a common management ID (pieces of superimposed display use data used for the same superimposed display metadata). For example, a display method may be employed in which, behind a thumbnail image having a management ID, the presence of a plurality of pieces of superimposed display use data having the management ID in common is indicated.

In FIG. 21B, the total number 334 of pieces of superimposed display use data is superimposed and displayed on some thumbnail images. For a piece of superimposed display use data for which a management ID is registered in the management table, the total number 334 of pieces of superimposed display use data for which the management ID is registered in common is displayed. For a piece of superimposed display use data for which a management ID is not registered, nothing is displayed. For example, for “xxx001.jpg” in FIG. 21B, “A” is registered as the management ID in the management table in FIG. 20, and the management ID is registered in common for three pieces of superimposed display use data (sss001.jpg, xxx002.jpg, and xxx003.jpg), and the total number is four including “xxx001.jpg”. Therefore, “4” is displayed on the thumbnail image of “xxx001.jpg”. Accordingly, the user can know the number of pieces of superimposed display use data from each of the pieces of superimposed display use data without reference to the superimposed display metadata.

S1402: Referring back to FIG. 19, a description is further given. In data selection, the user selects one piece of superimposed display use data on the index display screen 331. As the method for selecting one piece of superimposed display use data on the index display screen 331, for example, the user uses the input device 108 of the client terminal 10 to select a thumbnail image on the index display screen 331. A method in which the user clicks on a thumbnail image to select the thumbnail image in a case where the input device 108 is a mouse or a method in which the user touches a thumbnail image to select the thumbnail image in a case where the input device 108 is a touch panel may be used. For the piece of superimposed display use data for which the operation accepting unit 12 accepts selection, the display control unit 13 outlines the thumbnail image with a thick line or change the color of the outline so that the user can easily distinguish the piece of data from the other pieces of data that are not selected.

S1403: When the piece of data is selected, the third communication unit 11 of the client terminal 10 transmits a selected-data display request to the AP server 30. The selected-data display request includes the file identifier, which is, for example, the file name of the selected piece of superimposed display use data. In the first example embodiment, it is assumed that the file name is transmitted, and a description is further given.

S1404: When the first communication unit 33 of the AP server 30 receives the selected-data display request, the DB interfacing unit 36 of the AP server 30 transmits the file name to the DB server 40 to request pieces of superimposed display use data having a management ID the same as that of the file selected by the user. The data management unit 41 of the DB server 40 obtains from the database 44 the piece of superimposed display use data having the file name selected by the user. Further, the data management unit 41 obtains from the database 44 all pieces of superimposed display use data associated with a management ID the same as that of the piece of superimposed display use data. The data management unit 41 transmits the two or more pieces of superimposed display use data to the AP server 30 via the second communication unit 43.

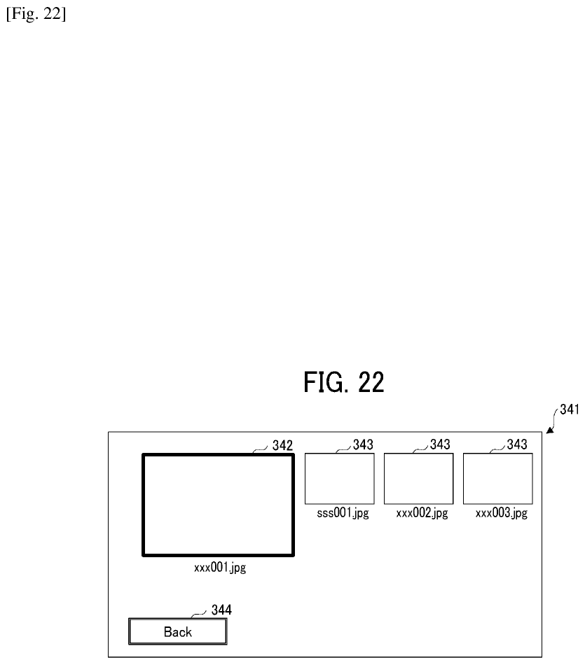

The Web server unit 32 of the AP server 30 generates a detail display screen 341 using the pieces of superimposed display use data. An example of the detail display screen 341 is illustrated in FIG. 22.

S1405: When generation of the detail display screen 341 is completed, the first communication unit 33 of the AP server 30 transmits the detail display screen 341 to the client terminal 10.

S1406: The third communication unit 11 of the client terminal 10 receives the detail display screen 341, and the display control unit 13 displays the detail display screen 341.

FIG. 22 illustrates an example of the detail display screen 341 displayed by the client terminal 10. FIG. 22 illustrates an example of the detail display screen 341 in an example case where “xxx001.jpg” is selected on the index display screen 331. On the detail display screen 341, a thumbnail image 342 of the piece of superimposed display use data selected by the user, thumbnail images 343 of the pieces of superimposed display use data having the common management ID, and a back button 344 are displayed.

As described above, when the user only selects one piece of superimposed display use data, the user can view all pieces of superimposed display use data associated with a management ID the same as that of the piece of superimposed display use data. The user can select a plurality of pieces of superimposed display use data at a time.

In order to clearly distinguish the piece of superimposed display use data selected by the user from the other pieces of superimposed display use data, the display control unit 13 may change the sizes of the thumbnail images (increase the size for the selected piece of superimposed display use data) and make the outline of the thumbnail image of the selected piece of data thicker (make the outline thicker for the selected piece of superimposed display use data) as illustrated in FIG. 22.

As described above, when the user only selects one piece of superimposed display use data, the client terminal 10 can display pieces of superimposed display use data having the same management ID, and therefore, the user can easily view the plurality of pieces of superimposed display use data used in generation of the superimposed display metadata.

### Management ID Addition in Download

The example where pieces of superimposed display use data having the same management ID are displayed as thumbnail images has been described with reference to FIG. 22. The user may want to download the pieces of superimposed display use data. However, the management ID is managed by the DB server 40 and is not added to the pieces of superimposed display use data that are downloaded, and the client terminal 10 is unable to identify the pieces of superimposed display use data that are used in superimposed display unless the client terminal 10 references the superimposed display metadata. Accordingly, a process for adding, to a piece of superimposed display use data that is downloaded, the management ID in the superimposed display management system 50 is described.

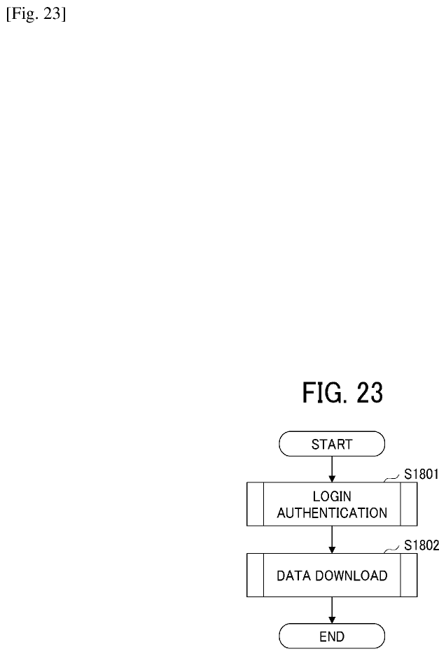

FIG. 23 is an example flowchart illustrating a procedure in which the client terminal 10 downloads superimposed display use data.

First, the user logs in to the superimposed display management system 50 (step S1801). The login process is the same as that described with reference to FIG. 10.

After user authentication is successfully completed, the client terminal 10 downloads superimposed display use data (step S1802). The sequence in the download step S1802 is described in detail below.

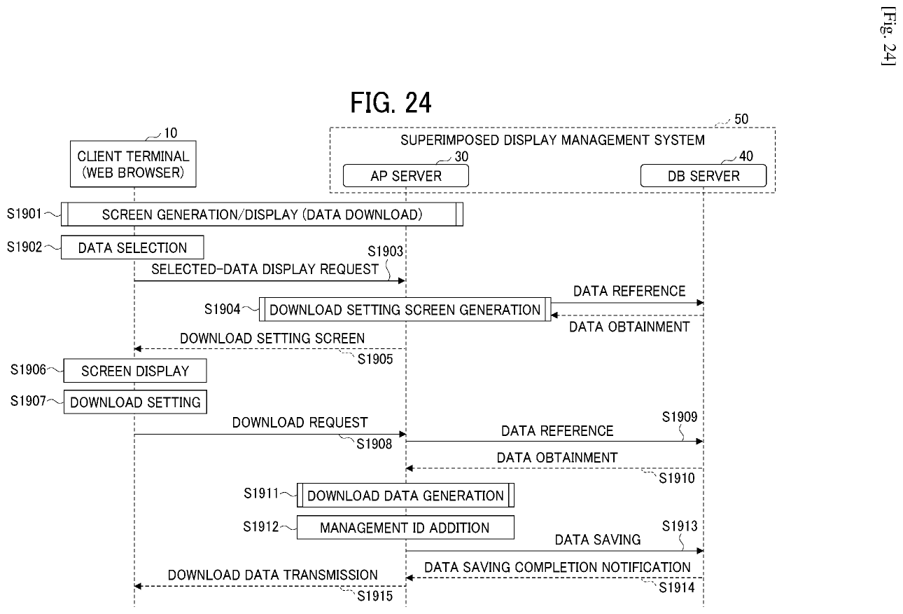

FIG. 24 is an example sequence diagram illustrating a procedure in which the client terminal 10 downloads superimposed display use data from the superimposed display management system 50.

S1901: In a screen generation/display step in step S1901, a predetermined screen is generated in accordance with the screen generation/display sequence described with reference to FIG. 11. It is assumed that the user presses the data download button 303 on the menu selection screen 301 in step S1901. Accordingly, the client terminal 10 displays a download screen 351.

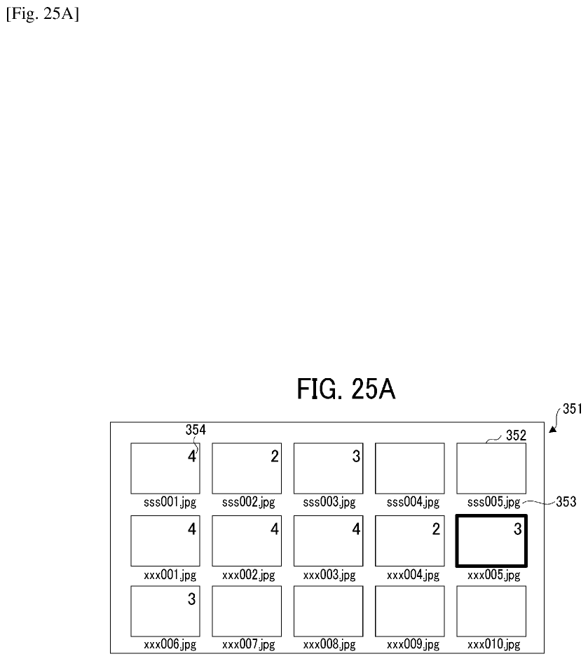

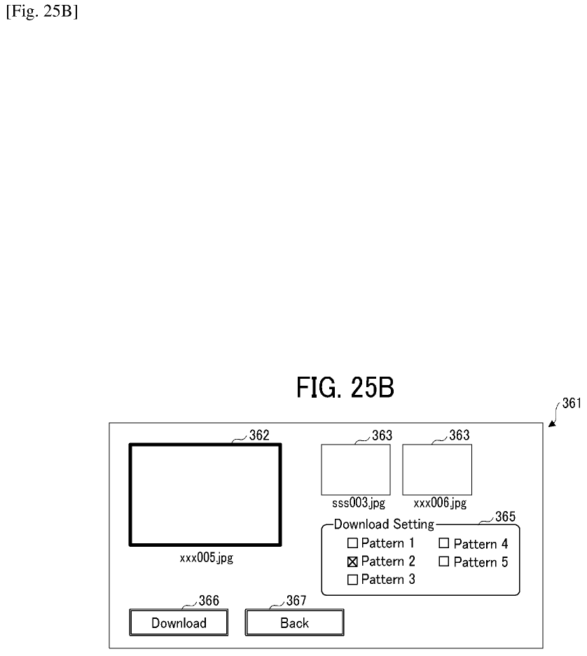

FIG. 25A illustrates an example of the download screen 351. The screen illustrated in FIG. 25A is similar to the index display screen 331 described with reference to FIG. 21B, and thumbnail images 352 and file names 353 are displayed on the screen. The total number 354 of pieces of superimposed display use data for which a common management ID is registered in the management table in FIG. 20 is displayed for each piece of superimposed display use data. For a piece of data for which a management ID is registered in the management table, the total number 354 of pieces of superimposed display use data is displayed. For a piece of superimposed display use data for which a management ID is not registered, nothing is displayed. In step S1901, the management ID generating unit 35 obtains and retains a management ID that is added in the subsequent step S1912.

S1902: Referring back to FIG. 24, a description is further given. The user selects a piece of superimposed display use data on the download screen 351. As the method for selecting a piece of superimposed display use data on the download screen 351, for example, the user uses the input device 108 of the client terminal 10 to select one of the thumbnail images displayed as an index. A method in which the user clicks on a thumbnail image to select the thumbnail image in a case where the input device 108 is a mouse or a method in which the user touches a thumbnail image to select the thumbnail image in a case where the input device 108 is a touch panel may be used. For the piece of data selected on the download screen 351, the display control unit 13 makes the outline of the thumbnail image thicker or changes the color of the outline so that the user can easily distinguish the piece of data from the other pieces of data that are not selected.

S1903: When the piece of superimposed display use data is selected, the third communication unit 11 of the client terminal 10 transmits a selected-data display request to the AP server 30. The selected-data display request includes the file identifier, which is, for example, the file name of the selected piece of superimposed display use data.

S1904: The first communication unit 33 of the AP server 30 receives the selected-data display request, and the DB interfacing unit 36 of the AP server 30 obtains from the DB server 40 pieces of superimposed display use data identified by using the file identifier, which is, for example, the file name. The method for obtainment is the same as that used in step S1404 in FIG. 19. The Web server unit 32 uses the obtained pieces of superimposed display use data to generate a download setting screen 361 illustrated in FIG. 25B.

S1905: The first communication unit 33 of the AP server 30 transmits the download setting screen 361 to the client terminal 10.

S1906: The third communication unit 11 of the client terminal 10 receives the download setting screen 361, and the display control unit 13 displays the download setting screen 361.

FIG. 25B illustrates an example of the download setting screen 361 displayed by the client terminal 10. It is assumed that “xxx005.jpg” is selected in data selection in step S1902. The download setting screen 361 is a display screen similar to the detail display screen 341 described with reference to FIG. 22 and includes a thumbnail image 362 of the selected piece of superimposed display use data, thumbnail images 363 of pieces of superimposed display use data having the same management ID, a download setting field 365, a download button 366, and a back button 367.

The download setting field 365 is a field used to set a data format that is used in downloading the management ID and the pieces of superimposed display use data.

The download setting field 365 is described with reference to FIG. 26. FIG. 26 illustrates patterns of the data format (examples of a data format identifier) of download data set in the download setting field 365. The data format has five patterns. The terms used in FIG. 26 are described. The management ID is a management ID registered by the management ID generating unit 35 of the first example embodiment. The superimposed display metadata is data generated in the superimposed display metadata generation step (step S1206) in the superimposed display metadata generation sequence described with reference to FIG. 17. The selected data is a piece of superimposed display use data selected on the download screen 351 illustrated in FIG. 25A. The superimposed display use data is a piece of superimposed display use data for which a management ID the same as that of the selected data is registered in common and is data that is used in superimposed display, and is displayed on the download setting screen 361 in FIG. 25B together with the selected data. The number of pieces of superimposed display use data changes depending on the selected data, and the selected data is one of the pieces of superimposed display use data. In the example illustrated in FIG. 26, three pieces of superimposed display use data are present, and superimposed display use data 1 is assumed to be the selected data.

Now, the patterns of the data format of download data are described. The data format of pattern 1 is a pattern in which the selected data, each piece of superimposed display use data, and the superimposed display metadata are stored in respective files, and four files are provided in FIG. 26. For each file, the management ID is added. As the method for adding the management ID to the superimposed display use data, in a case where the superimposed display use data is data in the Joint Photographic Experts Group (JPEG) format, the management ID is recorded to an area that is newly provided in the JPEG format, an Exchangeable image file format (Exit) area in which image capture information, etc. is recorded, a manufacturer note area in which the manufacturer can store data on their own, or an area in which addition of the management ID does not affect the file structure. The same applies to the other formats. The data in the data format of pattern 1 can be viewed with general data browser software. With pattern 1, the client terminal 10 receives a plurality of files, and therefore, taking into consideration convenience, the plurality of files may be converted to one piece of compressed data (for example, a zip file or an lzh file) at the time of download.

The data format of pattern 2 is a pattern in which the selected data, each piece of superimposed display use data, and the superimposed display metadata are combined into one file. The management ID is added to the one file obtained as a result of combining. The file in pattern 2 stores data in which the plurality of pieces of superimposed display use data are combined. The file in pattern 2 is in a format with which only the selected data can be viewed with general data browser software. Regarding the pieces of superimposed display use data other than the selected data in the combined data, only the client terminal 10 that logs in to the superimposed display management system 50 is allowed to view the other pieces of superimposed display use data. In such a case where pieces of superimposed display use data other than the selected data are not allowed to be displayed with general data browser software, for example, only the client terminal 10 that logs in to the superimposed display management system 50 is allowed to view the other pieces of superimposed display use data in the combined data, or dedicated data browser software is distributed to users to allow viewing.

The data format of pattern 3 is a pattern in which only the selected data is stored in a file. To the selected data, the management ID is added. The file in pattern 3 is in a format with which viewing with general data browser software is allowed.

The data format of pattern 4 is a pattern in which only the superimposed display metadata is involved. The management ID is added to the superimposed display metadata. The data in the data format of pattern 4 can be viewed with general data browser software.

The data format of pattern 5 is a pattern in which only the management ID is involved. Only the management ID is involved, and therefore, the pattern need not be in a file format and may include address information about the superimposed display management system 50. For example, a use method in which information in pattern 5 can be shared via an email or a social networking service (SNS) may be used.

S1907: Referring back to FIG. 24, a description is further given. The user performs download setting on the download setting screen 361 to set the data format with which the user wants to download data, and presses the download button 366 on the download setting screen 361. The operation accepting unit 12 accepts the download setting and the operation of pressing the download button 366.

S1908: The third communication unit 11 of the client terminal 10 transmits a download request to the AP server 30. The download request includes, for example, the pattern number of the data format that is set by the user in download setting and the file name of the selected piece of superimposed display use data.

S1909: The first communication unit 33 of the AP server 30 receives the download request, and the DB interfacing unit 36 requests the selected data from the DB server 40. The second communication unit 43 of the DB server 40 receives the request for the selected data including the file name of the selected piece of superimposed display use data, and the data management unit 41 obtains superimposed display use data from the database 44.

In a case of pattern 1, the data management unit 41 obtains the selected data, one or more pieces of superimposed display use data, and the superimposed display metadata.

In a case of pattern 2, the data management unit 41 obtains the selected data, one or more pieces of superimposed display use data, and the superimposed display metadata.

In a case of pattern 3, the data management unit 41 obtains the selected data.

In a case of pattern 4, the data management unit 41 obtains the superimposed display metadata.

In a case of pattern 5, the data management unit 41 does not obtain the pieces of data described above, and therefore, the AP server 30 need not access the DB server 40.

S1910: The second communication unit 43 of the DB server 40 transmits the obtained data to the AP server 30.

S1911: The DB interfacing unit 36 of the AP server 30 receives the data in the data format of one of patterns 1 to 5, and the download data generating unit 34 generates download data. The data format of the download data is in the pattern set in the download setting step S1907.

In the case of pattern 1, the download data generating unit 34 generates a file for each of the selected data, the one or more pieces of superimposed display use data, and the superimposed display metadata, compresses these files, and generates one compressed file.

In the case of pattern 2, the download data generating unit 34 converts the selected data, the one or more pieces of superimposed display use data, and the superimposed display metadata to one file in a format with which only the selected data can be viewed with general data browser software.

In the case of pattern 3, the download data generating unit 34 converts the selected data to a file in a format with which the selected data can be viewed with general data browser software.

In the case of pattern 4, the download data generating unit 34 converts the superimposed display metadata to a file in a format with which the superimposed display metadata can be viewed with general data browser software.

In the case of pattern 5, the download data generating unit 34 need not generate a data file but may generate a file for the management ID.

S1912: After generating the download data, the download data generating unit 34 adds the management ID to the download data in the data format of the pattern selected by the user from among patterns 1 to 5 illustrated in FIG. 26. The management ID is obtained and retained in step S1901.

In the cases of patterns 1 to 4, the management ID is added to the download data generated in step S1911. In the case of pattern 5, a file that stores the management ID as data may be generated, or the management ID may be converted so as to have a data format with which the management ID can be transmitted via an email or an SNS. The file for the management ID may be generated in step S1911.

S1913: The DB interfacing unit 36 of the AP server 30 saves on the DB server 40 the download data to which the management ID is added.

S1914: When data saving is completed, the second communication unit 43 of the DB server 40 transmits a data saving completion notification to the AP server 30.

S1915: When the DB interfacing unit 36 of the AP server 30 receives the data saving completion notification, the first communication unit 33 transmits the download data to the client terminal 10.

The client terminal 10 uses the download data to superimpose the planar images on the equirectangular projection image to display the images.

When the download data to which the management ID is added is obtained as described above, the download data can be distributed to the other users (other persons).

### Distribution of Download Data

Now, distribution of download data is described. There may be a case where the user distributes download data downloaded from the superimposed display management system 50 to the other persons. The data format of the download data downloaded from the superimposed display management system 50 has the plurality of patterns. For example, in the cases of patterns 1 and 2 described with reference to FIG. 26, when the download data is distributed to the other persons as is, the other persons obtain a complete set of pieces of data that are used in superimposed display (pieces of superimposed display use data and superimposed display metadata).

The cases of patterns 3 to 5 are advantageous in that the data amount is smaller than that in the cases of patterns 1 and 2; however, all pieces of data that are used in superimposed display are not distributed, and therefore, the other persons need to obtain the omitted data from the superimposed display management system 50. In the case of pattern 1, the plurality of pieces of superimposed display use data are stored in the respective files and downloaded, and therefore, in a case where some of the pieces of data are missing for some reason, the other persons need to obtain the missing data from the superimposed display management system 50.

In a case where the other persons attempt to obtain the omitted or missing data from the superimposed display management system 50, if the other persons are not allowed to obtain the data without user registration in the superimposed display management system 50, the other persons to which the data has been distributed is unable to obtain the omitted or missing data from the superimposed display management system 50. Such inconvenience can be avoided by using the management ID.

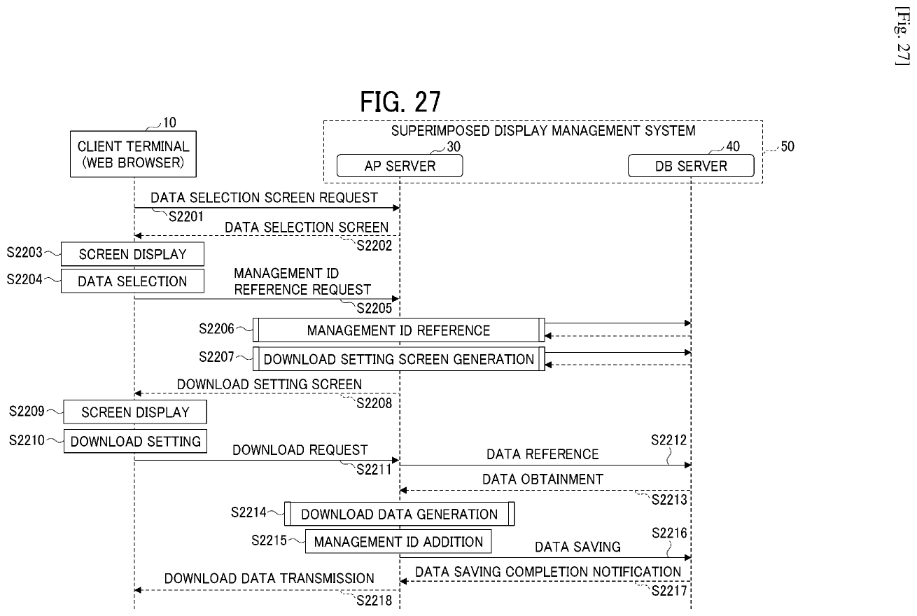

FIG. 27 is an example sequence diagram illustrating operation of accessing the superimposed display management system 50 using download data, according to an instruction from other user (other person). The procedure for accessing the superimposed display management system 50 using download data is described with reference to FIG. 27. The process illustrated in FIG. 27 is a sequence executed in a case where data is omitted or missing.

S2201: The other person inputs the URL of the superimposed display management system 50 to the client terminal 10 to cause the client terminal 10 to access the superimposed display management system 50. Even in a state where the client terminal 10 accesses the superimposed display management system 50 but the other person does not log in to the superimposed display management system 50, when the other person selects a data selection screen request that is displayed, the third communication unit 11 of the client terminal 10 transmits the data selection screen request to the AP server 30.

S2202: The first communication unit 33 of the AP server 30 receives the data selection screen request, and the Web server unit 32 transmits a data selection screen to the client terminal 10 via the first communication unit 33.

S2203: The third communication unit 11 of the client terminal 10 receives the data selection screen, and the display control unit 13 displays the data selection screen.

S2204: The other person selects, on the data selection screen, download data stored on the client terminal 10. Data to be selected is download data downloaded to the client terminal 10 from the superimposed display management system 50 as described with reference to FIG. 24. As described with reference to FIG. 26, data downloaded from the superimposed display management system 50 can have the data format of a plurality of patterns; however, management ID information is added to the data at the time of download from the superimposed display management system 50 regardless of the data format. Therefore, the client terminal 10 that makes a selection obtains the management ID information from the download data in step S2204.

S2205: The third communication unit 11 of the client terminal 10 transmits a management ID reference request including the management ID to the AP server 30. The management ID reference request includes the management ID information obtained from the download data.

S2206: The first communication unit 33 of the AP server 30 receives the management ID reference request, and the DB interfacing unit 36 transmits the management ID to the DB server 40 to request superimposed display use data and superimposed display metadata corresponding to the management ID. When the management ID is included in the management ID reference request and transmitted, the authenticating unit 42 searches the database 44 for the management ID. In a case where the management ID included in the management ID reference request and transmitted is included in the database 44, the user authentication is regarded as successful.

S2207: In a case where the user authentication is successful, the second communication unit 43 of the DB server 40 sends the received management ID to the data management unit 41, and the data management unit 41 obtains superimposed display use data and superimposed display metadata associated with the management ID. The second communication unit 43 transmits the superimposed display use data and the superimposed display metadata to the AP server 30. The DB interfacing unit 36 of the AP server 30 receives the superimposed display use data and the superimposed display metadata, and the Web server unit 32 uses the obtained data to generate the download setting screen 361.

S2208: The first communication unit 33 of the AP server 30 transmits the download setting screen 361 to the client terminal 10.

S2209: The third communication unit 11 of the client terminal 10 receives the download setting screen 361, and the display control unit 13 displays the download setting screen 361.

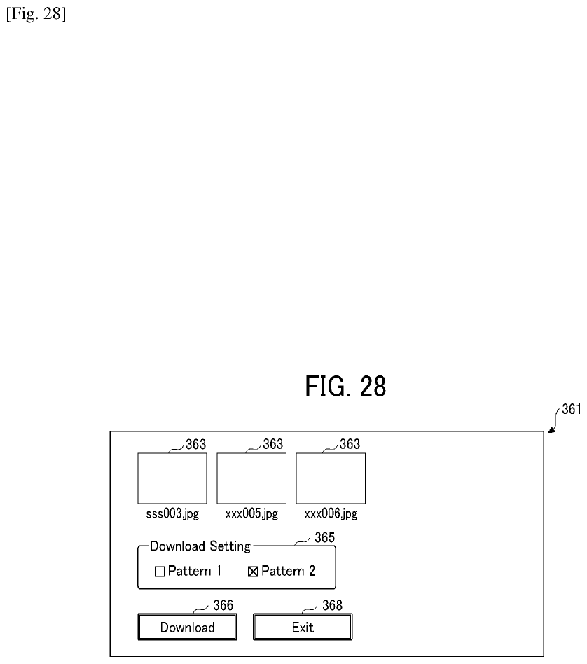

FIG. 28 illustrates an example of the download setting screen 361 displayed by the client terminal 10. The download setting screen 361 includes the thumbnail images 363 of pieces of superimposed display use data for which the management ID referenced in the management ID reference step (step S2206) is registered in the management table, the download setting field 365, the download button 366, and an exi9t button 368.

In the download setting field 365, only pattern 1 and pattern 2 of the data format, which are patterns with which a complete set of pieces of data that are used in superimposed display is obtained, are displayed so as to selectable. Accordingly, the other person can select a pattern with which a complete set of pieces of data that are used in superimposed display is obtained.

S2210: Referring back to FIG. 27, a description is further given. The other person performs download setting on the download setting screen 361 to set the data format with which the other person wants to download data, and presses the download button 366 on the download setting screen 361. The operation accepting unit 12 accepts the download setting and the operation of pressing the button.

S2211: The third communication unit 11 of the client terminal 10 transmits a download request to the AP server 30. The sequence in step S2212 and the subsequent steps is the same as the sequence in step 51909 and the subsequent steps in FIG. 24, and therefore, a description thereof will be omitted.

As described above, when the client terminal 10 accesses the superimposed display management system 50 while referencing the management ID in the download data, even a user who is not registered in the superimposed display management system 50 can use the superimposed display management system 50 to download the data to be used for superimposed display.

### Handling of a Plurality of Management IDs

Now, a case where a plurality of management IDs are registered for one piece of superimposed display use data is described. When the AP server 30 registers a management ID in the management ID registration step (step S1207) in the superimposed display metadata generation sequence illustrated in FIG. 17, there may be a case where another management ID has already been registered for the piece of superimposed display use data.

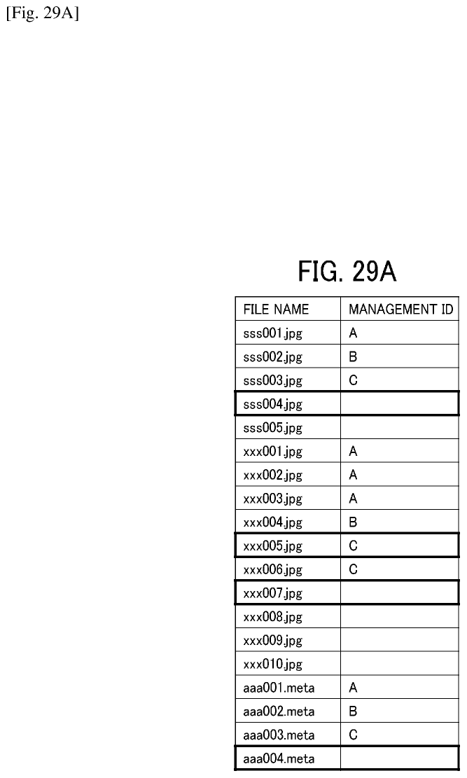

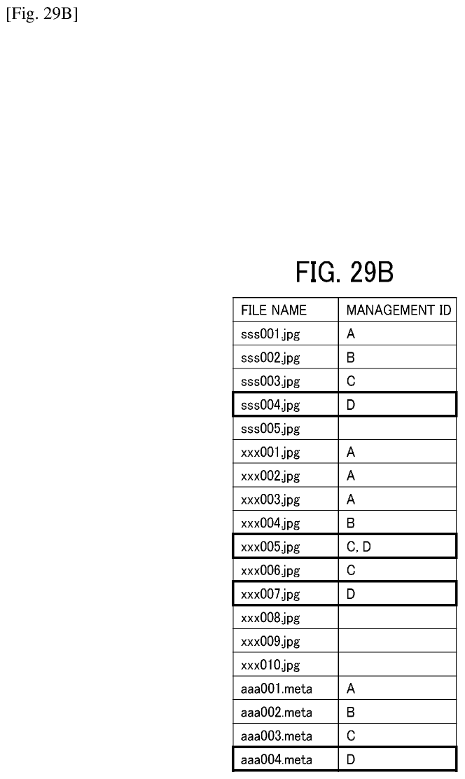

FIGS. 29A and 29B illustrate example management tables. For example, FIG. 29A illustrates a state where superimposed display metadata (aaa004.meta) is generated in the superimposed display metadata generation step (step S1206) and a management ID (D) is to be registered in the records of pieces of superimposed display use data (sss004.jpg, xxx005.jpg, and xxx007.jpg) in the management ID registration step (step S1207).

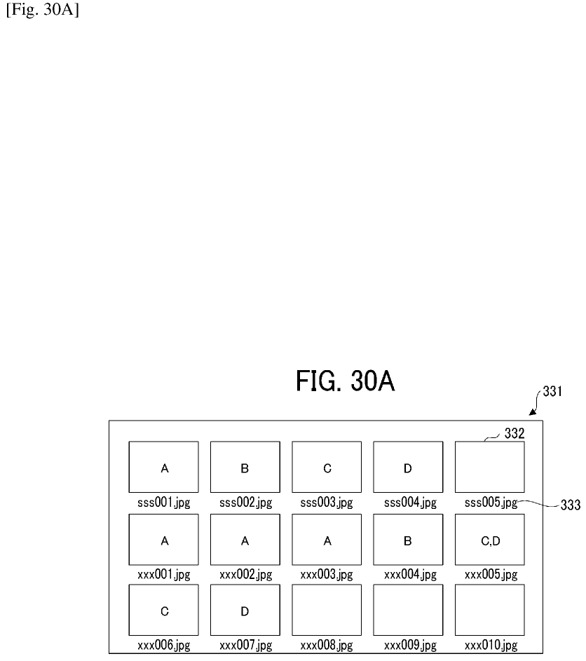

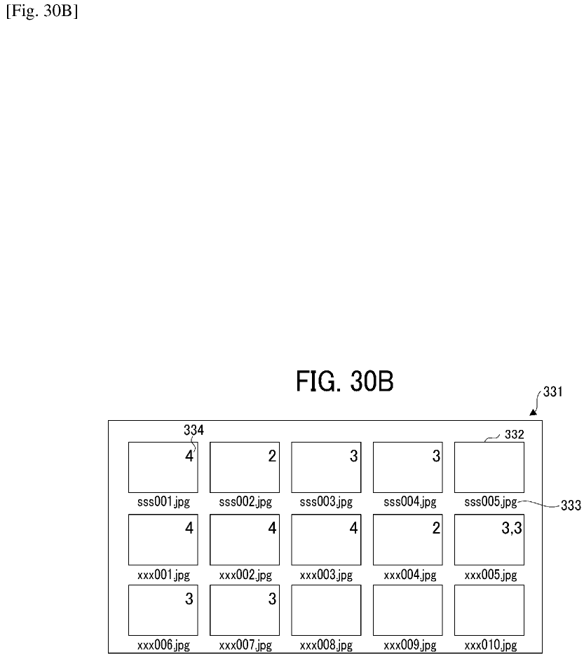

A management ID is not registered for two pieces of superimposed display use data (sss004.jpg and xxx007.jpg) and a management ID (C) has already been registered for one piece of superimposed display use data (xxx005.jpg). Even in such a case where a management ID has already been registered, the new management ID (D) is additionally registered as illustrated in FIG. 29B in the management ID registration step (step S1207). When the AP server 30 generates the index display screen 331, the plurality of management IDs is displayed as illustrated in FIG. 30A, or a plurality of the total numbers 334 of pieces of superimposed display use data is displayed as illustrated in FIG. 30B.

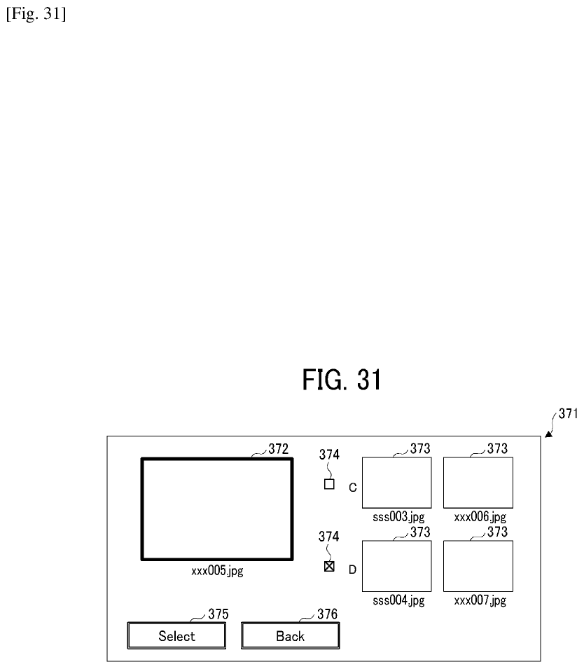

In the data download sequence for download from the superimposed display management system 50 illustrated in FIG. 24, in data selection (step S1902), the screen transitions from the download screen 351 illustrated in FIG. 25A to the download setting screen 361 illustrated in FIG. 25B. In a case where data for which a plurality of management IDs are registered in the management table is selected in data selection (step S1902), for example, a screen for selecting a management ID (hereinafter referred to as a management ID selection screen 371) as illustrated in FIG. 31 is generated to prompt the user to select a management ID.

FIG. 31 is a diagram illustrating an example of the management ID selection screen 371. On the management ID selection screen 371, a thumbnail image 372 of a piece of superimposed display use data selected in data selection (step S1902) and thumbnail images 373 of pieces of superimposed display use data each having a management ID that is the same as a corresponding one of the management IDs of the selected piece of superimposed display use data are displayed. The plurality of management IDs are registered for the selected data, and therefore, on the management ID selection screen 371, the thumbnail images of the pieces of superimposed display use data are arranged for each of the management IDs registered in the management table. Accordingly, on the management ID selection screen 371, checkboxes 374 for selecting the respective management IDs and a select button 375 are arranged. When the user selects a management ID using the checkbox 374 and presses the select button 375, the download setting screen 361 illustrated in FIG. 25B is displayed. The subsequent process from download setting (step S1907) is performed only for the selected management ID.

As described above, in the data management system 100 according to the first example embodiment, a management ID is registered, so that a piece of superimposed display use data can be used to reference the superimposed display metadata and the other pieces of superimposed display use data without reference to the superimposed display metadata. In an existing system, superimposed display use data needs to be retrieved using superimposed display metadata.

Data downloaded to the client terminal 10 from the superimposed display management system 50 has a management ID added thereto. Therefore, the management ID added to the download data can be used to access the superimposed display management system 50 and obtain superimposed display use data and superimposed display metadata to be used. Further, even another person who is not a registered user of the superimposed display management system 50 can obtain data to be used from the superimposed display management system 50 without a login as long as the other person obtains the download data having the management ID added thereto. In a case where download data is altered and management ID information is unable to be correctly obtained, the superimposed display management system 50 fails to correctly reference the management ID, and it is possible to prevent unauthorized use and it is possible not to guarantee superimposed display to work, which enables a stable operation of the superimposed display system.

### SECOND EXAMPLE EMBODIMENT

In a second example embodiment, the data management system 100 in which a management ID can be registered immediately after superimposed display use data is obtained is described.

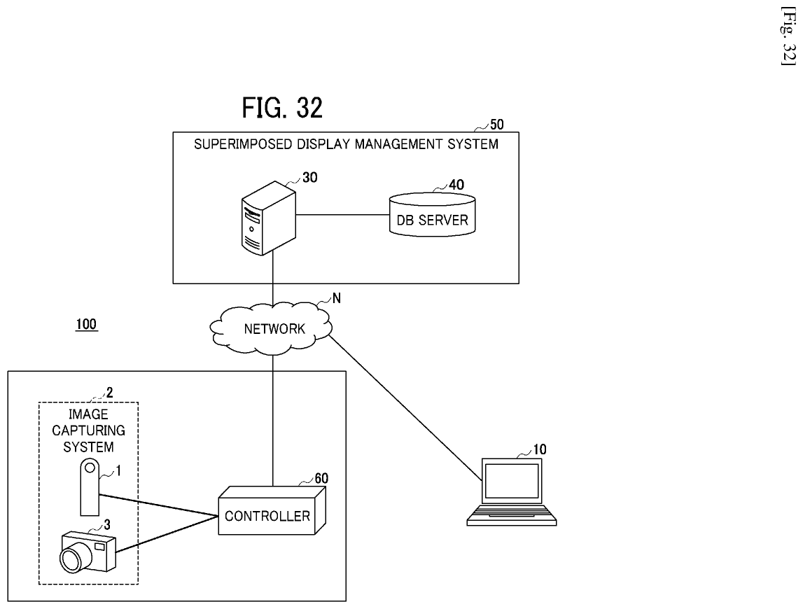

FIG. 32 is an example schematic diagram of the data management system 100 according to the second example embodiment. As illustrated in FIG. 32, the data management system 100 includes the superimposed display management system 50 that manages data used in superimposed display and the client terminal 10 that is used by a user, and further includes a controller 60 that controls a plurality of image capturing devices and an image capturing system 2 that transmits superimposed display use data to the controller 60. The controller 60, the AP server 30, and the client terminal 10 are connected to each other via the network N, which is, for example, the Internet.

It is assumed that the superimposed display management system 50 and the client terminal 10 respectively have configurations similar to those in the first example embodiment. However, as described below, in the second example embodiment, the controller 60 generates a management ID.

The image capturing system 2 includes a general image capturing device such as a digital camera (hereinafter referred to as a general image capturing device 3) and a special image capturing device 1 that can capture spherical images, and the controller 60 controls image capturing using the plurality of image capturing devices. The controller 60 controls image capturing by the plurality of image capturing devices in order to superimpose a planar image captured by the general image capturing device 3 in the image capturing system 2 on a spherical image captured by the special image capturing device 1. The general image capturing device 3 and the special image capturing device 1 consecutively capture images while communicating with each other or in accordance with control signals from the controller 60 substantially simultaneously or without a time difference (hereinafter referred to as consecutive image capturing).

The controller 60 is, for example, an information processing apparatus or an information terminal, such as a smartphone or a PC. A dedicated application runs on the controller 60 to communicate with the image capturing system 2 and receive superimposed display use data.

### Overall Operation of Data Management System 100 According to the Second Example Embodiment

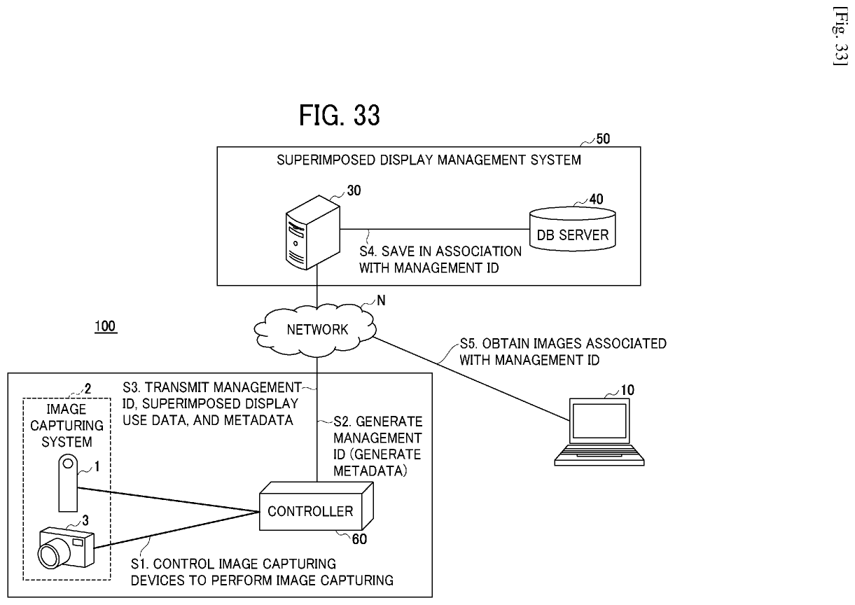

FIG. 33 is an example diagram illustrating a flow of generating a management ID and registering the management ID in the data management system 100.

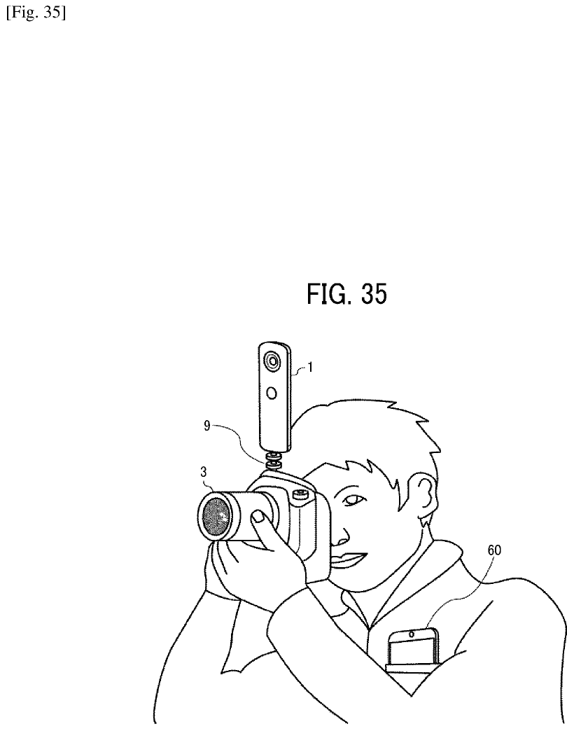

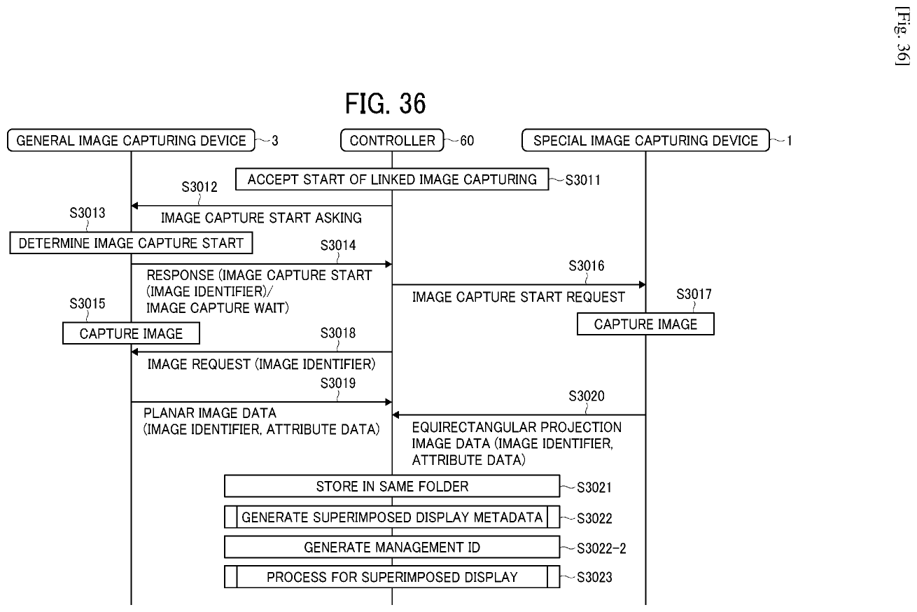

S1: The controller 60 controls the image capturing devices to perform consecutive image capturing in response to a consecutive-image-capture request accepted from the user. The details will be described with reference to FIG. 35 and FIG. 36.

S2: After image capturing, the controller 60 generates a management ID for a plurality of images (superimposed display use data) captured in the consecutive image capturing. The controller 60 may generate superimposed display metadata before generating the management ID.

S3: The controller 60 transmits the superimposed display use data, superimposed display metadata, and management ID to the superimposed display management system 50. This transmission is performed by using the data upload procedure in the first example embodiment.

S4: The superimposed display management system 50 receives the superimposed display use data, superimposed display metadata, and management ID, and the AP server 30 registers the superimposed display use data, superimposed display metadata, and management ID in the DB server 40.

S5: After registration is completed, the user operates the client terminal 10 to specify the management ID, so that the user can obtain from the superimposed display management system 50 and view the superimposed display use data or can download the superimposed display use data from the superimposed display management system 50.

### Functions

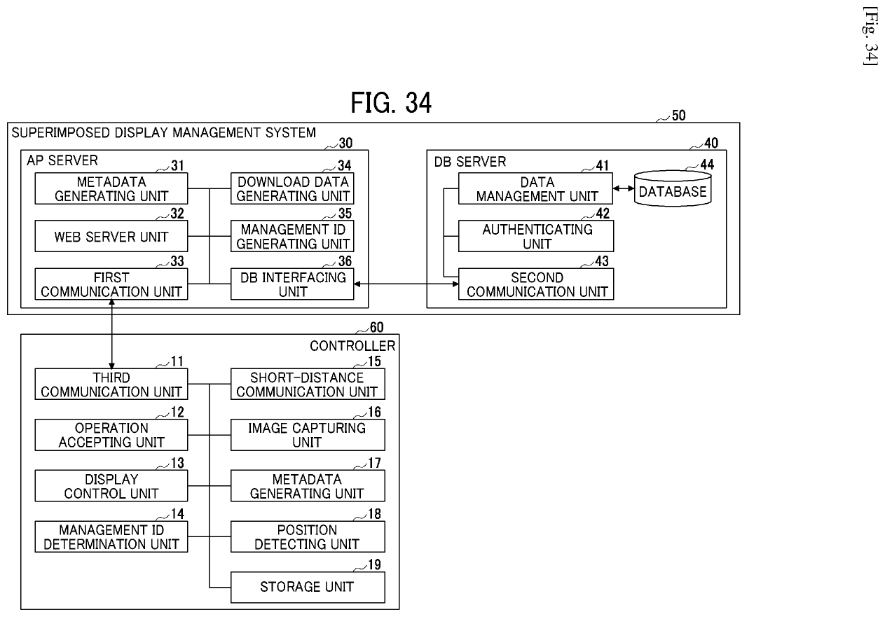

FIG. 34 is an example functional block diagram illustrating the functions of the AP server 30, the DB server 40, and the controller 60 included in the data management system 100 according to the second example embodiment as blocks. In the description of FIG. 34, differences from FIG. 8 are mainly described. The hardware configuration of the controller 60 is similar to that of the client terminal 10.

As illustrated in FIG. 34, the controller 60 includes the third communication unit 11, the operation accepting unit 12, the display control unit 13, a management ID determination unit 14, a short-distance communication unit 15, an image capturing unit 16, a metadata generating unit 17, and a position detecting unit 18. These units included in the controller 60 are functions or means that are implemented by one or more of the constituent elements illustrated in FIG. 7 operating in accordance with instructions given by the CPU 101 on the basis of the program loaded to the memory 102 from the storage device 104.

The third communication unit 11, the operation accepting unit 12, and the display control unit 13 are similar to those of the client terminal 10. The third communication unit 11 transmits/receives various types of data to/from the AP server 30. In the second example embodiment, the third communication unit 11 transmits superimposed display use data and information about a specified file to the AP server 30 and receives screen information about a Web page, etc. from the AP server 30.

The operation accepting unit 12 accepts various user operations performed at the controller 60. For example, the operation accepting unit 12 accepts selection of superimposed display use data, etc. The display control unit 13 analyzes screen information received by the third communication unit 11 and displays Web pages (various screens) on the display 107 (display device). The controller 60 may run a dedicated application instead of browser software to communicate with the superimposed display management system 50.

The management ID determination unit 14 generates a unique management ID from the date and time, location information, etc. The short-distance communication unit 15 communicates with the special image capturing device 1 and the general image capturing device 3 using short-distance wireless communication technology, such as Wi-Fi or Bluetooth (registered trademark). The image capturing unit 16 controls image capturing by the special image capturing device 1 and the general image capturing device 3.

The metadata generating unit 17 superimposes a planar image on an equirectangular projection image, the images being captured by the special image capturing device 1 and the general image capturing device 3, and generates superimposed display metadata. The functions of the metadata generating unit 17 are similar to those of the metadata generating unit 31 of the AP server 30.

The position detecting unit 18 communicates with, for example, a global positioning system (GPS) satellite to detect the current location information.

The controller 60 further includes a storage unit 19 configured as the memory 102 illustrated in FIG. 7. In the storage unit 19, various types of image data are stored.

### Image Capturing by Image Capturing System 2

FIG. 35 is a diagram illustrating a way of using the image capturing system 2. As illustrated in FIG. 35, the user puts the controller 60 in a pocket of their clothing and captures an image of an object, etc. using the general image capturing device 3 to which the special image capturing device 1 is attached via an adaptor 9. The controller 60 need not be put in a pocket of the clothing but may be placed within a range in which wireless communication with the special image capturing device 1 and the general image capturing device 3 is possible.

FIG. 36 is a sequence diagram illustrating the image capture method. A description is give below of a case of capturing an image of an object, a scene, etc. Simultaneously with the image capturing, ambient sound may be recorded by using a microphone.

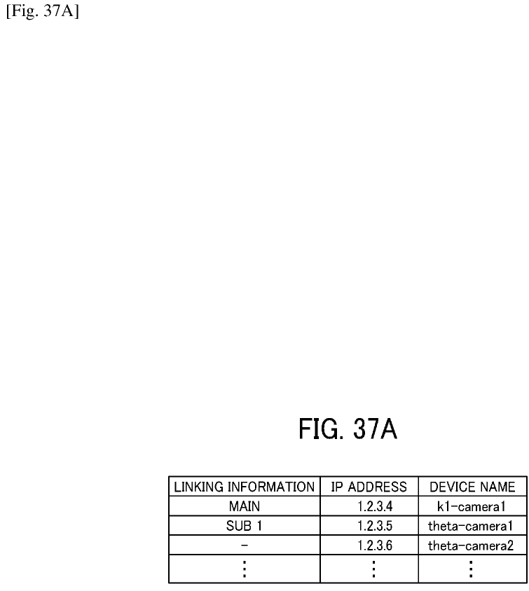

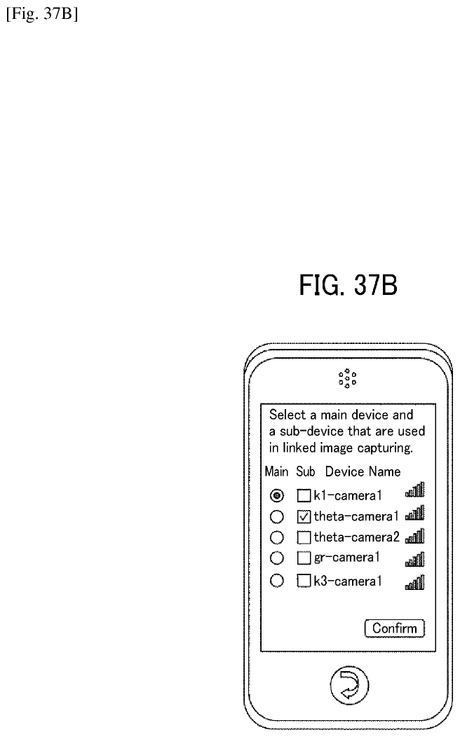

The controller 60 accepts an instruction for starting linked image capturing from the user (step S3011). In this case, the controller 60 displays a linked image capturing device setting screen illustrated in FIG. 37B on the display 107, based on information stored in an linked image capturing device table illustrated in FIG. 37A. On this screen, radio buttons for specifying a main image capturing device in linked image capturing and check boxes for specifying (selecting) one or more sub-image capturing devices in linked image capturing are displayed for the respective image capturing devices. Further, the device names of the image capturing devices and the received signal intensity levels are displayed for the respective image capturing devices. When the user specifies (selects) desired image capturing devices as the main and sub-image capturing devices and presses the “Confirm” button, the operation accepting unit 12 accepts the user instruction for starting linked image capturing. A plurality of image capturing devices may be used as sub-image capturing devices, and therefore, the check boxes are provided so as to allow specification (selection) of a plurality of image capturing devices.

The controller 60 transmits to the general image capturing device 3 image capture start checking information by performing polling to ask the general image capturing device 3 whether image capturing is started (step S3012). The general image capturing device 3 receives the image capture start checking (asking) information.

Next, the general image capturing device 3 determines whether an image capture start operation is performed by determining whether the general image capturing device 3 accepts a user operation of pressing the shutter button (step S3013).

Next, the general image capturing device 3 transmits, to the controller 60, response information indicating the details of response based on the result of determination in step S3013 (step S3014). In a case where it is determined in step S3013 that image capturing is started, the response information includes image capture start information indicating the start of image capturing. In this case, the response information also includes an image identifier from the general image capturing device 3. On the other hand, in a case where it is not determined in step S3013 that image capturing is started, the response information includes image capture wait information indicating waiting for image capturing. The controller 60 receives the response information.

Now, the case where it is determined in step S3013 that image capturing is started and where the response information received in step S3014 includes the image capture start information is described.

First, the general image capturing device 3 starts image capturing (step S3015). This process for image capturing is a process that starts with pressing of the shutter button and that includes capturing of an image of an object, a scene, etc., thereby obtaining captured image data (here, planar image data), and storing of the captured image data.

The controller 60 transmits image capture start request information for requesting the start of image capturing to the special image capturing device 1 (step S3016). The special image capturing device 1 receives the image capture start request information.

The special image capturing device 1 starts image capturing (step S3017). Accordingly, an equirectangular projection image is generated.

Next, the controller 60 transmits to the general image capturing device 3 captured image request information for requesting the captured image (step S3018). The captured image request information includes the image identifier received in step S3014. The general image capturing device 3 receives the captured image request information.

Next, the general image capturing device 3 transmits the planar image data obtained in step S3015 to the controller 60 (step S3019). At this time, the image identifier for identifying the planar image data that is transmitted and attribute data are also transmitted. The controller 60 receives the planar image data, the image identifier, and the attribute data.

The special image capturing device 1 transmits to the controller 60 the equirectangular projection image data obtained in step S3017 (step S3020). At this time, an image identifier for identifying the equirectangular projection image data that is transmitted and attribute data are also transmitted. The controller 60 receives the equirectangular projection image data, the image identifier, and the attribute data.

Next, the controller 60 stores the electronic file of the planar image data received in step S3019 and the electronic file of the equirectangular projection image data received in step S3020 in the same electronic folder for storage (step S3021).

Next, the controller 60 generates superimposed display metadata that is used when the planar image, which is a high-definition image, is superimposed and displayed on a partial area of the equirectangular projection image, which is a low-definition image (step S3022).

The management ID determination unit 14 generates a management ID using the current date and time, location information, etc. (step S3022-2). The management ID determination unit 14 stores the management ID, the planar image, the equirectangular projection image, and the superimposed display metadata in the storage unit 19.

The controller 60 performs a process for superimposed display (step S3023). The controller 60 transmits to the superimposed display management system 50 the management ID, the planar image, the equirectangular projection image, and the superimposed display metadata.

As described above, in the second example embodiment, the controller 60 can generate superimposed display metadata, and therefore, the management ID can be registered immediately after image capturing.

The management ID may be generated in response to a user operation and need not be generated subsequent to generation of the superimposed display metadata. The superimposed display metadata need not be generated by the controller 60 and may be generated by the AP server 30.

The sequence in FIG. 36 starts with image capturing by the general image capturing device 3 (a general camera, such as a single-lens reflex camera or a camera built in a smartphone). In the sequence, the shutter timing of the general image capturing device 3 is given priority, and a spherical image is captured at the timing when a main object is in focus to aim to obtain a superimposed image with an increased sense of realism. However, even if the special image capturing device 1 (for example, a full-view spherical image capturing device) captures an image first, the sequence in FIG. 36 similarly works.

### Management ID in the Second Example Embodiment

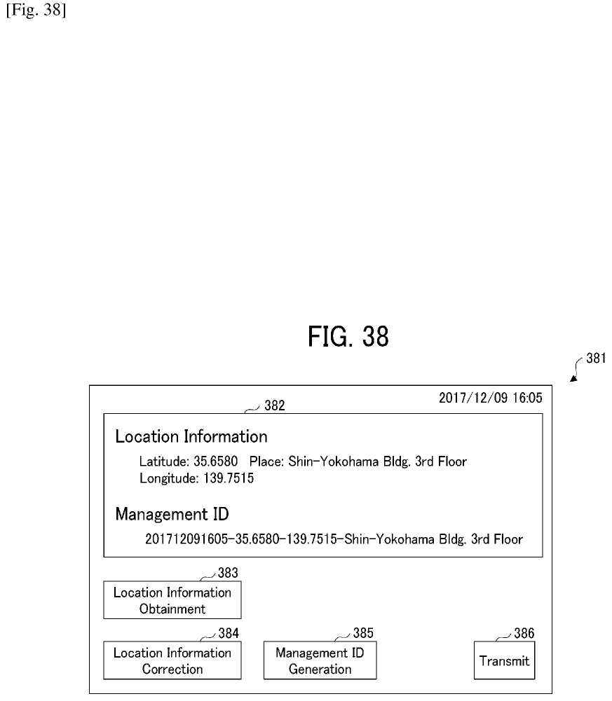

FIG. 38 is a diagram illustrating an example of a setting screen 381 displayed on the controller 60 when superimposed display use data and superimposed display metadata are uploaded. After consecutive image capturing, the controller 60 displays the setting screen 381 as illustrated in FIG. 38. For example, the setting screen 381 illustrated in FIG. 38 is displayed in a process similar to step S801 in FIG. 13.

The setting screen 381 includes an information field 382, a location information obtainment button 383, a location information correction button 384, a management ID generation button 385, and a transmit button 386.

When the user presses the location information obtainment button 383, the position detecting unit 18 detects location information, and the display control unit 13 displays the latitude and the longitude in the information field 382 as illustrated in FIG. 38. The user can press the location information correction button 384 to manually input location information or correct the displayed location information.

The user can press the location information correction button 384 to set not only the location information but also an identifier indicating the place, namely, the name or address indicating, for example, a specific floor of a building, in the information field 382. In FIG. 38, “Place: Shin-Yokohama Bldg. 3rd Floor” is input.

The management ID generation button 385 is a button for the management ID determination unit 14 to generate a management ID. As illustrated in FIG. 38, the management ID is displayed in the information field 382. The management ID illustrated in FIG. 38 is an example generated by concatenating the current date and time displayed in the top right part of the screen, the latitude, the longitude and the place as character strings.

As an example of the location information, the latitude and the longitude are used in the description. Other examples of information that can be detected with GPS include the altitude, the accuracy of the location information, etc., and these pieces of information may be displayed or used to generate a management ID. In addition to GPS, the location information can be obtained by positioning using Wi-Fi, on the basis of the distance to the mobile phone base station, by determination of signal intensity using Bluetooth Low Energy (registered trademark), etc. The display control unit 13 may display location information obtained by using any of these methods in the information field 382. The management ID determination unit 14 may determine a management ID on the basis of location information, etc. obtained by using any of these methods.

The order in which the pieces of information used in generation of the management

ID are concatenated is not limited to the example illustrated in FIG. 38. The pieces of information used in generation of the management ID may be converted to a character string generating by using a reversible algorithm, such as the Rivest-Shamir-Aldleman (RSA) algorithm, and the generated character string may be used as the management ID. Alternatively, a character string generated by using an irreversible algorithm, such as a Universally Unique Identifier (UUID) or a hash function, may be used as the management ID.

In step S3 in FIG. 33, the controller 60 transmits superimposed display use data to the superimposed display management system 50. In a case where the management ID is generated by using an irreversible algorithm, the controller 60 transmits, in addition to the management ID, location information and time information used in generation of the management ID. In a case of a management ID generated by using a reversible algorithm, the controller 60 may transmit only the management ID to the superimposed display management system 50 or may also transmit location information and time information used in generation of the management ID as in the case of the management ID generated by using an irreversible algorithm.

### Management Table

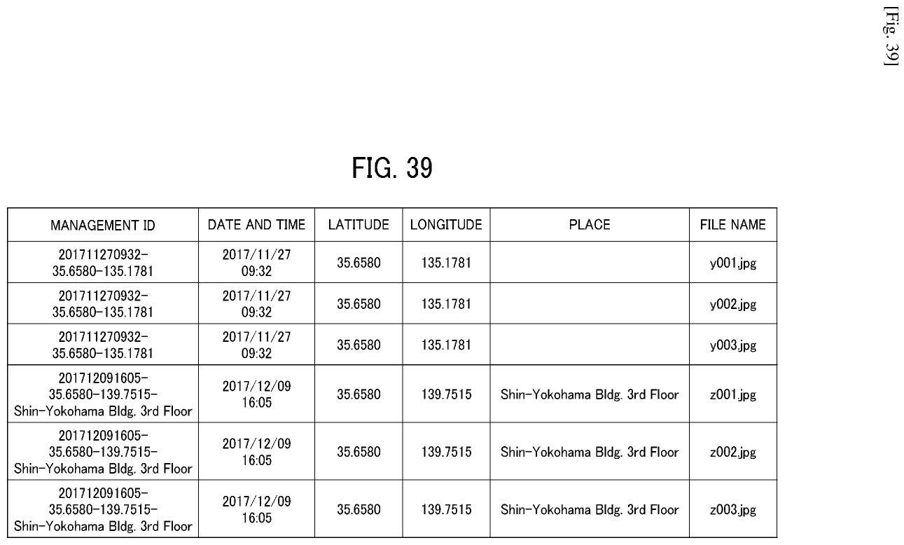

FIG. 39 illustrates an example management table retained by the DB server 40 in the second example embodiment. The management table in the second example embodiment has the items of management ID, date and time, latitude, longitude, place, and file name.

As described with reference to step S4 in FIG. 33, the AP server 30 accepts the superimposed display use data, the superimposed display metadata, and the management ID transmitted from the controller 60. The management ID includes pieces of information, namely, the date and time, the latitude, the longitude, and the place, in this order, and the data management unit 41 separates these pieces of information from each other and registers the pieces of information in the management table illustrated in FIG. 39. When the management table illustrated in FIG. 39 is used, the DB server 40 can identify the file name of the superimposed display use data from the management ID and can also identify the file name from the date and time and the location information.

Accordingly, from an image having no location information among the pieces of superimposed display use data already registered in the superimposed display management system 50, the date and time when the specific image was captured and location information about the image can be obtained by using the management ID.

### Case of Selecting and Transmitting File

The controller 60 can not only transmit pieces of superimposed display use data immediately after image capturing (in the case of consecutive image capturing) but also transmit a piece of superimposed display use data saved in the storage unit 19 to the superimposed display management system 50.

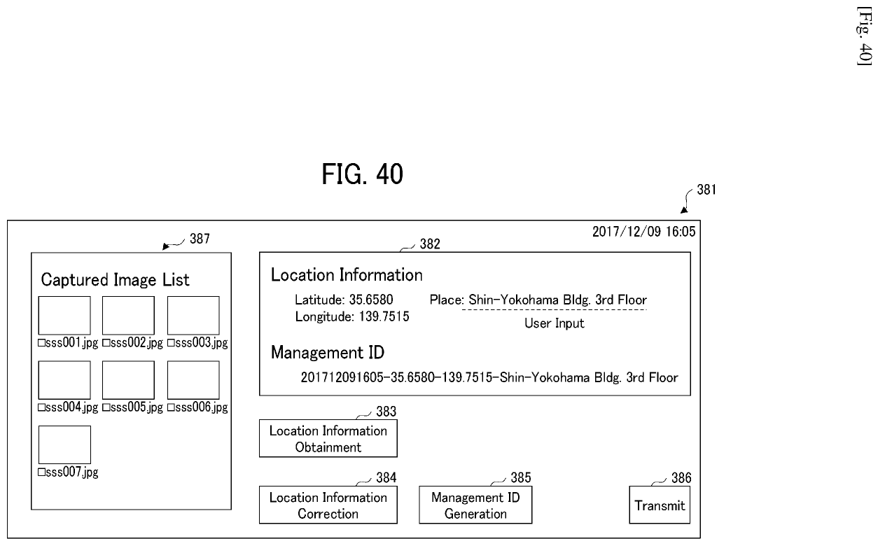

FIG. 40 is a diagram illustrating another example of the setting screen 381 displayed on the controller 60 in a case where the controller 60 transmits a selected file to the superimposed display management system 50. The setting screen 381 illustrated in FIG. 40 includes an image list field 387. The user can select a piece of superimposed display use data in the image list field 387. In the image list field 387, pieces of superimposed display use data stored in a certain folder (pieces of image data obtained mainly by the image capturing system 2) are displayed.

Only the piece of superimposed display use data selected by the user is transmitted to the superimposed display management system 50, and therefore, a situation where an image captured by the user by mistake is transmitted can be prevented.

As described above, according to the second example embodiment, in addition to the effect attained by the first example embodiment in which superimposed display use data and superimposed display metadata assigned a common management ID can be obtained, an effect is obtained in which a management ID associated with superimposed display use data having no location information can be used to obtain the location information.

Further, the controller 60 automatically transmits pieces of superimposed display use data that are assigned a common management ID, so that the user need not make a selection, resulting in increased convenience. The user can select a piece of superimposed display use data to be transmitted, so that an incorrect piece of superimposed display use data is not transmitted.

### Generation of Superimposed Display Metadata

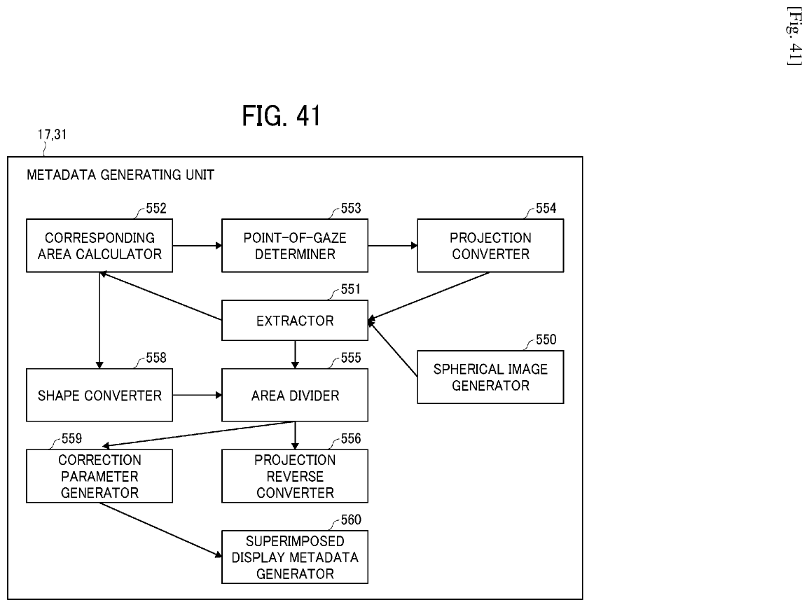

The functions of the metadata generating units 17 and 31 are described in detail below. FIG. 41 is a functional block diagram of the details of the metadata generating units 17 and 31.

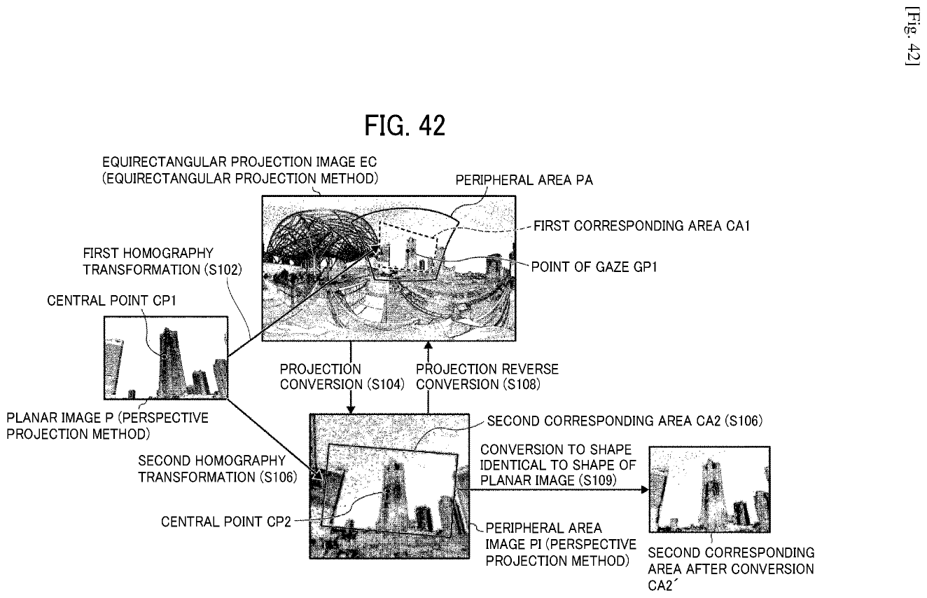

The metadata generating units 17 and 31 each include a spherical image generator 550, an extractor 551, a corresponding area calculator 552, a point-of-gaze determiner 553, a projection converter 554, an area divider 555, a projection reverse converter 556, a shape converter 558, a correction parameter generator 559, and a superimposed display metadata generator 560. The shape converter 558 and the correction parameter generator 559 need not be included in a case where brightness or color need not be corrected. The reference numerals of images and areas described below are found in FIG. 42. FIG. 42 is a diagram schematically illustrating images in the process of generating superimposed display parameters.

The spherical image generator 550 uses Open Graphics Library for Embedded Systems (OpenGL ES) to place an equirectangular projection image EC so as to cover a spherical surface, thereby generating a spherical image CE.

The extractor 551 extracts a plurality of feature points in the equirectangular projection image EC that is a rectangular image obtained by using an equirectangular projection method and a plurality of feature points in a planar image P that is a rectangular image obtained by using a perspective projection method. Each feature point is represented by a pixel on a boundary at which the luminance value changes by a predetermined value or more. Further, the extractor 551 extracts a plurality of feature points in a peripheral area image PI obtained as a result of conversion by the projection converter 554.

The corresponding area calculator 552 calculates a first corresponding area CA1 that is a rectangular area corresponding to the planar image P in the equirectangular projection image EC on the basis of the similarities between the plurality of feature points in the equirectangular projection image EC and the plurality of feature points in the planar image P to thereby perform first homography transformation. Here, a central point CP1 of a rectangle defined by the four vertices of the planar image P is converted to a point of gaze GP1 in the equirectangular projection image EC by the first homography transformation. The corresponding area calculator 552 calculates a second corresponding area CA2 that is a rectangular area corresponding to the planar image P in the peripheral area image PI on the basis of the similarities between the plurality of feature points in the planar image P and the plurality of feature points in the peripheral area image PI to thereby perform second homography transformation.

At least one of the planar image P and the equirectangular projection image EC may be resized before the first homography transformation to reduce the time taken to calculate the first homography. For example, in a case where the planar image P has 40 million pixels and the equirectangular projection image EC has 30 million pixels, for example, the planar image P may be resized so as to have 30 million pixels, or both the planar image P and the equirectangular projection image EC may be resized so as to have 10 million pixels. Similarly, at least one of the planar image P and the peripheral area image PI may be resized before the second homography calculation.

The homography in the present embodiments is a transformation matrix that represents a projection relation between the equirectangular projection image EC and the planar image P. When the coordinates of a point on the planar image P is multiplied by the homography transformation matrix calculated in the homography calculation process, the coordinates of a corresponding point on the equirectangular projection image EC (spherical image CE) can be calculated.

The point-of-gaze determiner 553 determines a point (referred to as “point of gaze” in the present embodiments), on the equirectangular projection image EC, at which the central point CP1 of the planar image P is located after the first homography transformation.

The coordinates of the point of gaze GP1 are the coordinates of a point on the equirectangular projection image EC, and therefore, it is desirable that the coordinates of the point of gaze GP1 be converted so as to be expressed by the latitude and longitude and standardized. Specifically, the vertical direction of the equirectangular projection image EC is expressed by the latitude coordinate extending from −90° (−0.5 a) to +90° (+0.5π), and the horizontal direction thereof is expressed by the longitude coordinate extending from −180° (−π) to +180° (+π). Accordingly, the coordinates of a pixel position that correspond to the image size of the equirectangular projection image EC can be calculated from the latitude and longitude coordinates.

The projection converter 554 converts a peripheral area PA centered on the point of gaze GP1 in the equirectangular projection image EC to an image in perspective projection, which is the projection method for the planar image P, to generate the peripheral area image PI. Here, the peripheral area PA for which projection conversion is performed is determined so that the peripheral area image PI having a square shape can be eventually generated, the peripheral area image PI being defined by a central point CP2, which is a point obtained as a result of conversion of the point of gaze GP1, and the vertical angle of view (or the horizontal angle of view), which is equal to the diagonal angle of view a of the planar image P. This process is further described in detail below.

### Conversion of Projection Method

First, conversion of the projection method is described. The equirectangular projection image EC is placed so as to cover a sphere CS, thereby generating the spherical image CE. Therefore, data of each pixel of the equirectangular projection image EC can be associated with data of a corresponding pixel of the 3D spherical image CE on the surface of the sphere CS. Accordingly, when the coordinates of a point on the equirectangular projection image EC are expressed by (latitude, longitude) =(e, a) and the coordinates of a point on the 3D sphere CS are expressed by rectangular coordinates (x, y, z), conversion performed by the projection converter 554 is expressed by equation 1 below.

(x, y, z)=(cos(e)×cos(a), cos(e)×sin(a), sin(e)) equation 1

Here, the radius of the sphere CS is assumed to be equal to 1.

Meanwhile, the planar image P, which is a perspective projection image, is a 2D image. When a point on the planar image P is expressed by 2D polar coordinates (radius vector, argument)=(r, a), the radius vector r corresponds to the diagonal angle of view α and can have a value within the range 0≤r≤tan(diagonal angle of view/2). When a point on the planar image P is expressed by 2D rectangular coordinates (u, v), the conversion relation with the polar coordinates (radius vector, argument)=(r, a) is expressed by equations 2 below.

u=r×cos(a), v=r×sin(a) equations 2

Then, equations 2 are applied to 3D coordinates (radius vector, polar angle, azimuth). Here, only the surface of the sphere CS is taken into consideration, and therefore, the radius vector in the 3D polar coordinates is equal to 1. When the above-described 2D polar coordinates (radius vector, argument)=(r, a) are used, projection in which the equirectangular projection image EC that is placed on the surface of the sphere CS is converted to a perspective projection image is expressed by equation 3 and equation 4 below under the assumption that a virtual camera IC is present at the center of the sphere CS.

r=tan(polar angle) equation 3

a=azimuth equation 4

Here, when the polar angle is represented by t, t is expressed by t=arctan(r).
Therefore, the 3D polar coordinates (radius vector, polar angle, azimuth) are expressed by (radius vector, polar angle, azimuth)=(1, arctan(r), a).

Further, conversion from the 3D polar coordinates to the rectangular coordinates (x, y, z) is expressed by equation 5 below.

(x, y, z)=(sin(t)×cos(a), sin(t)×sin(a), cos(t)) equation 5

The above equation 5 is used to enable conversion between the equirectangular projection image EC in equirectangular projection and the planar image P in perspective projection. That is, the radius vector r, which corresponds to the diagonal angle of view α of the planar image P to be generated, can be used to calculate transformation map coordinates indicating each pixel of the planar image P and the co-ordinates of a corresponding point on the equirectangular projection image EC. On the basis of the transformation map coordinates, the peripheral area image PI, which is a perspective projection image, can be generated from the equirectangular projection image EC.

In the projection conversion described above, the position, in the equirectangular projection image EC, expressed by (latitude, longitude)=(90°, 0°) is converted to the central point CP2 of the peripheral area image PI, which is a perspective projection image. Therefore, in a case of performing perspective projection conversion while assuming a certain point of the equirectangular projection image EC to be the point of gaze, the sphere CS on which the equirectangular projection image EC is placed is rotated to perform coordinate rotation so that the point of gaze expressed by the coordinates (latitude, longitude) is located at the position (90°, 0°).

As the transformation formula for this rotation of the sphere CS, a general coordinate rotation formula can be used, and therefore, a description thereof will be omitted.

### Determination of Peripheral Area Image

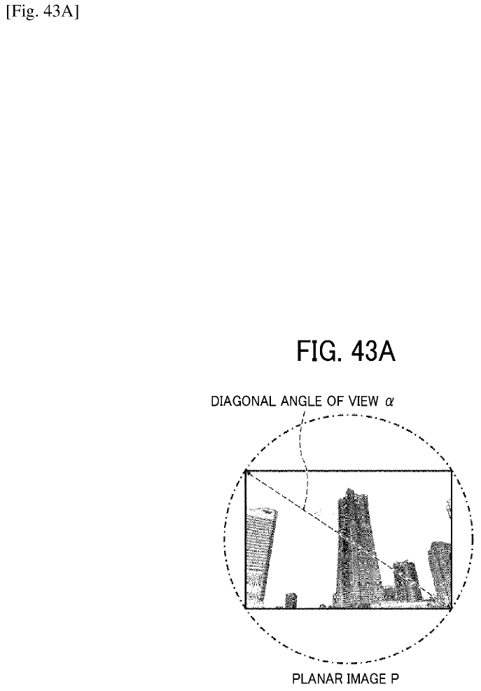

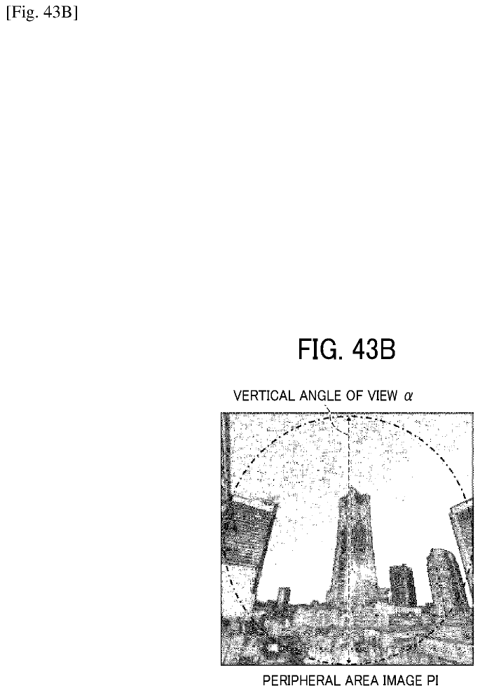

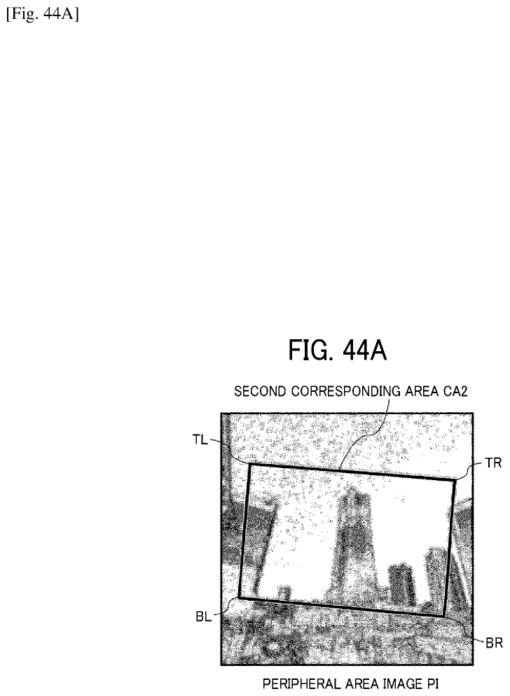

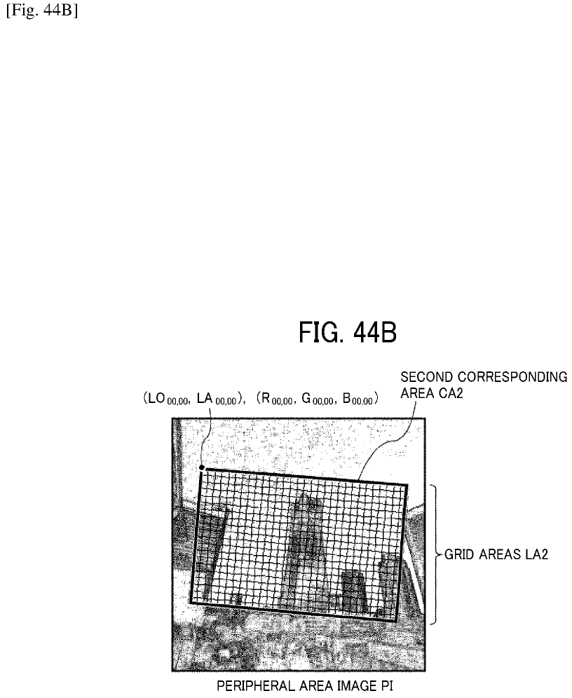

Next, a method for determining the area of the peripheral area image PI is described with reference to FIGS. 43A and 43B. FIGS. 43A and 43B are diagrams schematically illustrating determination of the peripheral area image PI.

For the corresponding area calculator 552 to determine the similarities between the plurality of feature points in the planar image P and the plurality of feature points in the peripheral area image PI, the second corresponding area CA2 included in the peripheral area image PI is made large to the extent possible. If the peripheral area image PI is set so as to have a large area, the peripheral area image PI includes the second corresponding area CA2. However, if the peripheral area image PI is set so as to have an excessively large area, the number of pixels for which the similarity is to be calculated increases accordingly, resulting in an increased processing time. Therefore, the peripheral area image PI includes the second corresponding area CA2 and so as to have a smaller area to the extent possible. Accordingly, in the present embodiments, the peripheral area image PI is determined with a method as described below.

In the present embodiments, the peripheral area image PI is determined by using the 35 mm equivalent focal length for the planar image P. The 35 mm equivalent focal length is obtained from Exif data recorded at the time of image capturing. The 35 mm equivalent focal length is a focal length based on the film size of 24 mm×36 mm, and therefore, the length of the diagonal of such a film and the focal length can be used to calculate the corresponding diagonal angle of view by using equation 6 and equation 7 below.

Diagonal of film=sqrt(24*24+36*36) equation 6

Angle of view of image to be combined/2=arctan((Diagonal of film/2)/35 mm equivalent focal length for image to be combined) equation 7

Here, an image that covers such an angle of view has a circle shape; however, the actual imaging element (film) has a rectangular shape. Therefore, the image captured by the imaging element is a rectangular image that is inscribed in the circle. In the present embodiments, the vertical angle of view a of the peripheral area image PI is set to a value equal to the diagonal angle of view a of the planar image P. Accordingly, the peripheral area image PI illustrated in FIG. 43B has a square shape that is circumscribed about the circle that covers the diagonal angle of view α of the planar image P illustrated in FIG. 43A, and the vertical angle of view α can be calculated from the length of the diagonal of the square and the focal length for the planar image P as expressed by equation 8 and equation 9 below.

Diagonal of square=sqrt(Diagonal of film*Diagonal of film+Diagonal of film* Diagonal of film) equation 8

Vertical angle of view α/2=arctan((Diagonal of square/2)/35 mm equivalent focal length for planar image) equation 9

The vertical angle of view α thus calculated is used to perform projection conversion, thereby enabling generation of the peripheral area image PI (perspective projection image) that covers the planar image P centered on the point of gaze as large as possible at the diagonal angle of view α and has the vertical angle of view α that is not excessively large.

Referring back to FIG. 41, the area divider 555 divides a partial area in an image into a plurality of grid areas. A method for dividing the second corresponding area CA2 into a plurality of grid areas is described in detail with reference to FIGS. 44A and 44B. FIGS. 44A and 44B are diagrams schematically illustrating dividing of the second corresponding area CA2 into a plurality of grid areas.

The area divider 555 divides a rectangle illustrated in FIG. 44A defined by the four vertices indicated by the vertex coordinates of the second corresponding area CA2 calculated by the corresponding area calculator 552 performing the second homography transformation into a plurality of grid areas LA2 illustrated in FIG. 44B. For example, the area divider 555 equally divides the rectangle into 30 grid areas in the horizontal direction and 20 grid areas in the vertical direction.

Now, a specific method for division into the plurality of grid areas LA2 is described.

A calculation equation used to equally divide the second corresponding area CA2 is described. In a case of equally dividing a line segment connecting two points A(X1, Y1) and B(X2, Y2) into n segments, the coordinates of a point Pm, which is the m-th point from the point A, are calculated by using equation 10 below.

Pm=(X1+(X2−X1)×m/n, Y1+(Y2−Y1)×m/n) equation 10

With equation 10 above, the coordinates of each point obtained by equally dividing the line segment can be calculated. Therefore, the coordinates of each point obtained by dividing the upper side and the lower side of the rectangle can be obtained, and thereafter, each line segment indicated by corresponding coordinates obtained as a result of division is further divided. When the upper left, the upper right, the lower right, and the lower left vertices of the rectangle are respectively represented by TL, TR, BR, and BL, the coordinates of each point obtained by equally dividing each of the line segment TL-TR and the line segment BR-BL into 30 segments are calculated. Then, the 0-th to 30-th points indicated by the calculated coordinates are obtained as a result of division. Subsequently, each of the line segments defined by corresponding points at the same positions in the order is equally divided into 20 segments to obtain the coordinates of the resulting points. Accordingly, the coordinates based on which the rectangular area is divided into 30×20 small areas can be calculated. FIG. 44B illustrates the coordinates of, for example, TL (LO_{00,00}, LA_{00,00}).

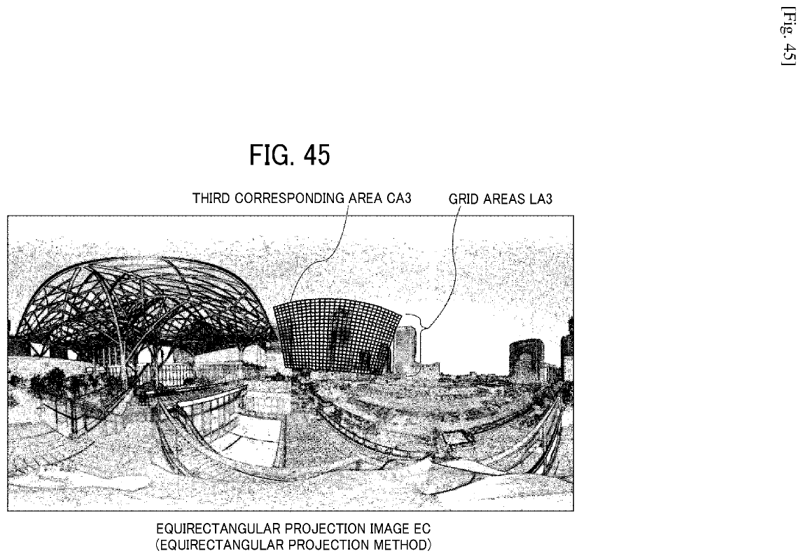

The projection reverse converter 556 reversely converts the projection method for the second corresponding area CA2 to equirectangular projection, which is the projection method for the equirectangular projection image EC, to thereby calculate a third corresponding area CA3, in the equirectangular projection image EC, corresponding to the second corresponding area CA2. Specifically, the projection reverse converter 556 calculates the third corresponding area CA3, in the equirectangular projection image EC, constituted by grid areas LA3 corresponding to the plurality of grid areas LA2 in the second corresponding area CA2. The third corresponding area CA3 is illustrated in FIG. 45. FIG. 45 is a diagram schematically illustrating the third corresponding area CA3 in the equirectangular projection image EC. Accordingly, the planar image P is eventually superimposed and displayed on the spherical image CE generated from the equirectangular projection image EC so as to fit in (be mapped onto) the third corresponding area CA3. With this process by the projection reverse converter 556, the location parameter indicating the coordinates of each grid point of each of the grid areas LA3 is generated. The location parameter is illustrated in FIG. 1.

The location parameter thus generated is used to enable calculation of a locational relation between the equirectangular projection image EC and the planar image P.

In a case where the location parameter is calculated and superimposed display is performed without performing any other processing, the resulting superimposed display may be unnatural if the equirectangular projection image EC and the planar image P are significantly different from each other in brightness or color tone. Therefore, the shape converter 558 and the correction parameter generator 559 described below provide a function of preventing unnatural superimposed display in the case where the brightness or color tone significantly differs.

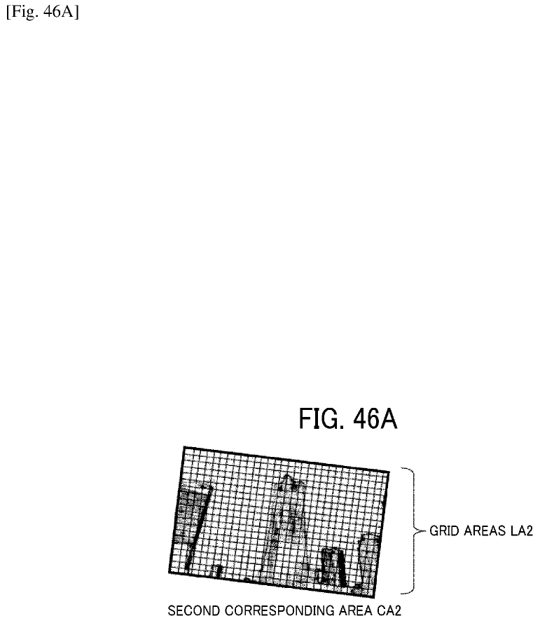

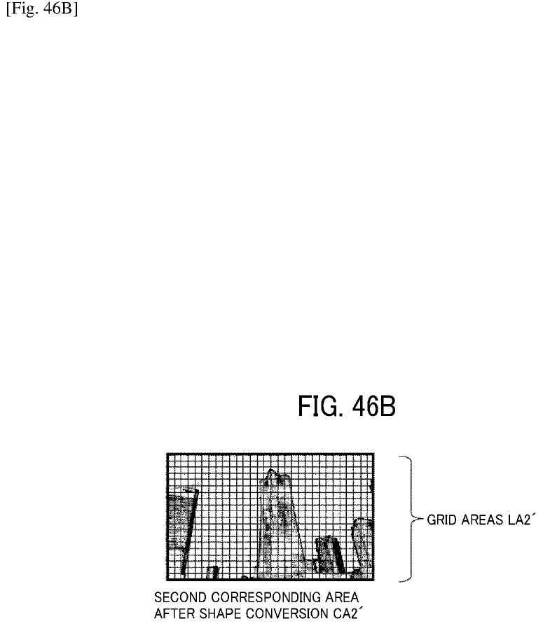

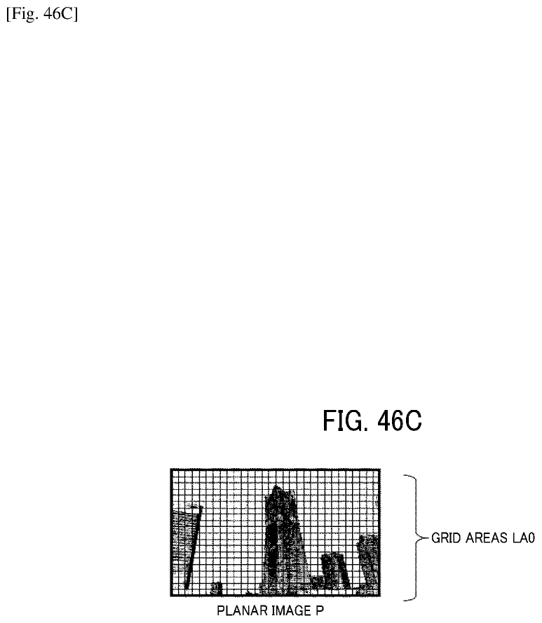

Prior to a color correction described below, the shape converter 558 maps the four vertices of the second corresponding area CA2 to the four vertices of the planar image P to thereby convert the shape of the second corresponding area CA2 to a shape identical to the shape of the planar image P. Specifically, the shape converter 558 converts the shape of the second corresponding area CA2 to a shape identical to the shape of the planar image P so that the grid areas LA2 of the second corresponding area CA2 illustrated in FIG. 46A match grid areas LA0 of the planar image P illustrated in FIG. 46C. As a result, the shape of the second corresponding area CA2 illustrated in FIG. 46A is converted to the shape of a second corresponding area CAT2′ illustrated in FIG. 46B. Accordingly, the grid areas LA2 are converted to grid areas LA2′ to have a shape identical to the shape of the grid areas LA0 of the planar image P.

The correction parameter generator 559 generates, for the color of the grid areas LA2′ of the second corresponding area CA2′ obtained as a result of conversion to the identical shape, a correction parameter for adjusting the brightness and color of the grid areas LAO of the planar image P, the grid areas LAO having a shape identical to the shape of the grid areas LA2′. Specifically, the correction parameter generator 559 calculates the average a of the brightness and color values (R, G, B) of all pixels constituting four grid areas LA0 that share one common grid point and further calculates the average a′ of the brightness and color values (R′, G′, B′) of all pixels constituting four grid areas LA2′ that share one common grid point. In a case where the one grid point of the grid areas LA0 and the one grid point of the grid areas LA2′ correspond to one of the four corners of the second corresponding area CA2 and one of the four corners of the third corresponding area CA3, the correction parameter generator 559 calculates the average a of the brightness and color from the corresponding one grid area LA0 and the average a′ of the brightness and color from the corresponding one grid area LA2′. In a case where the one grid point of the grid areas LA0 and the one grid point of the grid areas LA2′ correspond to a point on the boundary of the second corresponding area CA2 and a point on the boundary of the third corresponding area CA3, the correction parameter generator 559 calculates the average a of the brightness and color from the two internal grid areas LA0 and the average a′ of the brightness and color from the two internal grid areas LA2′. In the present embodiments, the correction parameter is gain data for correcting the brightness and color of the planar image P, and therefore, the correction parameter, which is represented by Pa, is calculated by dividing the average a′ by the average a as expressed by equation 11 below.

Pa=a′/a equation 11

Accordingly, the gain value indicated by the correction parameter is used to perform multiplication for each grid area LA2′ in superimposed display described below, and the color tone and the luminance value of the planar image P become closer to those indicated by the pixel values of the equirectangular projection image EC (spherical image CE), thereby enabling superimposed display that feels natural. The correction parameter need not be calculated from the averages and may be calculated by using, for example, the medians and/or the modes instead of or in addition to the averages.

The superimposed display metadata generator 560 uses the location parameter, the correction parameter, etc. to generate superimposed display metadata that indicates the position at which the planar image P is superimposed on the spherical image CE and the correction values for brightness and color.

### Superimposed Display Metadata

Now, a data structure of the superimposed display metadata is described with reference to FIG. 1. FIG. 1 illustrates a data structure of the superimposed display metadata.

As illustrated in FIG. 1, the superimposed display metadata includes equirectangular projection image information, planar image information, superimposed display information, and metadata generation information.

Among these pieces of information, the equirectangular projection image information is information transmitted from the special image capturing device 1 together with captured image data. The equirectangular projection image information includes an image identifier and attribute data. The image identifier included in the equirectangular projection image information is an image identifier for identifying an equirectangular projection image. In FIG. 1, the image identifier in the equirectangular projection image information is, for example, the file name of the image; however, the image identifier may be an image ID for identifying the image.

The attribute data included in the equirectangular projection image information is related information added to the equirectangular projection image information. In FIG. 1, the attribute data includes, for example, positioning correction data (pitch, yaw, roll) related to equirectangular projection image data obtained at the time of image capturing by the special image capturing device 1. The positioning correction data may be stored in the Exif format, which is specified as an image recording format used in the special image capturing device 1, or may be stored in any other format defined by Google Photo Sphere schema (GPano). When a spherical image is captured at the same position, a 360-degree omnidirectional image can be captured even if the positioning differs. In a case of displaying the spherical image CE, positioning information and the position of the center of the image (the point of gaze) are specified in order to determine the display position. Accordingly, in general, the spherical image CE is corrected so that the zenith is right above the user capturing the image and displayed, which enables natural display in which the horizon is corrected to a straight line.

The planar image information is information transmitted from the general image capturing device 3 together with captured image data. The planar image information includes an image identifier and attribute data. The image identifier included in the planar image information is an image identifier for identifying the planar image P. In FIG. 1, the image identifier is, for example, the file name of the image; however, the image identifier may be an image ID for identifying the image.

The attribute data included in the planar image information is related information added to the planar image information. In FIG. 1, the attribute data in the planar image information includes, for example, the value of the 35 mm equivalent focal length. The value of the 35 mm equivalent focal length need not be used in superimposing and displaying the planar image P on the spherical image CE; however, the value of the 35 mm equivalent focal length is included, for example, as reference information for determining the angle of view for display in a case of superimposed display.

The superimposed display information is information generated by the controller 60 and includes area division number information, the coordinates of the grid points of each grid area (location parameter), and correction values for brightness and color (correction parameter). Among these pieces of information, the area division number information includes the number of divisions in the horizontal (longitude) direction and in the vertical (latitude) direction in a case of dividing the first corresponding area CA1 into a plurality of grid areas.

The location parameter is vertex mapping information that indicates a position, in the equirectangular projection image EC (spherical image CE), at which each grid point obtained by dividing the planar image P into a plurality of grid areas is located. The correction parameter is gain data for correcting the color of the planar image P in the present embodiments. The target to be corrected may be a monochrome image, and therefore, the correction parameter is a parameter for adjusting at least the brightness among the brightness and color.

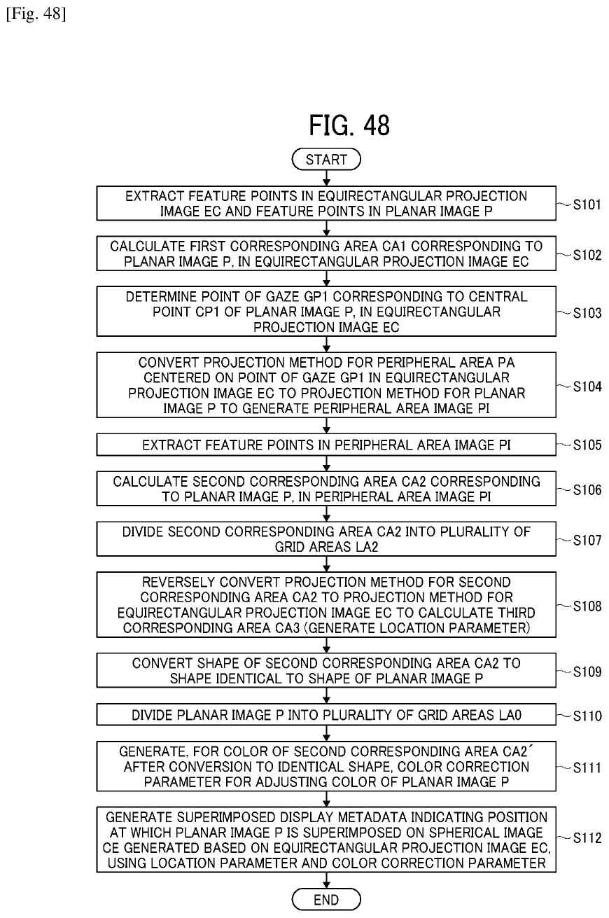

In a case where the spherical image CE is captured by using perspective projection, which is the projection method for the planar image P, a 360-degree omnidirectional image is not obtained. Therefore, an image of a wide angle of view, such as a spherical image, is often generated by using equirectangular projection, which is one of the existing projection methods. When equirectangular projection, such as the Mercator projection, is used for an image, a length in the horizontal direction increases as the distance from the standard parallel increases, resulting in the image significantly different from an image generated using perspective projection that is employed in general cameras. Even if scaling of the images is changed for superimposition, the images do not match, and the planar image P does not satisfactorily fit in the spherical image CE. Accordingly, in a case where the planar image P captured separately from the spherical image CE is superimposed on a partial area of the spherical image CE, the equirectangular projection image EC (spherical image CE) and the planar image P do not match, and the planar image P does not satisfactorily fit in the spherical image CE because the equirectangular projection image EC and the planar image P are generated using different projection methods. In the present embodiments, the location parameter is generated in the process illustrated in FIG. 48.

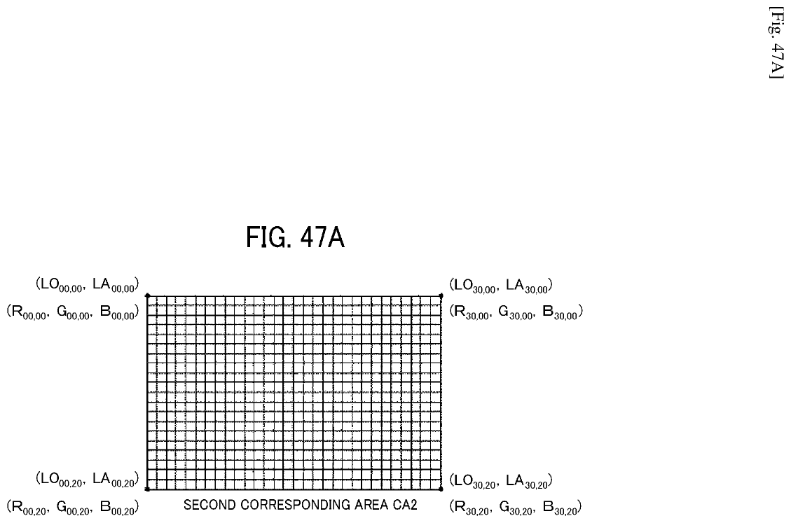

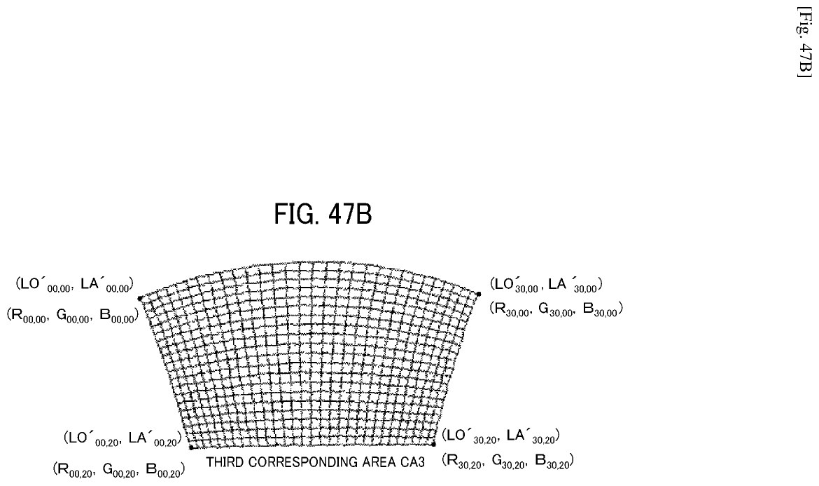

Now, the location parameter and the correction parameter are described in detail with reference to FIGS. 47A and 47B. FIG. 47A is a diagram schematically illustrating grid areas in the second corresponding area CA2, and FIG. 47B is a diagram schematically illustrating grid areas in the third corresponding area CA3.

As illustrated in FIG. 47A, in the present embodiments, the second corresponding area CA2 obtained by converting the first corresponding area CA1, which is a partial area of the equirectangular projection image EC, to an image in perspective projection, which is the projection method for the planar image P, is divided into a plurality of grid areas, namely, 30 areas in the horizontal direction and 20 areas in the vertical direction. In FIG. 47A, the coordinates of the grid points of each of the grid areas (LO _{00,00}, LA_{00,00}), (LO_{01,00}, LA_{01,00}) . . . , LA_{30,20}, LA_{30,20}) and the correction values for brightness and color of the grid points of each of the grid areas (R_{00,00}, G_{00,00}, B_{00,00}), (R _{01,00}, G_{01,00}, B_{01,00}), . . . , (R_{30,20}, G_{30,20}, B_{30,20}) are found. To simplify the figure, only the co-ordinates and the correction values for brightness and color of the grid points at the four vertices are indicated; however, the coordinates and the correction values for brightness and color are actually present for all of the grid points. The correction values R, G, and B for brightness and color respectively indicate correction gains for red, green, and blue. Further, the correction values R, G, and B for brightness and color actually indicate correction values for the brightness and color of an image within a predetermined range centered on each grid point indicated by coordinates (a range that does not overlap with a predetermined range centered on an adjacent grid point).

As illustrated in FIG. 47B, in the present embodiments, the third corresponding area CA3 obtained by reversely converting the second corresponding area CA2 to an image in equirectangular projection, which is the projection method for the equirectangular projection image EC, is similarly divided into a plurality of grid areas, namely, 30 areas in the horizontal direction and 20 areas in the vertical direction. In FIG. 47B, the coordinates of the grid points of each of the grid areas (LO′_{00,00}, LA′_{00,00}), LO′_{01,00}, LA′_{01,00}), . . . , (LO′_{30,20}, LA′_{30,20}) and the correction values for brightness and color, the correction values being equal to the correction values for the second corresponding area CA2, are found. Also in FIG. 47B, only the coordinates and the correction values for brightness and color of the grid points at the four vertices are indicated for simplifying the figure; however, the coordinates and the correction values for brightness and color are actually present for all of the grid points.

Referring back to FIG. 1, the metadata generation information includes version information indicating the version of the superimposed display metadata.

As described above, the location parameter indicates a locational correspondence between the planar image P and the equirectangular projection image EC (spherical image CE). If the location parameter is used to indicate the position of each pixel of the planar image P and the coordinates of a corresponding point on the equirectangular projection image EC (spherical image CE), the location parameter includes information for about 40 million pixels in a case where the general image capturing device 3 is a digital camera having a large number of pixels. Therefore, the amount of data of the location parameter increases, and the processing load due to, for example, data storage increases. In the present embodiments, the planar image P is divided into 600 (30×20) areas, and the location parameter includes data indicating only the coordinates of each grid point on the planar image P and a corresponding position on the equirectangular projection image EC (spherical image CE). In a case of superimposed display, the controller 60 interpolates an image in each area using the coordinates of the grid points to thereby implement superimposed display.

### Processing or Operation according to the Second Example Embodiment

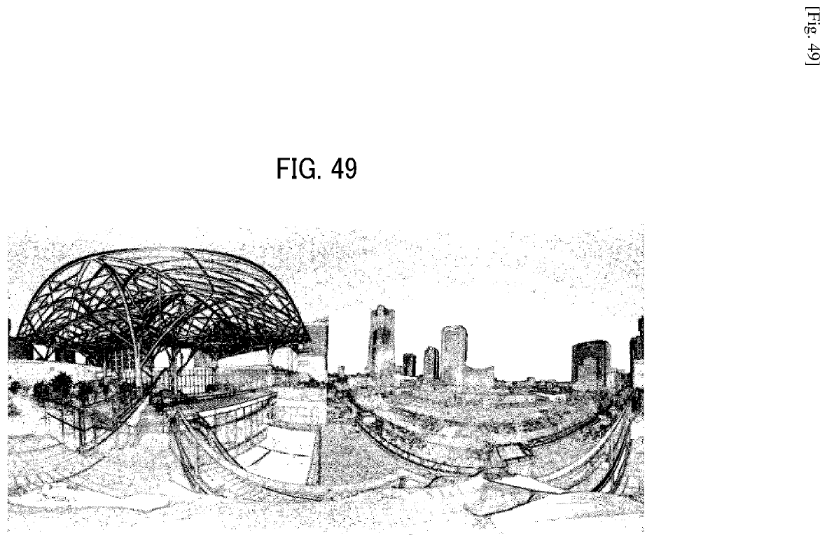

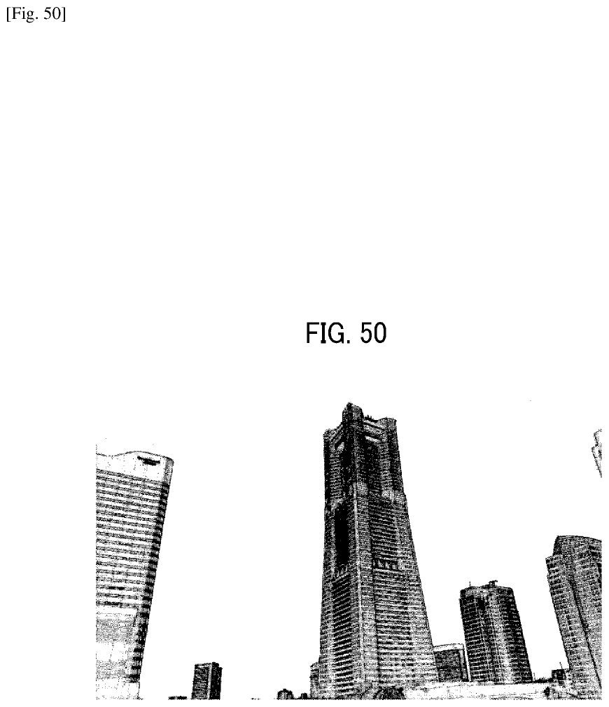

Now, the processing or operation according to the second example embodiment is described with reference to FIG. 48, etc. First, an image capture method performed by the image capturing system 2 is described with reference to FIG. 48. FIG. 48 is a flowchart illustrating a superimposed display parameter generation process. FIG. 49 illustrates an equirectangular projection image generated by the special image capturing device 1 using an equirectangular projection method. FIG. 50 illustrates a planar image generated by the general image capturing device 3 using a perspective projection method.

Even if the imaging element of the general image capturing device 3 and the imaging element of the special image capturing device 1 are the same, the definition, per unit area, of an image captured by the special image capturing device 1 becomes low. This is because the imaging element of the special image capturing device 1 captures an equirectangular projection image that fully covers a 360-degree scene, from which the spherical image CE is generated.

Hereinafter, the process for generating the superimposed display metadata is described. The superimposed display metadata is used to superimpose the planar image P illustrated in FIG. 50 and having a high definition on the spherical image CE, which is generated from the equirectangular projection image EC illustrated in FIG. 49 and having a low definition, to display a resulting image on the display 107. The superimposed display metadata includes the location parameter and the correction parameter, as illustrated in FIG. 1, and therefore, a method for generating the location parameter and the correction parameter is mainly described.

First, the extractor 551 extracts a plurality of feature points in the equirectangular projection image EC, which is a rectangular image obtained by using equirectangular projection, and a plurality of feature points in the planar image P, which is a rectangular image obtained by using perspective projection (step S101).

Subsequently, the corresponding area calculator 552 performs first homography transformation and calculates the first corresponding area CA1, which is a rectangular area corresponding to the planar image P, in the equirectangular projection image EC as illustrated in FIG. 42 on the basis of the similarities between the plurality of feature points in the equirectangular projection image EC and the plurality of feature points in the planar image P (step S102). In this process, it is not possible to precisely map the planar image P, which is an image in different projection, onto the equirectangular projection image EC; however, this process is a process (tentative determination process) for tentatively and roughly estimating a corresponding position.

Subsequently, the point-of-gaze determiner 553 determines a point (point of gaze GP1), in the equirectangular projection image EC, at which the central point CP1 of the planar image P is located after the first homography transformation (step S103).

Subsequently, the projection converter 554 converts the projection method for the peripheral area PA centered on the point of gaze GP1 on the equirectangular projection image EC to perspective projection, which is the projection method for the planar image P, to eventually generate the peripheral area image PI in which the vertical angle of view α of the peripheral area image PI is equal to the diagonal angle of view a of the planar image P, as illustrated in FIGS. 43A and 43B (step S104).

Subsequently, the extractor 551 extracts a plurality of feature points in the peripheral area image PI obtained by the projection converter 554 (step S105).

Subsequently, the corresponding area calculator 552 performs second homography transformation and calculates the second corresponding area CA2, which is a rectangular area corresponding to the planar image P, in the peripheral area image PI on the basis of the similarities between the plurality of feature points in the planar image P and the plurality of feature points in the peripheral area image PI (step S106). The planar image P is a high-definition image having, for example, 40 million pixels, and therefore, is resized in advance to an appropriate size.

Subsequently, the area divider 555 divides the second corresponding area CA2 into the plurality of grid areas LA2, as illustrated in FIG. 44B (step S107).

Subsequently, the projection reverse converter 556 converts (reversely converts) the projection method for the second corresponding area CA2 to equirectangular projection, which is the projection method for the equirectangular projection image EC, as illustrated in FIG. 42 (step S108). Then, the projection reverse converter 556 calculates the third corresponding area CA3, in the equirectangular projection image EC, constituted by the grid areas LA3 corresponding to the plurality of grid areas LA2 in the second corresponding area CA2, as illustrated in FIG. 45. FIG. 45 is a diagram schematically illustrating the third corresponding area CA3 in the equirectangular projection image EC. With this process performed by the projection reverse converter 556, the location parameter indicating the coordinates of each grid point of each of the grid areas LA3 is generated. The location parameter is found in FIG. 1 and FIG. 47, as described above.

The process for generating the correction parameter is described with reference to FIGS. 46A to 46C. FIGS. 46A to 46C are diagrams schematically illustrating an image in the process of generating the correction parameter.

After the process in step 5108, the shape converter 558 maps the four vertices of the second corresponding area CA2, as illustrated in FIG. 46A, to the four vertices of the planar image P to thereby convert the shape of the second corresponding area CA2 to a shape identical to the shape of the planar image P and obtain the second corresponding area CA2′, as illustrated in FIG. 46B (step S109).

Subsequently, the area divider 555 divides the planar image P into the plurality of grid areas LA0 having a shape identical to the shape of the grid areas LA2′ in the second corresponding area CA2′obtained as a result of conversion, as illustrated in FIG. 46C, the number of the grid areas LAO being equal to the number of the grid areas LA2′ (step S110).

Subsequently, the correction parameter generator 559 generates, for the brightness and color of the grid areas LA2′ in the second corresponding area CA2′, a correction parameter for adjusting the brightness and color of the grid areas LA0 in the planar image P, the grid areas LAO corresponding to the grid areas LA2′ (step S111).

Last, the superimposed display metadata generator 560 generates the superimposed display metadata on the basis of the equirectangular projection image information obtained from the special image capturing device 1, the planar image information obtained from the general image capturing device 3, the predetermined area division number information, the location parameter generated by the projection reverse converter 556, the correction parameter generated by the correction parameter generator 559, and the metadata generation information (step S112).

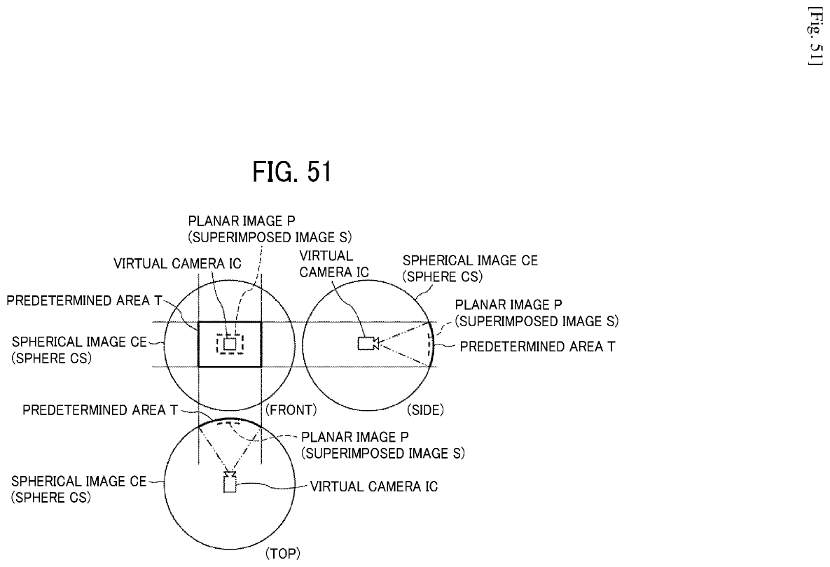

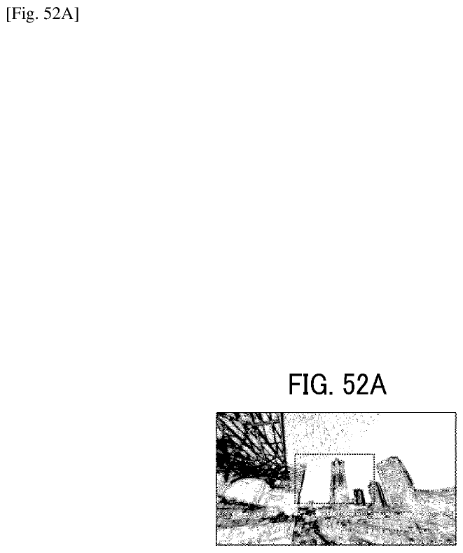

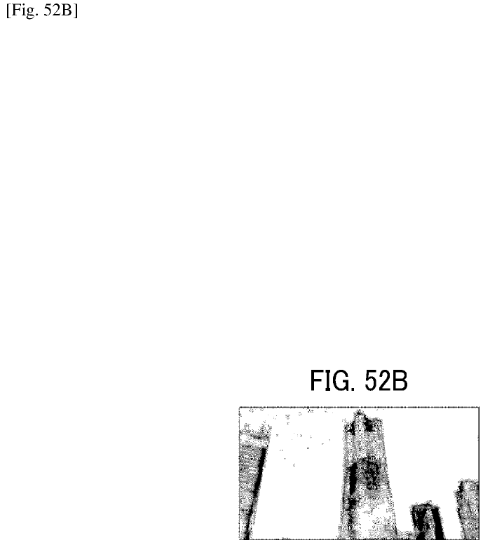

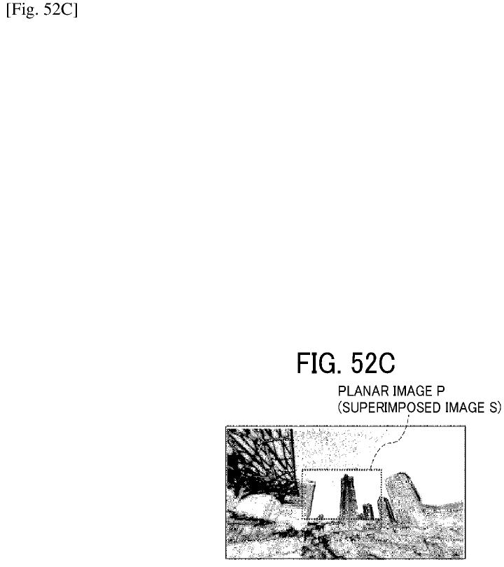

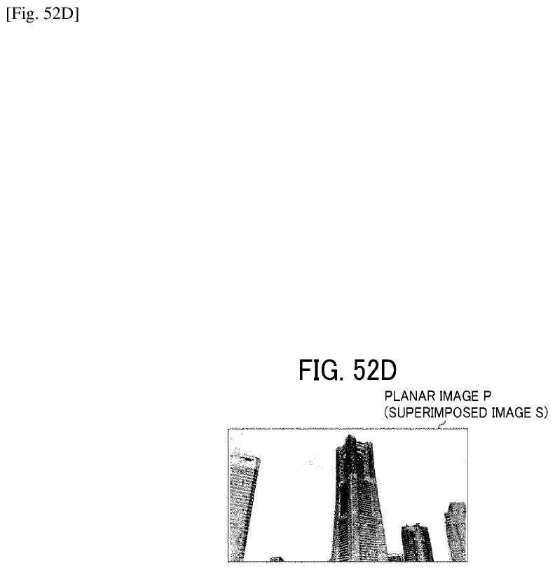

Now, the state of superimposed display is described in detail with reference to FIG. 51 and FIGS. 52A to 52D. FIG. 51 is a 2D diagram schematically illustrating a case where the planar image P is superimposed on the spherical image CE. Here, a case where the planar image P is superimposed on the equirectangular projection image is illustrated. As illustrated in FIG. 51, a superimposed image S having a high definition is superimposed on the spherical image CE having a low definition and placed on the sphere CS in accordance with the location parameter so as to be located on the inner surface facing the virtual camera IC.

FIGS. 52A, 52B, 52C, and 52D are diagrams schematically illustrating an example wide-angle image that is displayed without superimposed display, an example telephoto image that is displayed without superimposed display, an example wide-angle image that is displayed with superimposed display, and an example telephoto image that is displayed with superimposed display, respectively. The dashed line in FIGS. 52A and 52C are illustrated for convenience of description and may or may not actually be displayed on the display 107.

As illustrated in FIG. 52A, in a case where the spherical image CE is displayed without the planar image P superimposed thereon, when the area outlined by the dashed line in FIG. 52A is enlarged to full screen, the image having a low definition is displayed as is, and the user views the unclear image, as illustrated in FIG. 52B. On the other hand, in a case where the spherical image CE is displayed with the planar image P superimposed thereon as illustrated in FIG. 52C, when the area outlined by the dashed line in FIG. 52C is enlarged to full screen, the image having a high definition is displayed, and the user can view the clear image, as illustrated in FIG. 52D. Specifically, in a case where, for example, a signboard with text thereon is present in the area outlined by the dashed line and the planar image P having a high definition is not superimposed and displayed, when the image is enlarged, the text is blurred and illegible. In a case where the planar image P having a high definition is superimposed and displayed, even when the image is enlarged, the text remains clear and legible to the user.

### Other Example Applications

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

For example, in one or more of the present embodiments, image data is assumed to be superimposed display use data; however, audio data or moving image data may be embedded in an equirectangular projection image. For example, when a place in which audio data is embedded is clicked with a mouse, etc., the audio data is reproduced by the client terminal.

In any one of the present embodiments, the metadata is generated mainly for associating pieces of image data to be superimposed. As another example use of the metadata, the metadata can be used in, for example, display of a plurality of pieces of image data obtained at predetermined intervals in interval photography (time-lapse photography).

Further, in the above-described second example embodiment, since the metadata generating unit 17 and the management ID determination unit 14 are provided at the controller 60, the metadata generating unit 31 and/or the management ID generating unit 25 do not have to be provided at the AP server 30. In such case, a part of the functions to be provided by the superimposed display management system 50 may be performed at the controller 60. Specifically, obtaining the first data and the second data, generating the metadata for combining the first data and the second data, and generating the management ID, are performed at the controller 60.

Furthermore, in the above-described second example embodiment, the controller 60 may operate as the client terminal 10, which causes a display to display a screen for allowing a user to select the first data and the second data, for example. In such case, a part of the functions to be provided by the client terminal 10 may be performed at the controller 60. Accordingly, the client terminal 10 does not have to be provided in the second example embodiment.

In one embodiment, the present invention resides in: an information processing apparatus (superimposed display management system 50) including: obtaining means (for example, second communication unit 43) for obtaining a plurality of pieces of data; generating means (for example, metadata generating unit 31) for generating metadata used to combine first data of the plurality of pieces of data with second data being one or more of plurality of pieces of data other than the first data; identifier assigning means (for example, management ID generating unit 35) for assigning a common identifier to the first data, the second data, and the metadata; and data management means (data management unit 41) for storing, in a storage unit (for example, database 44), the first data, the second data, and the metadata in association with the common identifier.

In one embodiment, in the information processing apparatus, the data management means is configured to obtain, from the storage unit, any one of the first data, second data, and metadata, using the common identifier that is obtained. In one example, the data management means obtains, from the storage unit, the second data and the metadata associated with the common identifier that is associated with the first data. In another example, the data management means obtains, from the storage unit, the first data and the metadata associated with the common identifier that is associated with the second data.

In one embodiment, a data management system (100) includes the information processing apparatus (50) and a terminal device (10) connected through a network. The terminal device includes: display control means (display control unit 13) for displaying a plurality of pieces of data; accepting means (for example, operation accepting unit 12) for accepting selection of the first data and the second data to be combined; and first communication means (for example, third communication unit 11) for transmitting information on the first data and the second data accepted by the accepting means to the information processing apparatus. The information processing apparatus further includes second communication means (for example, the first communication unit 33) for receiving the information on the image data and the second data.

In one embodiment, the plurality of pieces of data are pieces of image data and stored in the storage unit (for example, database 44). The second communication means is configured to transmit, to the terminal device, file names and thumbnail images of the plurality of pieces of image data stored in the storage unit. At the terminal device, the display control means (for example, display control unit 13) displays, on a display, the file names and the thumbnail images of the pieces of the image data. The accepting means is configured to accept selection of the first image data and the second image data from among the pieces of the image data. The first communication means is configured to transmit information on the first image data and the second image data that are selected. The generating means is configured to generate the metadata using the information on the first image data and the second image data transmitted from the terminal device.

In one embodiment, in the data management system, one or more common identifiers are associated with one second image data in the memory.

In one embodiment, the data management system further includes an information terminal connected to a network, which includes: the generating means that obtains the first image data from a first image capturing device (for example, special image capturing device 1) generating the first image data and obtains the second image data from a second image capturing device (for example, general image capturing device 3) generating the second image data to generate the metadata; and second identifier assigning means (for example, management ID determination unit 14) for assigning a common identifier to the first image data and the second image data that are obtained and to the metadata. The information terminal registers the first image data, the second image data, the metadata, and the common identifier in the information processing apparatus.

In one embodiment, in the data management system, the second identifier assigning means assigns the common identifier that includes a date and time when the image is captured and location information about the information terminal.

In one embodiment, in the data management system, the information processing apparatus further includes screen information generating means (for example, Web server unit 32) for generating screen data used to display the first and second image data together with common identifiers, each of the common identifiers being associated with corresponding first and second image data and metadata obtained by the data management means from the storage unit. The second communication means is configured to transmit the screen data to the terminal device, and the display control means of the terminal device is configured to display, on the basis of the screen data, each of the first and second image data together with a corresponding one of the common identifiers.

In one embodiment, in the data management system, the screen information generating means is configured to generate screen data used to display each first or second image data together with the number of first and second image data associated with the common identifier that is associated with the first or second image data, and the display control means is configured to display, on the basis of the screen data, each of the first and second image data together with the number of first and second image data associated with the common identifier.

In one embodiment, in the data management system, in a case where the accepting means accepts selection of the first image data or the second image data, the first communication means is configured to transmit, to the information processing apparatus, information about the selected first image data or the selected second image data. The data management means is configured to obtain, from the storage unit, all of the first and second image data having the common identifier that is associated with the selected first image data or the selected second image data. The screen information generating means is configured to generate screen data used to display file names and thumbnail images of the first and second image data obtained by the data management means. The second communication means is configured to transmit, to the terminal device, the screen data that includes the file names and the thumbnail images of the first and second image data obtained by the data management means. The display control means is configured to display, on the display, the file names and the thumbnail images of the first and second image data on the basis of the screen data.

In one embodiment, in the data management system, when a request for downloading first image data, second image data, and metadata is received from the terminal device, the screen information generating means is configured to generate screen data including a data format identifier for specifying a data format that is used when the first image data, the second image data, and the metadata are downloaded. The second communication means is configured to transmit the screen data to the terminal device. The display control means is configured to display the data format identifier together with file names and thumbnail images of the first image data and the second image data on the basis of the screen data. The accepting means is configured to accept selection of the data format identifier.

In one embodiment, the data format identifier is used to specify one of: a data format in which the first image data, the second image data, and the metadata are stored in separate files and the common identifier is added to each of the files; a data format in which the first image data, the second image data, and the metadata are stored in one file and the common identifier is added to the file; a data format in which the first image data or the second image data for which selection is accepted at the terminal device is stored in one file and the common identifier is added to the file; a data format in which the metadata associated with a common identifier the same as the common identifier of the first image data or the second image data for which selection is accepted at the terminal device is stored in one file and the common identifier is added to the file; and a data format in which the first image data, the second image data, and the metadata are not included but the common identifier is stored in a file.

In one embodiment, in the data management system, the information processing apparatus further includes download data generating means (for example, download data generating unit 34) for generating download data in a data format that is specified with the data format identifier transmitted from the terminal device. The download data includes at least one of the first image data, the second image data, and the metadata associated with a common identifier the same as the common identifier of the first image data or the second image data for which selection is accepted at the terminal device. The second communication means is configured to transmit the download data to the terminal device.

In one embodiment, in the data management system, in a case where another terminal device that retains the download data specifies the common identifier of the download data to make a request for the first image data or the second image data, the information processing apparatus is configured to perform user authentication on the basis of whether the common identifier is stored in the storage unit. In a case where the authentication is successful, the screen information generation means is configured to generate the screen data including the data format identifier, and the second communication means is configured to transmit the screen data to the other terminal device.

In one embodiment, in the data management system, the screen information generating means is configured to generate the screen data with which selection of the data format identifier for specifying only download data in a data format that includes the first image data, the second image data, and the metadata is allowed.

In this disclosure, a first image is an image superimposed with a second image, and a second image is an image to be superimposed on the first image. For example, the first image is an image covering an area larger than that of the second image. In another example, the second image is an image with image quality higher than that of the first image, for example, in terms of image resolution. For instance, the first image may be a low-definition image, and the second image may be a high-definition image. In another example, the first image and the second image are images expressed in different projections (projective spaces). Examples of the first image in a first projection include an equirectangular projection image, such as a spherical image. Examples of the second image in a second projection include a perspective projection image, such as a planar image. In this disclosure, the second image, such as the planar image captured with the general image capturing device, is treated as one example of the second image in the second projection (that is, in the second projective space). The first image, and even the second image, if desired, can be made up of multiple pieces of image data which have been captured through different lenses, or using different image sensors, or at different times. Further, in this disclosure, the spherical image does not have to be the full-view spherical image. For example, the spherical image may be the wide-angle view image having an angle of about 180 to 360 degrees in the horizontal direction. As described below, it is desirable that the spherical image is image data having at least a part that is not entirely displayed in the predetermined area T. The predetermined area T is an area to be displayed to the user. In this disclosure, superimposing one image on another image is an example of combining one image with another image. Other examples of combining images include, but not limited to, placement of one image on top of other image entirely or partly, laying one image over other image entirely or partly, mapping one image on other image entirely or partly, pasting one image on other image entirely or partly, and integrating one image with other image. That is, as long as the user can perceive a plurality of images (such as the spherical image and the planar image) being displayed on a display as they were one image, processing to be performed on those images for display is not limited to the above-described examples.

The present invention can be implemented in any convenient form, for example using dedicated hardware, or a mixture of dedicated hardware and software. The present invention may be implemented as computer software implemented by one or more networked processing apparatuses. The processing apparatuses can compromise any suitably programmed apparatuses such as a general purpose computer, personal digital assistant, mobile telephone (such as a WAP or 3G-compliant phone) and so on. Since the present invention can be implemented as software, each and every aspect of the present invention thus encompasses computer software implementable on a programmable device. The computer software can be provided to the programmable device using any conventional carrier medium (carrier means). The carrier medium can compromise a transient carrier medium such as an electrical, optical, microwave, acoustic or radio frequency signal carrying the computer code. An example of such a transient medium is a TCP/IP signal carrying computer code over an IP network, such as the Internet. The carrier medium can also comprise a storage medium for storing processor readable code such as a floppy disk, hard disk, CD ROM, magnetic tape device or solid state memory device.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

This patent application is based on and claims priority to Japanese Patent Application No. 2018-048369, filed on Mar. 15, 2018, in the Japan Patent Office, the entire disclosure of which is hereby incorporated by reference herein.

1. An information processing system comprising:
processing circuitry configured to
obtain a plurality of pieces of data;
generate metadata used to combine first data of the plurality of pieces of data, with second data being one or more of the plurality of pieces of data other than the first data;
assign a common identifier to the first data, the second data, and the metadata; and
store, in a memory, the first data, the second data, and the metadata in association with the common identifier.

2. The information processing system according to claim 1, wherein when the common identifier associated with any one of the first data, second data, and metadata stored in the memory is obtained, the processing circuitry is further configured to obtain, from the memory, any one of the first data, second data, and metadata, using the common identifier that is obtained.

3. The information processing system according to claim 1,
wherein the processing circuitry includes first processing circuitry and second processing circuitry that communicate with each other through a network,
wherein the first processing circuitry is configured to generate the metadata used to combine the first data and the second data, and assign the common identifier to the first data, the second data, and the metadata, and
wherein the second processing circuitry is configured to store the first data, the second data, the metadata, and the common identifier in the memory.

4. The information processing system according to claim 3, wherein the first processing circuitry resides on an information terminal operated by a user, and the second processing circuitry resides on a server communicable with the information processing apparatus through a network, wherein the first processing circuitry is further configured to:
obtain, as the first data, first image data from a first image capturing device that generates the first image data;
obtain, as the second data, second image data from a second image capturing device that generates the second image data; and
transmit, to the second processing circuitry, the first image data, the second image data, the metadata, and the common identifier.

5. The information processing system according to claim 4, wherein the common identifier includes date and time information indicating a date and time when the image is captured, and location information indicating a location of the information terminal.

6. A data management system, comprising:
the information processing system according to claim 1; and
a terminal device communicably connected to the processing circuitry through a network, the terminal device including:
circuitry configured to control a display to display the plurality of pieces of data obtained at the information processing system, and accept selection of the first data and the second data to be combined from among the plurality of pieces of data; and
a communication device configured to transmit information on the first data and the second data that are selected to the information processing system through the network,
the information processing system further including a communication device configured to receive the information on the first data and the second data from the terminal device, the information on the first data and the second data being used for generating the metadata.

7. The data management system according to claim 6, wherein
the plurality of pieces of data are pieces of image data and stored in the memory of the information processing system,
the communication device of the information processing system is configured to transmit, to the terminal device, for each of the plurality of pieces of image data that are stored, a file name and a thumbnail image,
the circuitry of the terminal device is further configured to display, on the display, the file name and the thumbnail image for each of the plurality of pieces of image data, and
wherein the selection of the first image data and the second image data is made using the file name and the thumbnail image being displayed.

8. The data management system according to claim 7, wherein, when the same second image data is to be combined with more than one first image data, the processing circuitry is further configured to associate a plurality of different common identifiers with the same second image data.

9. The data management system according to claim 6, wherein the processing circuitry is further configured to:
generate screen data for displaying the first image data and the second image data together with the common identifier, the common identifier associating the first image data, the second image data, and the metadata; and
transmit the screen data to the terminal device, and
the circuitry of the terminal device is configured to control a display to display, based on the screen data, the first image data and the second image data together with the common identifier.

10. The data management system according to claim 9, wherein the processing circuitry is further configured to generate the screen data so as to further include a number of pieces of the first image and the second image data associated with the common identifier, and
the circuitry of the terminal device is further configured to further display, based on the screen data, the number of pieces of the first image data and the second image data associated with the common identifier.

11. The data management system according to claim 9, wherein
when the information processing system receives selection of at least one piece of image data from among pieces of the first image data and the second image data, the processing circuitry is further configured to:
obtain, from the memory, all of the pieces of first image data and second image data having the common identifier that is associated with the selected piece of first image data or second image data; and
generate screen data for displaying file names and thumbnail images of all of the pieces of first image data and second image data that are obtained; and
transmit the screen data to the terminal device, and
the circuitry of the terminal device is further configured to display, on the display, the file names and the thumbnail images of all of the pieces of first image data and second image data based on the screen data.

12. The data management system according to claim 11, wherein
when a request for downloading the first image data, the second image data, and the metadata is received from the terminal device, the processing circuitry is further configured to:
generate screen data including a data format identifier identifying a data format that is used when the first image data, the second image data, and the metadata are downloaded; and
transmit the screen data to the terminal device, and
the circuitry of the terminal device is further configured to display the data format identifier together with file names and thumbnail images of the first image data and the second image data based on the screen data, and
accept selection of the data format identifier.

13. The data management system according to claim 12, wherein the data format identifier is used to specify one of:
a data format in which the first image data, the second image data, and the metadata are stored in separate files and the common identifier is added to each of the files,
a data format in which the first image data, the second image data, and the metadata are stored in one file and the common identifier is added to the file,
a data format in which the first image data or the second image data for which selection is accepted at the terminal device is stored in one file and the common identifier is added to the file,
a data format in which the metadata associated with a common identifier the same as the common identifier of the first image data or the second image data for which selection is accepted at the terminal device is stored in one file and the common identifier is added to the file, and
a data format in which the first image data, the second image data, and the metadata are not included but the common identifier is stored in a file.

14. The data management system according to claim 12, wherein the processing circuitry is further configured to:
generate download data in a data format that is specified with the data format identifier transmitted from the terminal device, the download data including at least one of the first image data, the second image data, and the metadata associated with a common identifier the same as the common identifier of the first image data or the second image data for which selection is accepted at the terminal device, and
transmit the download data to the terminal device.

15. The data management system according to claim 14, wherein
in response to receiving a request for the first image data or the second image data from another terminal device, the request including a specific common identifier, the processing circuitry is further configured to:
determine whether the common identifier is stored in the memory to authenticate a user of the another terminal device, and
based on a determination that the common identifier is stored in the memory to indicate that authentication is successful, generate the screen data including the data format identifier and transmit the screen data to the another terminal device.

16. The data management system according to claim 15, wherein
the processing circuitry is further configured to generate the screen data so as to only allow selection of the data format identifier for downloading a set of the first image data, the second image data, and the metadata.

17. A data management method performed by an information processing system, the data management method comprising:
obtaining a plurality of pieces of data;
generating metadata used to combine first data of the plurality of pieces of data, with second data being one or more of the plurality of pieces of data;
assigning a common identifier to the first data, the second data, and the metadata; and
storing, in a memory, the first data, the second data, and the metadata in association with the common identifier.

18. A non-transitory computer-readable recording medium storing a program code for causing a computer system to perform a data management method, comprising:
obtaining a plurality of pieces of data;
generating metadata used to combine first data of the plurality of pieces of data, with second data being one or more of the plurality of pieces of data;
assigning a common identifier to the first data, the second data, and the metadata; and
storing, in a memory, the first data, the second data, and the metadata in association with the common identifier.
